(19) United States
(12) Patent Application Publication
(10) Pub. No.: US 2004/0244382 A1
(43) Pub. Date: Dec. 9, 2004

(54) Distributed direct fluid contactor

(76) Inventors: David L. Hagen, Goshen, IN (US); Gary Ginter, Chicago, IL (US); Bill Goheen, Goshen, IN (US); Allan McGuire, Elkhart, IN (US); Janet Rankin, Shawano, WI (US); J. Lyell Ginter, Lancaster, CA (US); Gary Ginter, Chicago, IL (US)

Correspondence Address: Louis J. Knobbe, Knobbe, Martens, Olson & Bear, LLP, 14th Floor, 2040 Main Street, Irvine, CA, 92614, US

(21) Appl. No.: 10/713,899

(22) Filed: Sep. 12, 2003

Related U.S. Application Data
(63) Continuation-in-part of application No. 10/161,159, filed on May 30, 2002, now Pat. No. 6,564,556.
Application No. 10/161,159 is a continuation of application No. 09/645,986, filed on Oct. 27, 2000, now abandoned.
Application No. 09/645,986 is a division of application No. 09/042,231, filed on Mar. 11, 1998, now Pat. No. 6,289,666.
Application No. 09/042,231 is a continuation-in-part of application No. 08/232,047, filed on Apr. 26, 1994, now Pat. No. 5,743,080.
Application No. 08/232,047 is a continuation-in-part of application No. 07/967,289, filed on Oct. 27, 1992, now Pat. No. 5,617,719.

(51) Int. Cl. F02C 3/30

(52) U.S. Cl. 60/775

(57) ABSTRACT

The invention relates in general to methods of controlled mixing one fluid with another. In particular it relates to a distributed direct fluid contactor including arrays of streamlined perforated tubes distributed across a flow to efficiently contact and mix one or more fluids flowing through one or more tubes with a second fluid flowing across those tubes. These distributed contactors thereby mix the fluids in a substantially uniform fashion causing a prescribed uniformity or variation in the ratio of the first to second fluid across the space. This thereby to generally creates and controls the physical and/or chemical changes in those fluids, including evaporation, condensation, forming powders and conducting chemical reactions including combustion.

### FIELD OF THE INVENTION

The invention relates in general to methods of controlled mixing one fluid with another and thereby to generally create and control physical and/or chemical changes in those fluids, including evaporation, condensation, forming powders and conducting chemical reactions including combustion.

### REFERENCES

2.1 U.S. Pat. No. 3,651,641 to Ginter, James Lyle; ENGINE SYSTEM AND THERMOGENERATOR THEREFORE, Mar. 28, 1972

2.2 U.S. Pat. No. 5,617,719 to Ginter, James Lyle; VAPOR-AIR STEAM ENGINE, Apr. 8, 1997

2.3 U.S. Pat. No. 5,743,080 to Ginter, James Lyle; VAPOR-AIR STEAM ENGINE, Apr. 28, 1998

2.4 U.S. Pat. No. 6,289,666 to Ginter, James Lyle; HIGH EFFICIENCY LOW POLLUTION HYBRID BRAYTON CYCLE COMBUSTOR, Sep. 18, 2001

2.5 U.S. Pat. No. 5,031,581 to Powell, Brian; CRANKLESS RECIPROCATING MACHINE, Jul. 16, 1991

2.6 U.S. Pat. No. 5,570,670 to Powell, Brian; TWO STROKE INTERNAL COMBUSTION ENGINE, Nov. 5, 1996

2.7 U.S. Pat. No. 6,263,661 to van der Burgt, Maarten Johannes; van Liere; Jacobus; SYSTEM FOR POWER GENERATION, Jul. 24, 2001

2.8 U.S. Pat. No. 6,370,862 to Cheng, Dah Yu; STEAM INJECTION NOZZLE DESIGN FOR GAS TURBINE COMBUSTION LINERS FOR ENHANCED POWER OUTPUT AND EFFICIENCY, Apr. 16, 2002

2.9 Anders, K.; Frohn, A.; Karl, A. And Roth, N. “Flame propagation in planar droplet arrays and interaction phenomena between neighbouring droplet streams. Proc. 26^{th} Symp. (Int.) On Combustion, pp 1697-1703. The Combustion Institute, 1996.

2.10 Chiu, H. H; Chigier, Norman; Eds. “Mechanics and Combustion of Droplets and Sprays” 386 p, 1995 Begell House, Inc. ISBN 1-56700-051-7; LC#QD516.M43

2.11 Davis, E. James; & Schweiger, G; “The Airborne Microparticle—Its Physics, Chemistry, Optics, and Transport Phenomenon” 2002, Springer Verlag ISBN 3-540-43364-3

2.12 Frohn, Arnold; Roth, Norbert “Dynamics of Droplets”, Springer Verlag 2000 ISBN 3-540-65887-4

2.13 Orme, M. “On the genesis of droplet stream micro-speed dispersions.” Physics of Fluids A, 3, 12, 2936, 1991

2.14 Sirignano, William A. “Fluid Dynamics and Transport of Droplets and Sprays”, 311 p, 1999, Cambridge Univ. Press, ISBN: 0521630363

2.15 Chigier, N. et al. (Re: Electrostatic reduction of liquid jets to form micro droplets. See ILASS 2001 or 2002 proceedings)

### BACKGROUND PRIOR ART DROP & SPRAY FORMATION

Many physical and chemical processes depend on the surface area of liquid or the interfacial area between two fluids (e.g., between a liquid and a gas or a second liquid). Heat exchange between two fluids in direct contact depends on the interfacial area between them and thus on the specific interfacial area (surface area per mass). Similarly the evaporation rate depends on the specific surface area. Chemical reactions between a “liquid” and a gas typically occur only between the vapor evaporated from the liquid, and the surrounding gas.

3.1 Sprays & Droplet Formation

3.1.1 Drop Formation

Sprays are commonly used to break up liquid jets into small drops. Drops are shattered into smaller droplets as a high speed flow interacts with a second flow. However these form drops with a relatively broad size distribution. E.g., Diesel sprays use orifices about 10 micrometers (μm) to 60 μm in diameter. Traditional sprays may have drop sizes differing by ten fold or more. E.g., 3 μm to 50 μm.

3.1.2 Conventional Fluid Swirlers/Mixers

Slowly flowing fluids are often laminar, making it difficult to uniformly mix sprays with flows. Flows are often injected rapidly to cause turbulence to increase mixing. However it is still difficult to achieve large scale mixing fluids between the center and periphery of flows. Conventional systems use mechanical swirlers to create fluid swirl about an axis parallel to the flow. They also try to direct gas flows to achieve a recirculating zone within a duct or combustor to achieve good mixing. Cheng (2002) uses radial injection of diluent air and stem to achieve radial recirculation zones. However such measures create pressure drops and corresponding pumping losses. E.g., Combustors typically have about 4% to 7% pressure drop in trying to uniformly mix fuel with compressed air.

3.1.3 Pumping Loss

Pumping losses for gases are substantial. Compressing gas typically results in losses about 11% of compression power or more due to compressor (turbomachinery) inefficiencies. These compression losses are compounded at higher pressures where such compressors are staged in sequence. Large and small turbine power systems commonly use two to six times as much air for cooling combustion gases as that required for stoichiometric combustion. Parasitic pumping costs for liquids also become significant at higher pressures currently being used e.g., The latest Diesel fuel systems pump and inject fluid at a pressure of about 2,600 bar (about 39,000 psi). This Pressure Volume work of injecting Diesel fuel is 82% of that required to compress 110% of stoichiometric air to 10 Bar with a temperature of 788 K.

3.1.4 Distributed Orifices Along a Tube

Common garden hose sprinklers or soakers provide a line of orifices along a tube which are used to spray water resulting in a typical distribution of drop sizes. Drip irrigation hoses use similar perforated tubes forming large drops at a slow rate. Water treatment systems commonly use porous ceramic bubblers located along supply manifolds to create large quantities of air bubbles. Again these do not provide uniform (or prescribed, predetermined or pre-selected) small orifices.

3.1.5 Droplet Flash Breakup

When liquids are superheated and injected into lower pressure fluids, they “flash” and rapidly evaporate. Bubbles form within drops by homogeneous or heterogeneous nucleation. These bubbles rapidly expand and shatter the drops, forming droplets about ten times smaller. (Sometimes referred to as droplets “exploding”).

U.S. Pat. No. 5,617,719 (see Appendix A), U.S. Pat. No. 5,743,080 (see Appendix B), and U.S. Pat. No. 6,289,666 (see Appendix C), to Lyle Ginter, the entirety of each one of which is hereby incorporated by reference herein, teach injection of superheated water into a combustor. The water drops subsequently flash into smaller drops and evaporate. When liquid temperature is high enough that the vapor pressure of the liquid injected is greater than the pressure of the surrounding fluid plus the drop internal pressure due to surface energy, the drop will break up or shatter into smaller drops. In U.S. Pat. No. 6,289,666 Ginter further teaches injecting water into the compressor intake, into the compressed air stream formed by the compressor, within or after the combustor and elsewhere as envisioned by the skilled artisan.

In U.S. Pat. No. 6,263,661 van der Burgt and van Liere similarly teach using the SwirlFlash® injectors to inject superheated water into compressors. Alpha Power Systems (Netherlands) reports a broad distribution with large 4 μm to 50 μm drops which shatter into a narrow distribution of 2.2 μm to 3.5 μm drops when spraying 200° C. water within the first few stages of a compressor. The vapor formed by droplet evaporation must then be compressed by the compressor, offsetting some of the benefits of cooling the air being compressed.

3.1.6 Forming Uniform Small Drops from Uniform Small Orifices

As fluid is emitted from an orifice, it first forms a “sessile” drop shape, and then a “pendant” drop shape. Uniform liquid drops are formed when pendant shaped drops leave a smooth uniform orifice under constant positive differential pressure, temperature and acceleration (e.g., gravity). Here the differential pressure is defined here as the pressure Pᵢ at the inside opening of the orifice within the tube less the pressure Pₒ at the outer orifice opening outside the tube.

3.1.7 Orifice Excitation

This drop size repeatability is improved by applying a transverse vibration to the nozzle at a precise frequency. According to Lord Raleigh, drops form from an axisymmetric jet emanating from a nozzle of radius rₒ when the non-dimensional wavenumber k*ₒ is less than unity where k*ₒ is equal to two Pᵢ times rₒ divided by lambda (λ), where lambda is the wavelength corresponding to the excitation frequency omega (ω) corresponding to the characteristic capillary speed V_{c}. I.e.

$$ω = \frac{{V}_{c}}{λ} = \frac{0.56 {V}_{c}}{2 {P}_{i} {r}_{o}}$$

Orme (1991) found that a drop stream in vacuum was most uniform, giving the least dispersion of drop speed, when the growth rate of the capillary stream prior to droplet formation was at maximum. These occurred at a wavenumber k*ₒ of about 0.56. The National Institute of Science and Technology (NIST) is using this method to generate standard sized spheres in the 0.1 μm to 30 μm range. NIST reports achieving a relative size precision of the order of about 0.025%.

3.1.8 Droplet Arrays

William Sirignano (1999, Ch 4) reviews “Droplet Arrays and Groups”. He refers to “Twardus and Brzustowski (1977), Labowsky (1978), Umemura et al. (1981a, 1981b), Tal and Sirignano (1982, 1984) and Tal et al. (1983, 1984a, 1984b).” Sirignano states: “This last group of investigators has examined a few droplets or spherical particles in a well defined geometry or a large number of droplets in a periodic configuration. Let us define these arrangements as droplet arrays. These arrays are artificial and contrived but can be useful in obtaining information about the third phenomenon and, to some extent, about the second phenomenon. Since the number of droplets in an array is typically small, the impact on the primary ambient conditions is not significant and arrays are not useful for studying the first phenomenon.” (Op cit p 122). Thus, Sirignano notes theoretical analysis using small droplet arrays with a few small laboratory experiments, but gives no indication of reduction to practice for commercially useful configurations.

Frohn & Roth (2000) schematically describe a linear array of five orifices in a plate, and a three-dimensional droplet array of three orifices in a plate. (Op cit. FIG. 3.3. p 91) They observe: “Orifice plates with several hundred orifices have been realized.” (Op cit. p 92) They cite Anders, Frohn Karl and Roth's (1996) measurements of flame propagation in planar droplet arrays of three or five droplet streams. They only describe orifice plates with a few orifices and do not describe orifices in tubes.

3.1.9 Electro Drop Breakup

Electric fields were demonstrated to influence drop and sprays in the 17^{th} century. In 1878, Lord Rayleigh described the mechanism by which a liquid stream breaks up into droplets. He further derived the charge to surface energy limit beyond which a drop will shatter. Chigier et al. (2002) report liquid jets necking down to smaller jets and then multiple jets in the presence of electric field gradients.

3.1.10 Slurry Evaporation

In the prior art, fluids with slurried or dissolved solids (such as milk) are injected into driers through injectors that create a broad range of drop sizes. The very small drops result in very small solid particles. A substantial portion of these small particles are entrained with the hot exit gas and are not collected by the particle recovery systems. This results in significant loss of product and revenue. Conversely, it is difficult to evaporate the very large drop sizes. These requires extensive residence time with larger equipment and operating costs. If the carrier liquid in these large drops are not fully evaporated, then it is carried over into the product, resulting in increased moisture and caking of the product.

### SUMMARY OF SOME EMBODIMENTS OF STREAMLINED PERFORATED TUBE ARRAYS

4.1 Summary

In some embodiments, users form arrays of streamlined perforated tubes distributed across a flow to efficiently contact one or more fluids flowing through one or more tubes with a second fluid flowing across the tubes.

In some embodiments, users form precise arrays of orifices of uniform size or prescribed, predetermined or pre-selected sizes about and along thin wall or ultra-thin wall tubes.

In some embodiments, users preferably prepare compound perforated tubes to form smaller orifices. Users preferably form structural upstream tube sections. Users then form perforated downstream tube sections from thin strips or foils and bond these to the structural sections.

In some embodiments, users form arrays of perforated tubes attached to supply manifolds. Users preferably offset adjacent tubes upstream/downstream to increase flow area between tubes and reduce the pressure drop across the array. Users preferably streamline the tube's shape (upstream to downstream), orifice size and distribution and tube to tube spacing to optimize fluid compression and pumping costs and mixing uniformity versus tube construction costs. See, e.g., FIG. 1A which is a conceptual illustration of a helical perforated tube inside a duct in perspective view. (See also, e.g., FIGS. 1B-1D.)

In some embodiments, using these arrays of distributed tubes, users consequently create corresponding downstream arrays of vortices that effectively mix the two fluids (e.g., droplets with the cross-flowing fluid). In some embodiments, users further increase turbulence and mixing by orienting the orifices transverse to the flow and/or adding micro-swirlers along or between the distribution tubes. In some embodiments, users preferably provide structural supports to further strengthen or stiffen the tube arrays as needed to withstand the bending and pressure oscillations created by the flows and vortices.

By means of such embodiments, users create microjets and/or droplets of a first fluid flow and uniformly mix them with a second fluid flow.

### SOME OBJECTS AND ADVANTAGES

Some objects and advantages of certain embodiments of this invention are as follows:

5.1.1 Distribute small orifices of uniform or prescribed sizes in a prescribed, predetermined or pre-selected sizes in a prescribed, predetermined or pre-selected manner across a space or flow;

5.1.2 Deliver microjets of a first fluid through those orifices with a narrow prescribed spatial distribution;

5.1.3 Deliver monodisperse droplets or droplets through those orifices with preferably, a narrow and/or prescribed, predetermined or pre-selected size distribution;

5.1.4 Provide a high specific surface area with a substantially uniform surface area per drop or a narrow size distribution;

5.2 Methods using a Single Fluid

5.2.1 Distribute a first fluid uniformly or in a prescribed, predetermined or pre-selected manner across a space;

5.2.2 Distribute drops of a first fluid substantially uniformly or in a prescribed, predetermined or pre-selected manner and with a substantially uniform or prescribed, predetermined or pre-selected size distribution across a space;

5.2.3 Provide precise digital modulation and control of drop formation, drop size and drop delivery rates;

5.2.4 Form powders of uniform or prescribed, predetermined or pre-selected narrow size distribution from distributed drops;

5.3 Methods using a Plurality of Fluids

5.3.1 Distribute a first fluid in a uniform or prescribed, predetermined or pre-selected manner throughout a second fluid flow;

5.3.2 Form arrays of perforated tubes to distribute and mix a first fluid flowing through the tubes and out the orifices with a second fluid flowing across the tubes, in a uniform or prescribed, predetermined or pre-selected manner;

5.3.3 Create droplets (or bubbles) of a first fluid in a second fluid that are monodisperse or have a narrow or prescribed, predetermined or pre-selected size distribution;

5.3.4 Position and orient orifices along and about tubes to deliver droplets of a first fluid in prescribed, predetermined or pre-selected volumes of a second fluid in the fluid flow between those perforated distribution tubes;

5.3.5 Provide mixing turbulence substantially uniformly across a flow with a lower energy;

5.3.6 Precisely control the distribution of the ratio of a first fluid flowing out through tube orifices to a second fluid flowing across one or more perforated distribution tubes;

5.3.7 Evaporate drops with a narrow distribution of evaporation times in a space or prescribed, predetermined or pre-selected fluid flow;

5.3.8 Provide a residence time that ensures that a prescribed, predetermined or pre-selected fraction of fluid drops is evaporated within a given probability;

5.3.9 Provide a residence time and a narrow drop size distribution that ensure that there is less than a prescribed, predetermined or pre-selected probability of unevaporated drops greater than a prescribed, predetermined or pre-selected size in the exit flow;

5.3.10 Provide preferably a very wide “turn down ratio” ranging from “drops on demand” to a maximum prescribed, predetermined or pre-selected ratio of fluids;

5.3.11 Provide preferably very precise control of the ratio of a first fluid that is evaporated in a second fluid;

5.4 Improve Heat Exchanger Efficiency

5.4.1 Reduce the temperature differential between two fluids in a heat exchanger and preferably its fluid temperature distribution, thereby improving system thermodynamic efficiency, capital and operating costs;

5.4.2 Provide preferably a very high direct contact surface area per unit injected fluid mass to increase heat transfer, evaporation rates, condensation rates and/or chemical reactions;

5.4.3 Efficiently contact a second fluid by a first liquid to efficiently heat or cool the second fluid flow;

5.4.4 Form a direct contact condenser with uniform drop sizes to efficiently recover vaporized liquid from a fluid flow;

5.4.5 Reduce the total energy required to pump two fluids and distribute and mix the first fluid in the second fluid;

5.4.6 Reduce the energy required to pump and uniformly mix a first liquid in a second generally gaseous fluid;

5.4.7 Provide methods of efficiently removing particulates from a second fluid flow by contacting them with a first liquid flowing through multiple tube orifices;

5.4.8 Provide methods of introducing two or more fluids into the second fluid by providing two or more distributed perforated tube arrays distributing those fluids into a flow of the second fluid; and

5.4.9 Provide techniques or methods to control the ratios of introduced fluids to the second fluid.

For purposes of summarizing the invention, certain aspects, advantages and novel features of the invention have been described herein above. Of course, it is to be understood that not necessarily all such advantages may be achieved in accordance with any particular embodiment of the invention. Thus, the invention may be embodied or carried out in a manner that achieves or optimizes one advantage or group of advantages as taught or suggested herein without necessarily achieving other advantages as may be taught or suggested herein.

All of these embodiments are intended to be within the scope of the invention herein disclosed. These and other embodiments of the invention will become readily apparent to those skilled in the art from the following detailed description of the preferred embodiments having reference to the attached figures, the invention not being limited to any particular preferred embodiment(s) disclosed.

### BRIEF DESCRIPTION OF THE DRAWINGS

Having thus summarized the general nature of the invention and some of its features and advantages, certain preferred embodiments and modifications thereof will become apparent to those skilled in the art from the detailed description herein having reference to the figures that follow, of which:

FIG. 1A is a simplified conceptual perspective view of a distributed fluid contactor, having features and advantages in accordance with one embodiment of the invention;

FIG. 1B is a simplified schematic view of a tube wall, perforated thin-wall tube or perforated foil tube of a distributed fluid contactor system, having features and advantages in accordance with one embodiment of the invention;

FIG. 1C is a simplified schematic view of a hexagonal array of orifices of a distributed fluid contactor system, having features and advantages in accordance with one embodiment of the invention;

FIG. 1D is a simplified schematic view of a Cartesian array (at about 45°) of orifices of a distributed fluid contactor system, having features and advantages in accordance with one embodiment of the invention;

FIG. 2 is a simplified schematic view of a perforated flat or arc thinned wall tube of a distributed fluid contactor system, having features and advantages in accordance with one embodiment of the invention;

FIG. 3 is a simplified schematic exploded view of orifices in a thin tube wall of a distributed fluid contactor system, having features and advantages in accordance with one embodiment of the invention;

FIG. 4 is a simplified view of a compound perforated tube of a distributed fluid contactor system, having features and advantages in accordance with one embodiment of the invention;

FIG. 5 is a simplified schematic view of an aerodynamic compound perforated tube of a distributed fluid contactor system, having features and advantages in accordance with one embodiment of the invention;

FIG. 6 is a simplified schematic view illustrating the arrangement and relative spacing between a pair of compound perforated tubes of a distributed fluid contactor system, having features and advantages in accordance with one embodiment of the invention;

FIG. 7 is a simplified schematic view of a ribbed tubular structure to support perforated foils of a distributed fluid contactor system, including transverse support ribs and upstream and downstream curved support strips, and having features and advantages in accordance with one embodiment of the invention;

FIG. 8 is a simplified schematic view of a trifluid direct contactor system, burner or combustor, having features and advantages in accordance with one embodiment of the invention;

FIGS. 9A and 9B are simplified schematic views of conical orifice configurations opening outward or inward, having features and advantages in accordance with embodiments of the invention;

FIG. 10A is a simplified schematic cross sectional view of a circular perforated tube, having features and advantages in accordance with one embodiment of the invention;

FIG. 10B is a simplified schematic cross sectional view of an oval perforated tube, having features and advantages in accordance with one embodiment of the invention;

FIG. 10C is a simplified schematic cross sectional view of a streamlined perforated tube, having features and advantages in accordance with one embodiment of the invention;

FIG. 10D is a simplified schematic cross sectional view of a flattened perforated tube, having features and advantages in accordance with one embodiment of the invention;

FIG. 10E is a simplified schematic cross sectional view of a flattened dual chamber perforated tube, having features and advantages in accordance with one embodiment of the invention;

FIG. 10F is a simplified schematic cross sectional view of a flattened single chamber perforated tube, having features and advantages in accordance with one embodiment of the invention;

FIG. 10G is a simplified schematic cross sectional view of an asymmetric streamlined perforated tube, having features and advantages in accordance with one embodiment of the invention;

FIG. 10H is a simplified schematic cross sectional view of triangular perforated tube, having features and advantages in accordance with one embodiment of the invention;

FIG. 11A is a simplified schematic perspective view of a circular array of perforated tubes across the flow within a duct, having features and advantages in accordance with one embodiment of the invention;

FIG. 11B is a simplified schematic perspective view of a cylindrical array of perforated tubes parallel to the flow within a duct, having features and advantages in accordance with one embodiment of the invention;

FIG. 12A is a simplified schematic view of a circular array of perforated tubes connected to manifolds, having features and advantages in accordance with one embodiment of the invention;

FIG. 12B is a simplified schematic view of a rectangular array of perforated tubes connected to manifolds, having features and advantages in accordance with one embodiment of the invention;

FIG. 12C is a simplified schematic view of an annular array of perforated tubes connected to manifolds, having features and advantages in accordance with one embodiment of the invention;

FIG. 12D is a simplified schematic view of a three dimensional conical array of perforated tubes connected to manifolds inside a duct, having features and advantages in accordance with one embodiment of the invention;

FIG. 12E is a simplified schematic view of a three dimensional rectangular tent array of perforated tubes connected to manifolds, having features and advantages in accordance with one embodiment of the invention;

FIG. 12F is a simplified schematic view of a three dimensional annular tent array of perforated tubes connected to manifolds, having features and advantages in accordance with one embodiment of the invention;

FIG. 12G is a simplified schematic view of a three dimensional cylindrical array of perforated tubes connected to manifolds, having features and advantages in accordance with one embodiment of the invention;

FIG. 12H is a simplified schematic view of a three dimensional can array of perforated tubes connected to manifolds, having features and advantages in accordance with one embodiment of the invention;

FIG. 13A is a simplified perspective of two linear array of orifices on both sides of a perforated tube, having features and advantages in accordance with one embodiment of the invention;

FIG. 13B is a simplified perspective of columnar arcs of orifices on both sides of a perforated tube, having features and advantages in accordance with one embodiment of the invention;

FIG. 13C is a simplified perspective view of columnar arrays of orifices on both sides of a perforated tube, having features and advantages in accordance with one embodiment of the invention;

FIG. 14A is a simplified perspective of a radial variation in orifice spatial density in a circular array of perforated tubes, having features and advantages in accordance with one embodiment of the invention;

FIG. 14B is a simplified perspective view of a transverse variation in orifice spatial density in a rectangular array of perforated tube connected to manifolds, having features and advantages in accordance with one embodiment of the invention;

FIG. 14C is a simplified perspective view of a perforated tube with two rows of orifices with size gradations, having features and advantages in accordance with one embodiment of the invention;

FIG. 14D is a simplified perspective view of a perforated tube containing columns of orifices that change in a stepped fashion, having features and advantages in accordance with one embodiment of the invention;

FIG. 14E is a simplified perspective view of a perforated tube containing orifices that are positioned and sized in a random fashion, having features and advantages in accordance with one embodiment of the invention;

FIG. 14F is a simplified perspective view of a hemispherical end to a tube perforated with orifices, having features and advantages in accordance with one embodiment of the invention;

FIG. 15A is a simplified schematic view of a two perforated tubes with diagonally opposed orifices, with tubes laid up in parallel, having features and advantages in accordance with one embodiment of the invention;

FIG. 15B is a simplified schematic view of a two perforated tubes with diagonally opposed orifices, configured with tubes laid up opposite each other, having features and advantages in accordance with one embodiment of the invention;

FIG. 15C is a simplified schematic view of a two perforated tubes with diagonally oriented orifices in chevron pattern, with tubes laid up in parallel, having features and advantages in accordance with one embodiment of the invention;

FIG. 15D is a simplified schematic view of a two perforated tubes with diagonally oriented orifices in chevron pattern, with tubes laid up opposite each other, having features and advantages in accordance with one embodiment of the invention;

FIG. 16A is a simplified perspective view of perforated tubes encircling a cylindrical duct and connected to manifolds, having features and advantages in accordance with one embodiment of the invention;

FIG. 16B is a simplified perspective view of perforated tubes oriented about a cylindrical duct and parallel to its axis, and connected to manifolds, having features and advantages in accordance with one embodiment of the invention;

FIG. 17A is a simplified schematic view of perforated tubes in a “tent” or “conical” arrangement oriented in a “funnel” shape within a duct, having features and advantages in accordance with one embodiment of the invention;

FIG. 17B is a simplified schematic view of perforated tubes oriented about “pleated” array, within a duct, having features and advantages in accordance with one embodiment of the invention;

FIG. 17C is a simplified schematic view of perforated tubes arranged in a “compound” array, within a duct, having features and advantages in accordance with one embodiment of the invention;

FIG. 18A is a simplified schematic view of upstream perforated tubes in a grounded “horn” conical array with a downstream grid connected to a high voltage power supply, within a duct, having features and advantages in accordance with one embodiment of the invention;

FIG. 18B is a simplified schematic view of two sets of perforated tubes alternatingly connected to negative high voltage electrode or to ground, within a duct, having features and advantages in accordance with one embodiment of the invention;

FIG. 18C is a simplified schematic view of perforated tubes connected to a negative high voltage, within a grounded duct, having features and advantages in accordance with one embodiment of the invention;

FIG. 19 is a simplified perspective view of streamlined stiffeners supporting a “horn” conical array of perforated tubes with streamlined structural supports within a duct, within a grounded duct, having features and advantages in accordance with one embodiment of the invention;

FIG. 20A is a simplified schematic of Flow Control by Minimum (Largest) Orifice Differential Fluid Pressure Switch, having features and advantages in accordance with one embodiment of the invention;

FIG. 20B is a simplified schematic of Flow Control Relative to All Orifice Differential Fluid Pressure, having features and advantages in accordance with one embodiment of the invention;

FIG. 20C is a simplified schematic of Flow Control by Graded Differential Fluid Pressure, having features and advantages in accordance with one embodiment of the invention;

FIG. 20D is a simplified schematic of Flow Control by Digital Pulsation of Fluid Pressure, having features and advantages in accordance with one embodiment of the invention;

FIG. 20E is a simplified schematic of Flow Control by Frequency Modulation of Fluid Pressure, having features and advantages in accordance with one embodiment of the invention;

FIG. 20F is a simplified schematic of Flow Control by Amplitude Modulation of Fluid Pressure, having features in accordance with one embodiment of the invention;

FIG. 21 is a simplified schematic of a general distributed direct contact array system with a controller, having features in accordance with one embodiment of the invention;

FIG. 22 is a simplified schematic of a multiple duct horizontal distributed contactor, having features and advantages in accordance with one or more embodiments of the invention;

FIG. 23A is a simplified schematic cross sectional view of a streamlined perforated tube formed by wrapping a thin strip about two dissimilar wires, having features and advantages in accordance with one embodiment of the invention;

FIG. 23B is a simplified schematic cross sectional view of a streamlined perforated tube formed by wrapping a thin strip about two similar wires, having features and advantages in accordance with one embodiment of the invention;

FIG. 23C is a simplified schematic cross sectional view of a streamlined perforated tube formed by bonding two strips along two dissimilar wires, having features and advantages in accordance with one embodiment of the invention;

FIG. 23D is a simplified schematic cross sectional view of a streamlined perforated tube formed by abutting and bonding two thinned strips on either side of two dissimilar wires, having features and advantages in accordance with one embodiment of the invention; and

FIG. 24 is a simplified schematic cross sectional view of a streamlined perforated tube wall formed by selective thinning and perforation, having features and advantages in accordance with one embodiment of the invention.

### BRIEF DESCRIPTION OF THE APPENDICES

7.1 Appendix A (pages A-1 to A-27) includes U.S. Pat. No. 5,617,719 to Lyle Ginter, the entirety of which is hereby incorporated by reference herein and which is a part of the present disclosure;

7.2 Appendix B (pages B-1 to B-32) includes U.S. Pat. No. 5,743,080 to Lyle Ginter, the entirety of which is hereby incorporated by reference herein and which is a part of the present disclosure; and

7.3 Appendix C (pages C-1 to C-24) includes U.S. Pat. No. 6,289,666 to Lyle Ginter, the entirety of which is hereby incorporated by reference herein and which is a part of the present disclosure.

8 List of Some Components and Certain Nomenclature

A list of some components and certain nomenclature utilized in describing and explaining some embodiments of the invention follows:

Tube

Tube Wall

Tube Inner Diameter Dᵢ

Tube Outer Diameter Dₒ

Tube Wall Thickness T=(Dₒ−Dᵢ)/2

Thinned Tube Wall Section

Thinned Tube Wall Thickness t

Orifice

Orifice Inner Diameter dᵢ

Orifice Outer Diameter dₒ

Orifice Inner Pressure at Inner Opening Pᵢ

Orifice Outer Pressure at Outer Opening Pₒ

Orifice spacing h

Orifice axial angle alpha (α)

Orifice transverse orientation angle theta (θ)

Fluid Duct

Fluid Duct Wall

Fluid Duct Entrance

Fluid Duct Exit

Fluids

First Fluid (passing through a Perforated Tube and out the Orifices)

Second Fluid (passing through Fluid Duct across one or more perforated tubes)

Compound perforated tube

Upstream Structural Tube Section

Downstream Perforated Tube Wall Section

Downstream Structural Tube Section

Tube Rib

Multi-Duct Compound Tube

First Tube Duct

Second Tube Duct

Inter-duct Wall

Manifold

Manifold Side Opening

Manifold End Opening

Manifold Internal Structure

Perforated Tube Array

Planar Tube Array

3-D tube Array

Structural Support

Upstream Stiffener Rib

Downstream Stiffener Rib

Array Mount

Micro-Swirler

Over Tube Swirler

Across Tube Swirler

Between Tube Swirler

First Fluid Delivery System

Storage Tank

Supply Pump

Delivery Pump

Recirculating Pump

Pressure Modulator

Filter

Coarse Liquid Filter

Fine Liquid Filter

Uniform Orifice Filter

Recirculating Bypass Filter

Fluid (Gas) Filter

Second Fluid Delivery System

Blower

Compressor

Tube Vibrator

Physical Sensors

Pressure Sensors

Differential Pressure Sensors

Filter Pressure Drop Sensor

Temperature Sensors

First Fluid Flow Sensor

Second Fluid Flow Sensor

Composition sensors

Oxygen Sensors

Emission Sensors

Speed & Position Sensors

Pump Speed Meter

Compressor/Blower Speed Meter

Pressure Modulator Position Sensor

Controller

First Fluid Controller

Second Fluid Controller

High Voltage Power Supply

Particulate separator

Gravity Separator

Multi-duct Gravity Separator

Cyclone

Electrostatic Precipitator

Impingement Separator

9 Some Exemplary Definitions The following definitions of certain features and components are exemplary and are not to be considered limiting in any way:

Orifice—a mouth or aperture of a tube, cavity etc.; opening

Opening—open place or part; hole; gap; aperture

Aperture—(1) an opening; hole; gap (2) the opening, or the diameter of the opening, in a camera, telescope, etc. through which light passes into the lens

Hole—an opening in or through a solid body, a fabric, etc.; a perforation; a rent; a fissure; a hollow place or cavity; an excavation; a pit; Webster 1913 rearranged

Duct (1)—a tube, channel, or canal through which a gas or liquid moves; (2) a tube in the body for the passage of excretions or secretions; (3) a conducting tubule in plant tissue; (4) a pipe OF conduit through which wires or cables are run, air is circulated or exhausted etc.

1 micro-meter or micrometer (μm)=1 micron=one millionth of a meter.

1 nano-meter or nanometer (nm)=one billionth of a meter.

1 mil=one thousandth of an inch=0.001″=25.4 μm

1 micro-inch or microinch=0.000,001″=25.4 nm

Detailed Description of the Preferred Embodiments

In some embodiments, users select combinations of one or more orifice diameters, number of orifices, orifice configurations, differential fluid pressure, fluid temperature and electric field gradient to achieve the desired or needed delivery drop size and distribution. Users correspondingly select the tube wall thickness, tube diameter and/or orifice forming technology with suitable Thickness/Diameter capabilities.

In some embodiments, users preferably create compound perforated tubes to form thinner walls and smaller orifices than conventionally available.

In some circumstances, that wall thickness may be insufficient to support the desired differential pressure desired or needed to deliver or expel the first fluid through the perforated tubes. In modified embodiments, users further iterate among these parameters to achieve economically suitable combinations. The following description details these methods and the operation of such distributed direct fluid contactors.

10.1 Thin Wall and Compound Perforated Tube Design and Related Methods

Some preferred embodiments and methods thereof relate to creating very large numbers of small uniform orifices (holes, openings) distributed along and about a thin walled tube. A first fluid is directed to flow through the tube and out of the orifices.

In some embodiments, users preferably flow a second fluid across orifices to entrain drops of the first fluid delivered at low differential pressure into that second fluid. In other embodiments, users create a differential pressure across the tubes sufficient to force the first fluid through orifices and form micro-jets into the second fluid.

10.1.1 Number of Orifices or Jets

Conventional systems typically only use a few orifices in a plate or at the end of an injector. In some embodiments of the system of the invention, users preferably perforate one or more sides of tubes with tens to hundreds of orifices per millimeter (mm) of tube length. Users further distribute orifices substantially uniformly across the flow by preparing arrays of perforated tubes across the flow. Thus, users preferably form thousands to hundreds of thousands of orifices or more across the flow.

10.1.2 Fluid Duct(s)

Users deliver the second fluid through one or more fluid duct(s). Users position the perforated tubes within or near the entrance or the exit of the fluid duct depending on the particular application, as needed or desired.

10.1.3 Tube Supports

Users preferably provide structural supports to support the distributed tubes against the bending forces of the cross-flow. In some embodiments, these supports are configured to enable flexure sufficient to accommodate any differential thermal expansion during operation.

10.1.4 Differential Pressure

With a large number of orifices, users can provide a large cumulative cross sectional area of orifices for the first fluid to flow through. Desirably, users no longer require a large positive pressure difference to deliver the first fluid.

Thus, users preferably use a low positive differential pressure to force the first fluid within the tube out through the orifices. This low pressure distribution method strongly reduces the pumping costs typically required in conventional systems which use conventional very high positive differential pressures with a few orifices.

In some embodiments, users increase the differential pressure to create a large number of short jets or micro-jets.

10.1.5 Uniform or Prescribed Distribution through Many Orifices

Some important aspects relate to using many substantially uniform small orifices. Another important aspect is to distribute these about a fluid flow to uniformly mix the first fluid (liquid and/or gas) flowing through orifices with a second fluid (gas and/or liquid) flowing across those orifices. Advantageously, this causes more uniformly and efficient distribution and mixing of fluids. In various embodiments, users may use this distributed fluid contactor method to distribute drops of a first liquid into a second gas, distribute a first gas into a second gas, distribute a first liquid into a second liquid, or distribute a first gas (e.g., bubbles) into a second liquid.

In further embodiments, these liquids may in turn contain a distribution of a second fluid. These may for instance deliver water droplets in a liquid or gaseous fuel. Similarly the fluid flow across the tubes may be a gas entraining water droplets (a “mist” or “fog”). In some embodiments, the liquid flowing through the tubes may have air entrained within it. In other embodiments, the liquid may have nucleated bubbles of vapor formed within the tube.

10.1.6 Smaller Uniform Orifices

Users develop further techniques and methodologies in accordance with some embodiments to make smaller and more uniform orifices to generate smaller droplets (or bubbles) of uniform size. Drilling technologies have limits to an orifice's Thickness/orifice Diameter (t/d) (e.g., by laser drilling). Thus, one innovative features of some embodiments relates to making fluid distribution perforated tubes with thin wall tubing. Users further desirably enhance this by thinning the tube walls so users can perforate the walls with smaller orifices.

10.1.7 Laser Frequency and Power

Users may use several different technologies to create orifices, such as laser drilling, photo-lithographic etching, x-ray lithographic etching, among others. Users preferably select the laser power, frequency and optics according to the orifice diameter and uniformity required. To achieve smaller diameters, users utilize lasers with smaller wavelengths (higher frequencies.) CO₂ lasers can achieve about 20 μm diameter orifices. Eximer lasers can drill orifices of about 1 μm to about 2 μm in diameter with Thickness to Diameter ratios (t/d) of up to 100 or even 200. E.g., in ink jet orifice arrays. Ultraviolet lasers can achieve sub micrometer orifice sizes.

Users may also utilize other drilling methods. For example, friction drilling, mechanical punching, electro drilling. Users typically use these for larger orifices such as forming orifices in manifold ducts where tubes are connected.

10.1.8 Wall Thickness to Orifice Diameter Ratio

Laser drilling can typically achieve a given Wall Thickness (“depth” or orifice “length”) to Orifice Diameter ratios (t/d). E.g., Common laser drilling technology can achieve Thickness/Diameter ratios of 10:1. Some technologies can achieve Thickness/Diameter ratios of 100:1 to 200:1 with Eximer lasers, depending on wavelength. With laser drilling, the orifice size is thus limited to the thickness of the sheet drilled, divided by the Thickness/Diameter (t/d) ratio for a given wavelength. e.g., about 20 μm to 1 μm diameter holes in a 200 μm wall for Thickness/Diameter ratios of 10:1 to 200:1.

Table 1 shows the variation in tube wall thickness as a function of tube wall thickness to diameter ratios for a range of tube diameters from 1 mm to 16 mm.

TABLE 1
Wall Thickness μm versus Tube Diameter for various Tube Wall
Thickness/Diameters

| Wall | | | | | | | | | | |
|---|---|---|---|---|---|---|---|---|---|---|
| Thickness/ | Tube Diameter mm | | | | | | | | | |
| Diameter | 16 | 12 | 10 | 8 | 6 | 5 | 4 | 3 | 2 | 1 |
| 4 | 4000 | 3000 | 2500 | 2000 | 1500 | 1250 | 1000 | 750 | 500 | 250 |
| 6 | 2667 | 2000 | 1667 | 1333 | 1000 | 833 | 667 | 500 | 333 | 167 |
| 8 | 2000 | 1500 | 1250 | 1000 | 750 | 625 | 500 | 375 | 250 | 125 |
| 10 | 1600 | 1200 | 1000 | 800 | 600 | 500 | 400 | 300 | 200 | 100 |
| 12 | 1667 | 1000 | 933 | 750 | 500 | 418 | 333 | 250 | 166 | 83 |

Table 2 shows the consequent orifice diameters for various tube wall thicknesses as a function of wall thickness to orifice diameter ratio of the drilling technology used.

TABLE 2
Orifice Diameter μm versus Wall Thickness μm for various Thickness/Diameter Limits

| Thickness/ | Wall or Sheet Thickness micrometers (μm) | | | | | | | | | |
|---|---|---|---|---|---|---|---|---|---|---|
| Diameter | 1000 | 500 | 200 | 100 | 50 | 20 | 10 | 5 | 2 | 1 |
| 2 | 500 | 250 | 100 | 50 | 25 | 10 | 5 | 2.5 | 1 | 0.5 |
| 5 | 200 | 100 | 40 | 20 | 10 | 4 | 2 | 1 | 0.4 | 0.2 |
| 10 | 100 | 50 | 20 | 10 | 5 | 2 | 1 | 0.5 | 0.2 | 0.1 |
| 20 | 50 | 25 | 10 | 5 | 2.5 | 1 | 0.5 | 0.25 | 0.1 | 0.05 |
| 50 | 20 | 10 | 4 | 2 | 1 | 0.4 | 0.2 | 0.1 | 0.04 | 0.02 |
| 100 | 10 | 5 | 2 | 1 | 0.5 | 0.2 | 0.1 | 0.05 | 0.02 | 0.01 |

10.1.9 Many Uniform Orifices

Some embodiments of the invention provide tens to hundreds of orifices per mm of tube length. E.g., by making 20 μm orifices every 60 μm along a thin walled tube, users create about 17 orifices/mm tube length. By wrapping 3 meters (m) of such thin walled perforated tubing into a conical distributed fluid contactor, users provide 50,000 orifices distributed across the flow. Similarly, by reducing orifice size to 2 μm spaced every 6 μm axially along a perforated tube in 200 axial rows circumferentially about that tube, users nominally achieve about 33,000 orifices/mm tube length. Using about 3 m of such conical distributed fluid contactor, users would advantageously provide about 100 million orifices distributed across the flow.

These methods provide far greater number of nozzles than conventional systems which provide just a few nozzles with one or a few orifices per nozzle. E.g., a large bore Diesel engine may use three nozzles each with six orifices, forming a total of 18 orifices.

10.1.10 Thin Wall Perforated Tubes

Conventional Diesel injectors may use 10 μm to 60 μm diameter orifices with high pressure heavy walled tubing. By using smaller orifices users create small drops or droplets while significantly reducing the injection pressure. Thin-walled tubes with diameter to wall thickness ratios (D/t) of 8 to 10 are available (e.g., with 760 μm or 0.030″ OD, and 500 μm or 0.020″ ID). Users nominally consider “thin wall tubes” as having wall thicknesses of 1,000 μm to 200 μm.

Users preferably use such thin wall tubing to make 100 μm to 20 μm diameter orifices (0.004″ to 0.000,8″ diameter orifices) directly in the thin tube wall using an orifice forming technology such as laser drilling which can form orifices with at least a 10:1 Thickness/Diameter (t/d) ratio. With such orifices, users advantageously form simple drops with diameters in the range from about 200 μm to 40 μm with low differential positive pressures and flows. With such thin walls, users can further reduce the orifice sizes down to a range of 10 μm to 2 μm by using laser drilling technology capable of thickness to diameter (t/d) ratios of 100:1.

Of course, as the skilled artisan will appreciate, other suitable nominal thicknesses for the thin wall tubes may be efficaciously utilized, as needed or desired, giving due consideration to the goals of achieving one or more of the benefits and advantages as taught or suggested herein.

10.1.11 Ultra-Thin Wall Perforated Tubes

In some embodiments, for still smaller orifices, users select thinner walled tubing or use orifice forming technologies capable of higher Thickness/Diameter (t/d) ratios. Ultra-thin walled tubes are commonly available with wall thicknesses from about 200 μm down to about 125 μm (about 0.008″ to 0.005″) or even to about 75 μm (about 0.003″). With such ultra-thin walled tubing, users readily form orifices with diameters down to about 20 μm to 8 μm using laser hole drilling technology capable of Thickness/Diameter ratios of 10:1. With 100:1 laser drilling technology using short wavelength (high frequency) lasers, users could potentially form orifices of 2 μm to 0.8 μm in diameter with such ultra-thin wall tubing.

10.2 Thinning Walls to Form Thin Walled Tubes

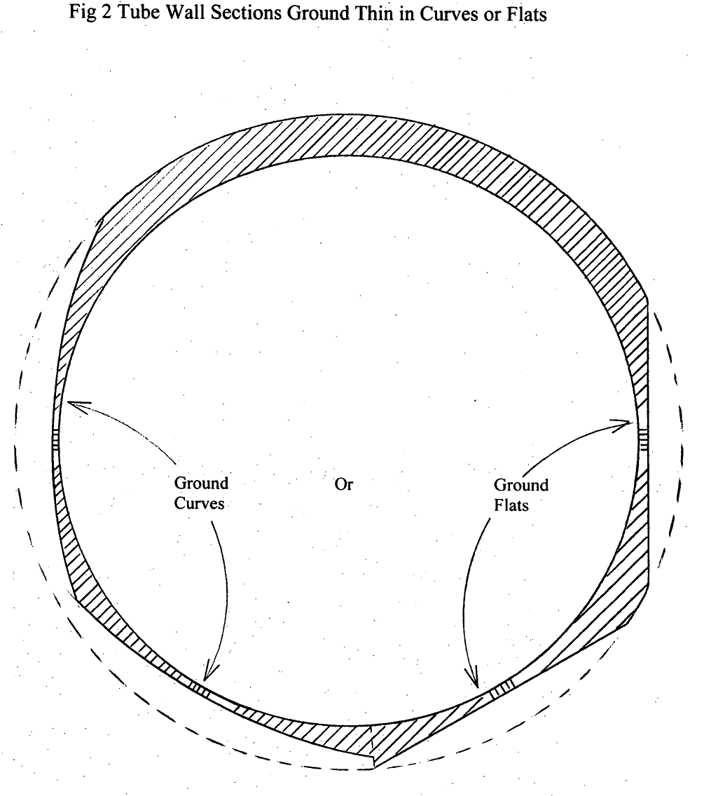

The size of holes formed in tubing is nominally limited by the thickness of the tubing and the Length/Diameter capabilities of the hole forming method. In modified embodiments, users form smaller diameter holes by thinning the tube wall. Tube walls are machined, or ground thinner, or thinned by electrochemical machining. (See, for example, FIG. 2 and FIG. 3)

The final thickness is preferably refined by precision surface grinding as desired or needed. For example, with precision grinding to a tolerance of about 2.5 μm (0.000,1″), users nominally machine a tube of about 4 mm diameter with about 200 μm thick walls and then surface grind the tube wall to a thickness of about 20 μm to about 30 μm.

10.2.1 Grind Arcs or Flats on Tubing

To form thinner walls, in some embodiments, users further grind an arc (or a flat) onto a tube to create a thin sections aligned axially along the outer surface of the tubing. The wall thickness at the thinnest sections could be coarsely machined and then ground down to a wall thickness of a given a multiple of the grinding precision tolerance. E.g., grinding the wall thickness to about a 10 fold multiple of a grinding precision of about 2.5 μm would nominally permit grinding down to nominally 25 μm thick walls.

CNC Industries of Fort Wayne Ind. USA, and Alpha Technologie company of Thyez France, are two companies for example specializing in precision surface grinding. They claim to nominally hold the surface tolerance to 2.5 micrometers (0.000,1″) with precision grinding. This is about 10% of the desired final wall thickness.

10.2.2 Forming Thin Sheet into Thin Walled Tubing

To further improve on the uniformity of forming thin walled tubing, in another embodiment, users preferably take thin sheet with substantially uniform thickness, bend and form it into a tube. The sheet edges are then bonded together to complete the tube. This method creates a tube with much greater wall uniformity than conventional drawing etc. Consequently, the orifices created will have much more uniform diameters.

10.2.3 Hole Drilling

An ultra thin wall thickness of about 25 micrometers will enable users to subsequently drill holes of about 2.5 μm holes, using a drilling technology with a thickness/diameter ratio of about 10. Thus, the hole diameter achievable is of the order of the precision of the surface grinding tolerance. By forming a thin arc, users drill multiple holes transversely around the perimeter of the tube in this thinned section. Users then extend this linear array along the length of the tube.

10.2.4 Multiple Arcs or Flats Around Tubing

This methodology is then extended to form multiple arcs or flats around the tube. E.g., two thin sections on either side. The number of arcs or flats can be extended to three, four, five or more sections around the tube.e.g., in hexagonal arcs or flats.

10.3 Micro-Orifices in Compound Ultra-thin Walled Perforated Tubes

To distribute even smaller orifices, in some embodiments, users form compound perforated tubes with thinner walls by bonding thin perforated formed strips or foils to heavier formed structural supports. In some embodiments users form orifices using technologies (such as Laser drilling) with higher Thickness/Diameter ratios and/or smaller radiation wavelengths (higher frequency), to form smaller orifices.

Practical ultra-thin wall tube systems may require structural support to withstand the bending forces of the external second fluid flow across the tube as well as to handle forces due to gravity and vibration. To support these bending forces, in some embodiments users take a thicker upstream tube portion formed from strips thick enough to provide structural support. Users make the small orifices through one or more thin perforated strips and form them into the downstream portion of the tube.

Users preferably form an ultra-thin walled compound perforated tube by bonding the downstream thin walled tube portion to the upstream structural portion. E.g. users bond thin strips, of about 500 μm to 50 μm thick, onto thicker support walls, either within or without the upstream support. With this construction method, users advantageously create tubes with larger effective tube diameter/wall thickness ratio. (See, for example, FIG. 4.)

10.3.1 Forming Small Orifices in Thin Sheets or Foils

With a range of Thickness/Diameter orifice forming technologies and thin sheet or foil thicknesses available, users variously achieve orifice diameters of about 25 μm down to sub-micron sizes for a range of sheet thickness from about 1000 μm to 1 μm. (Smaller orifices can be formed with deep ultra-violet, electron or x-ray forming technologies as these technologies progress.) Assuming pendant drops are formed with sizes twice the orifice diameter, users nominally form uniform drops from about 50 μm to 0.5 μm in diameter from an array of orifices of substantially uniform size.

10.3.2 Compound Foil-Walled Perforated Tubes

In further embodiments, users form ultra-thin walled compound tubes using even thinner sheets or “foil” to create still smaller orifices. e.g., walls less than about 50 μm thick. Stainless steel structural foils are available in at least in about 30 μm, 25 μm, and 20 μm thin sheets. E.g., Metal Foils, LLC provides stainless steel foils from 250 μm down to 25 μm (0.010″ down to 0.001″). Emitec Inc. of Augurn Hills, Mich., and Lohmar in Germany, manufacturer heat exchangers using foils of such thicknesses which they purchase from at least three reliable manufacturers.

Given the thinnest acceptable metal foil thickness, users preferably divide by the Thickness/Diameter ratio of the drilling technology used to arrive at the orifice diameter. (e.g., divide wall thickness by 10 for common laser drilling technologies.) To achieve smaller orifices, users can select shorter wavelength (higher frequency) lasers and/or use lasers capable of higher Thickness/Diameter ratios as needed or desired. (Some companies claim Thickness/Diameter ratios of 100 or higher for eximer laser drilling etc.) Thus, users can laser drill about 2 μm diameter orifices through 20 μm thick stainless steel foil. (Conversely, given a desired orifice diameter and the thickness/diameter limit of a drilling technique, users can calculate the desired thickness of the thin sheet or foil.)

In some embodiments, users may utilize even thinner foils. E.g., ACF Metals of Tucson Ariz. makes ultra-thin metal foils with thicknesses of about 5 micrometers (em) down to about 1 nanometer (nm).

10.4 Two Section Compound Perforated Tube

10.4.1 Cut Structural Strip

In some embodiments, users take thin stainless steel sheet and cut a structural strip to a width about equal to the circumference of the upstream portion of an elliptical support tube section. I.e. the sheet is cut to a width of about πD/2. As an example, to create a half tube about 4 mm in outer diameter, a stainless steel sheet of about 0.2 to 1.0 mm thick is selected depending on the bending strength or stiffness required. This is then cut to a width of about 6.3 mm. This strip is then formed into the desired upstream streamlined shape.

10.4.2 Thin Wall Strip

In some embodiments, the lower thin downstream wall portion is prepared cutting a thin strip from thin sheet material or foil. In some embodiments, users select the stainless steel foil with thin but commercially available thickness e.g., preferably about the desired diameter of the orifices times the length/diameter ratio of the hole forming method. E.g., about 20 to 30 μm (about 0.02 mm to about 0.03 mm) thick to prepare small holes about 2 μm to 3 μm in diameter, using a laser capable of drilling holes with a 10:1 length/diameter ratio.

10.4.3 Thin Foil Downstream Perforated Wall Section

Wrapped downstream portion: In some embodiments, the ultra-thin sheet is cut into a strip about equal to the circumference of the desired tube. This is formed into the desired shape and wrapped around the upper structural tube portion.

Part downstream portion: In other embodiments, users prepare a strip of stainless steel foil about equal to the circumference of the remaining downstream streamlined portion of the desired tube, plus an amount to overlap and bond to the top half of the tubing. For example, the downstream portion may be about 7.5 mm to 8.5 mm wide, with about 0.5 mm to about 1 mm overlap on each side. This results in a thin-wall strip about 8.5 mm to 10.5 mm wide.

10.4.4 Indented Attachment Edges

In some modified embodiments, users press or grind a thin indent a little greater than the thickness of the perforated thin wall or foil on each outer edge of the structural strip. e.g., about 25 to 35 micrometers deep. Users preferably form the indent width about equal to or a little greater than the desired attachment width of the foil. E.g., about 0.6 mm to 1.1 mm inward on both outer edges of the structural strip. This provides the benefit of reducing turbulence at the joint between lower to upper tube portions. Various companies claim capability to grind with a precision of about 2.5 μm (0.000,1″). This is about 10% of the desired indent depth.

10.5 Perforate Thin Strip or Foil

In various embodiments, the thin strip or foil strip is perforated with a pattern of fine holes in one or two dimensional arrays or patterns as desired.

Laser drilling: The preferred method of forming orifices is to use lasers to drill fine orifices proportional to the thickness of the material limited by the length/diameter capability of the laser. E.g., The Department of Defense sought a Small Business Innovative Research (SBIR) project #AF02-003 to drill large numbers of 170 μm holes with very high precision. High power lasers evaporate material rapidly, leaving clean uniform holes. Shorter wavelength higher frequency lasers may be used to drill smaller holes. E.g., Ultra-violet lasers can prepare holes down to micrometer or sub-micrometer capability.

Mechanical punch: In other embodiments, users may form linear or spatial arrays of micro-punches to press holes through thin foils.

Electro drill: In further embodiments, users may form holes using an electrode type removal process.

Resist Etch: In some embodiments, users may form holes using a photo-etch method with a resist, similar to methods of forming circuit boards.

Form Longitudinal perforated array: In various embodiments, users preferably form an array of orifices longitudinally along the strip. In other embodiments, users may form two parallel arrays, leaving a solid section in the middle and on either edge. The width of the array is preferably about 1.0 to about 1.5 times the diameter of the tube.

As an example, in some embodiments, users form two parallel arrays about 3.5 mm wide on either side of a solid center band about 1.5 mm wide, leaving a solid strip on either edge of about 0.75 mm wide to which to bond the foil to the tube. This results in perforating about 7 mm of a foil strip of about 10 mm width.

10.5.1 Bond Perforated Downstream Portion to Structural Portion

In various embodiments, users preferably wrap the lower perforated tube portion around the upper portion. The upper edges of the downstream portion are bonded to the upper portion.

In other embodiments, users form the downstream portion and position it to overlap the upper structural portion. Where indents are formed, the edges of the lower thin wall section are preferably positioned into the indents in the upper portion.

Both edges of the perforated downstream half tube are bonded to the supporting half tube. E.g., by induction welding, friction welding, brazing, soldering or gluing according to the temperature and strength required.

10.6 Supported Compound Foil-Wall Perforated Tubes

Thin walls limit the differential pressure that can be supported by a perforated wall. The thinner the wall or foil, the lower the differential pressure or span that the tube can typically tolerate.

In some embodiments, to accommodate thinner walls or foils, users support the thin wall with a heavier structural wall. Users form large orifices in the structural wall. Users further form the perforated foil or ultra-thin and line the inside of large holed structural support wall. The large orifices in the structural support limit the span across which the thin wall or foil must support the differential pressure. The outer structural wall supports the foil against the drag from the cross-flow and against the differential fluid pressure. (See, for example, FIG. 4.)

In alternative embodiments, users form thin perforated wall or foil around the large holed structural support and bond them to the support.

10.7 Centrally Stiffened Compound Perforated Tube

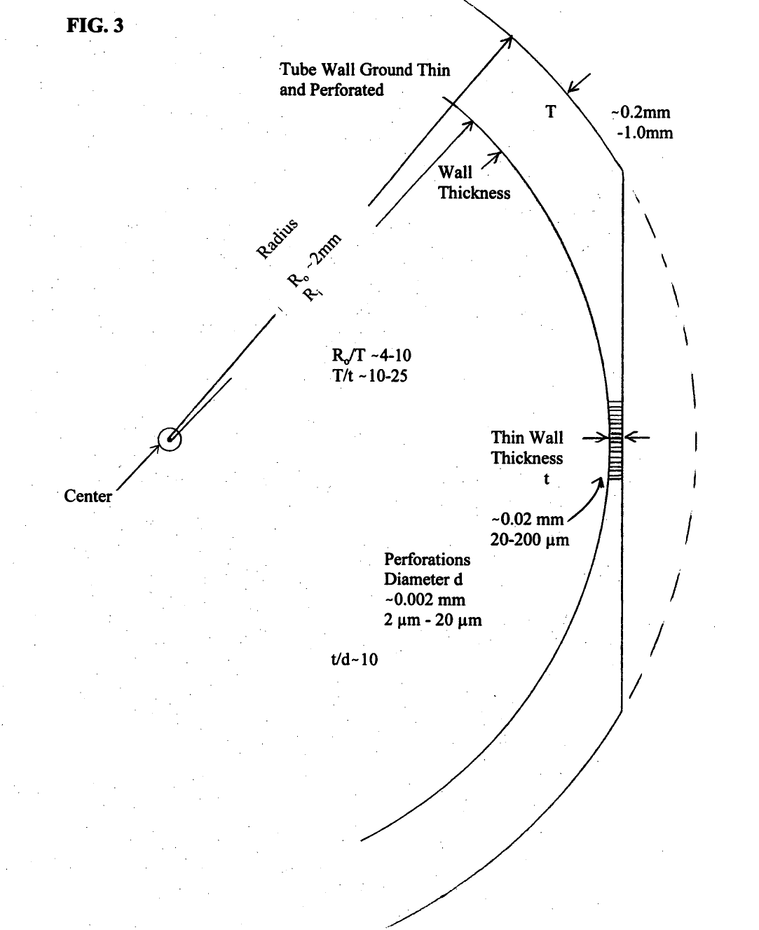

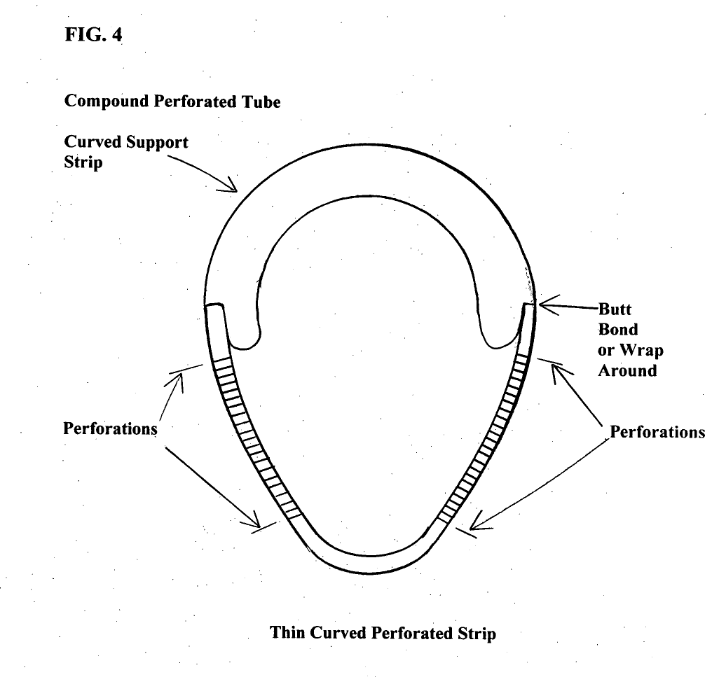

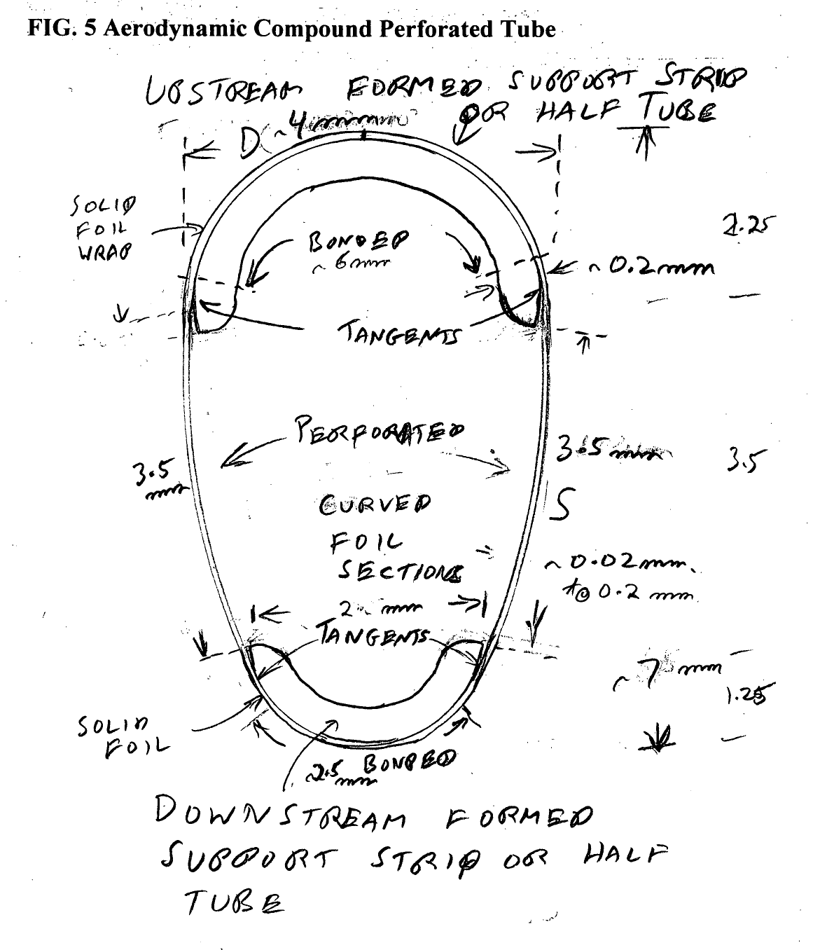

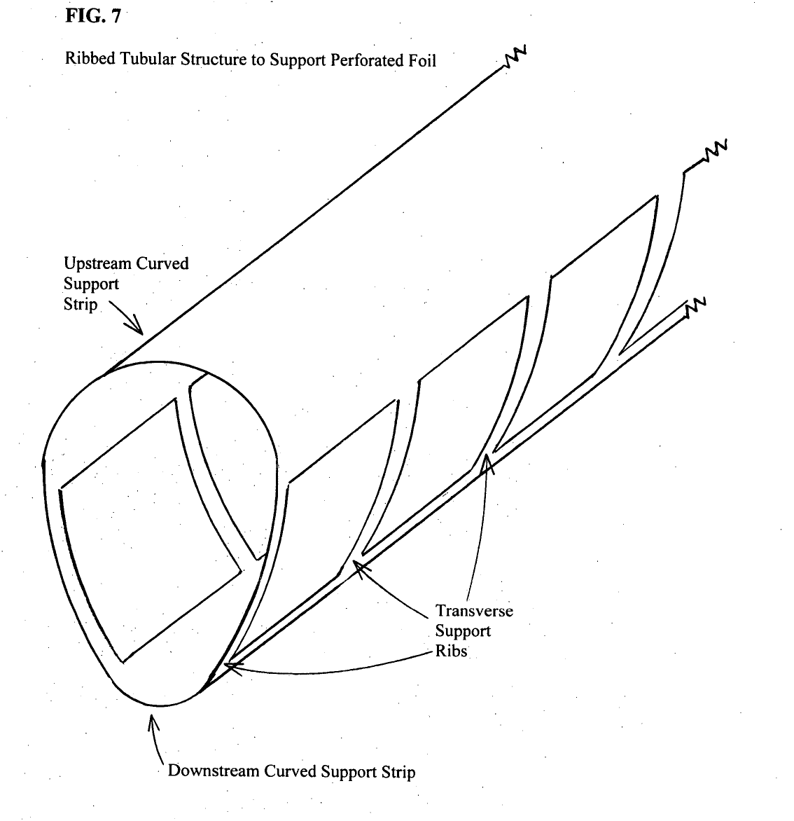

Thin perforated foil (e.g., about 20 μm to about 30 μm thick) is relatively weak and deformable. In some embodiments, users preferably attach thin perforated foil to one or two structural tube sections to support and stiffen it. E.g., bond about 200 μm foil to about 1 mm (1,000 μm) thick stiffener strip. (See, for example, FIGS. 5 and 7.)

10.7.1 Cut Thin Stiffening Strip

In some embodiments, users cut a thin stiffening strip for the downstream portion of the compound perforated tube. E.g., about 1.5 mm wide by about 0.2 mm to 1.0 mm thick.

10.7.2 Attach Central Stiffening Strip

In various embodiments, users attach or bond the narrow stiffening strip down the middle of the perforated foil on the solid axial section of the foil between the two perforated sections. E.g., on about 1.5 mm section. Users variously bond the components by induction welding, electrical spot welding, capacitance discharge welding, friction welding, brazing, soldering or gluing according to the temperature and strength required.

10.7.3 Form Support Tube into Upstream Streamlined Shape

In some embodiments, users form the structural strip into the desired upstream streamlined shape. This shape approximates a half ellipse with the open side being the shorter axis. For instance, in some moderate sized embodiments, the outer dimension may be about 4 mm wide.

10.7.4 Form Stiffened Perforated Foil into Downstream Streamlined Shape

In such embodiments, users form the stiffened perforated foil strip into the desired downstream streamlined shape. This will approximate a narrowed half ellipse with the open side being the shorter axis. For example, the outer dimension may be about 4 mm wide resulting in a circumference of about 10 mm.

10.7.5 Fit Perforated Foil Tube to Structural Support Half Tube

To assemble such embodiments, users typically spread the stiffened perforated lower half tube and fit it over the upper half support tube. In some embodiments users align the edges of the perforated foil in the indented edge of the formed structural strip.

In other embodiments, users preferably wrap the perforated strip over and around the upstream structural part tube.

10.7.6 Bond Foil to Tube

Users further bond both edges of the stiffened perforated foil half tube to the supporting half tube. E.g., by induction welding, friction welding, brazing, soldering or gluing according to the temperature and strength required.

10.8 Transversely Stiffened Compound Tube

In some embodiments, users preferably provide periodic transverse stiffener arcs between the upstream tube support and the downstream stiffener to which the thin perforated walls are attached.

10.8.1 Assemble Skeleton Tube from Components

Preferably users attach the periodic transverse stiffener arcs between the preformed upstream tube support and the downstream stiffener into the final shape.

10.8.2 Attach Perforated Foil(s)

Users then attach the perforated foil to one or preferably both sides of the formed skeleton tube.

10.9 Forming Curved Perforated Tubes

When tubes are bent into a curve, there is a danger of the tube walls flattening or crinkling. Prior art bending methods fill the tube with a liquid and then cool the liquid to a solid. E.g., with beeswax a hydrocarbon with a high melting point, or historically with lead. After the tube is bent into shape, the tube is heated and evacuated to remove the forming solid.

10.9.1 Forming Curved Compound Tube Sections

In some embodiments, compound tubes will be formed into arcs, helices or other non-linear curves. In such configurations, users form the upstream support tube section and the downstream portions to the desired arc, helix or other non-linear curve.

10.9.2 Assembling Curved Tube Sections

The upstream and downstream tube portions are then assembled and bonded together into or near the desired final shape. This method significantly reduces the likelihood that the thin perforated walls will tear or wrinkle compared to the damage that could happen if linear compound tubes are assembled and then formed into an arc, helix or other non-linear curve.

10.10 Skeleton Compound Tube Formation

In some embodiments, users provide stiffening ribs circumferentially from the upstream structural tube portion around (or within) the downstream perforated tube to support it. (See, for example, FIG. 7.)

10.10.1 Remove Gaps Between Stiffener Arcs

In some embodiments users machine and grind away tube side sections, leaving the transverse stiffener arcs in place between the upper and lower tubular sections. (Similar, for example to FIG. 7.) Then users assemble a compound tube by attaching the perforated foils to the sides or around the structural tube as described before.

10.10.2 Herringbone Compound Perforated Tube Assembly

In modified embodiments users attach transverse stiffeners about perpendicular to the central stiffener on the perforated thin sheet or foil like a covered herringbone. The stiffened perforated thin wall or foil is then formed into the desired streamlined shape. This downstream stiffened perforated wall section is bonded to the upper support tube section.

10.11 Drop Penetration & Mixing

In various embodiments, users preferably design, configure and/or control the system so that the droplets of the first fluid traverse less than or equal to about half the gap G between the tubes in each direction. (See, for example, FIG. 8.) To achieve this, the orifice size, location and orientation, array configuration, gap between tubes, fluid differential pressure, temperature, and external electrical field (as discussed further below) are designed or controlled relative to the flow, density and viscosity of the second fluid. The droplets will generally follow an approximately parabolic arc compounded by oscillating vortices formed by tubes.

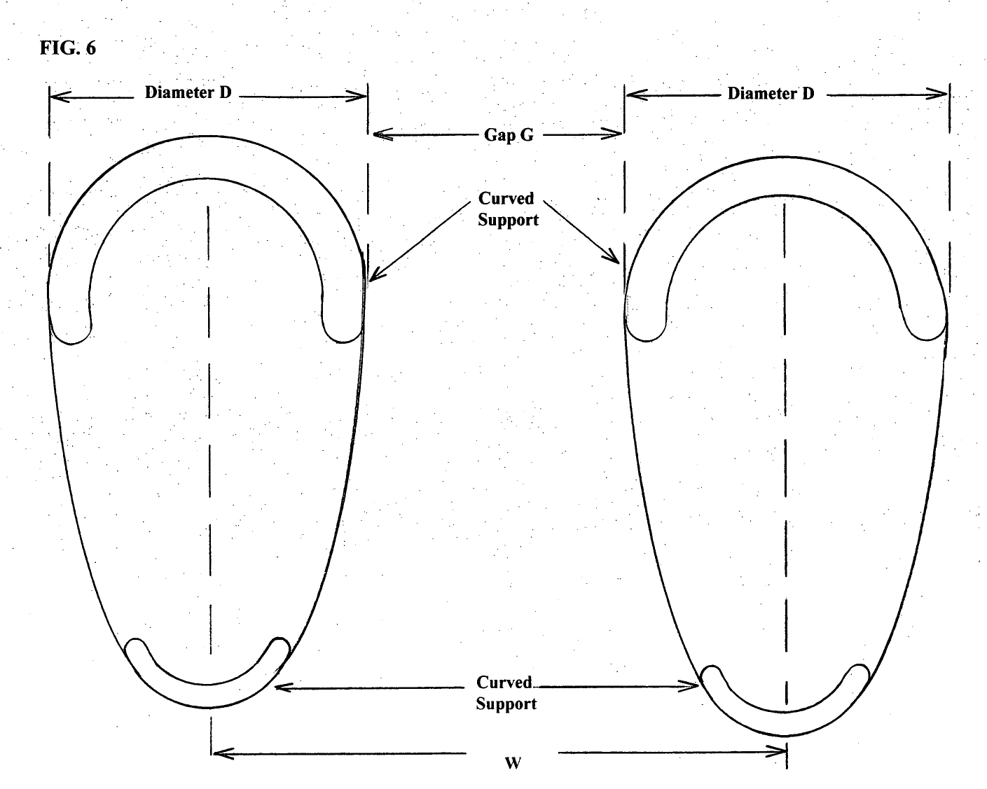

For example, tubes of about 4 mm diameter are positioned about every 7 mm giving about a 3 mm tube to tube gap. (See, e.g., FIG. 6 and FIG. 8.) In this case, users preferably inject the droplets about 1.5 mm into the transverse diverging flow of the second fluid. Users typically inject droplets of about 4 μm to about 40 μm in diameter depending on the dimensions and fluid properties etc.

10.11.1 Pressure Difference in Compound Perforated Tubes

With compound tubes, the thin walls will be the limiting factor on the pressure difference across the tube walls. However now much of the bending strength is taken up by the structural tube portion. For thin perforated walls users preferably provide reinforcing supports outside of the thin perforated walls. This transfers much of the internal fluid load to the reinforcing supports.

Users preferably conduct a full finite element analysis to adjust the dimensions for the required flow and pressure differences. In other embodiments, other suitable modeling and/or computation techniques empirical or semi-empirical studies and/or correlations, and the like may be efficaciously utilized to adjust dimensions, as need or desired.

10.12 Orifice Array Configuration

10.12.1 Linear Array

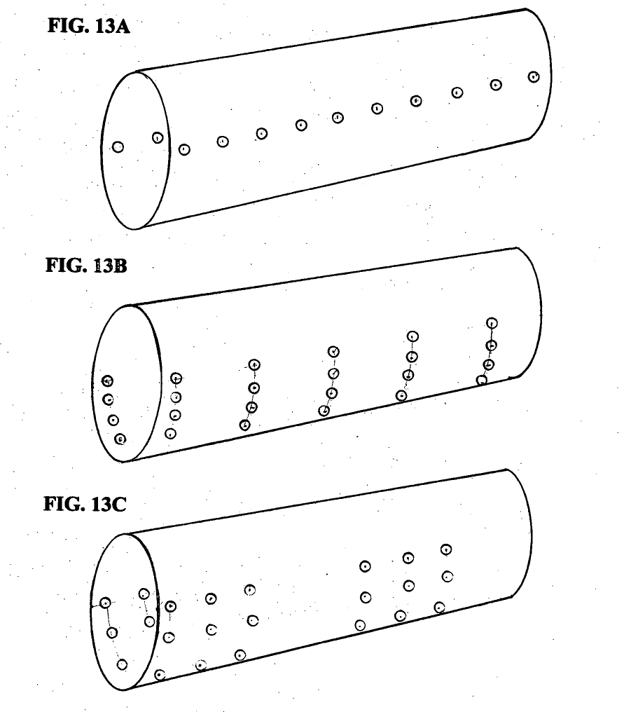

Rather then a high pressure spray from one or a few orifices, in some embodiments users preferably utilize many orifices in an array along a tube wall to provide a more uniform mixing of the first fluid emitted from the tube with the second fluid flowing across that tube. Users make many orifices of diameter d in a tube of diameter D with wall thickness T based on the Thickness/Diameter ratio capabilities of the drilling technology used. In some embodiments, users distribute these orifices along a line on the tube wall. (See, for example, FIG. 13A.)

10.12.2 Column or Arc

In other embodiments, users generally create and distribute orifices in a columns or arcs about a tube wall. (See, for example, FIG. 13B.) A column of orifices in line with the flow will create a number of parallel sprays traversing the flow. The cooperative spray effect will desirably reduce the rate the downstream sprays are diverted by the flow. This advantageously enables sprays of fine drops to project further across the transverse flow. In such embodiments, users advantageously use many orifices in a column or arc about the tube wall to create many smaller more uniform drops while projecting them further across a flow than is possible with individual sprays with similar differential pressures.

10.12.3 Spatial Orifice Array

In some embodiments, users preferably form a spatial array of orifices by creating an array of lines, columns or arcs as described above.

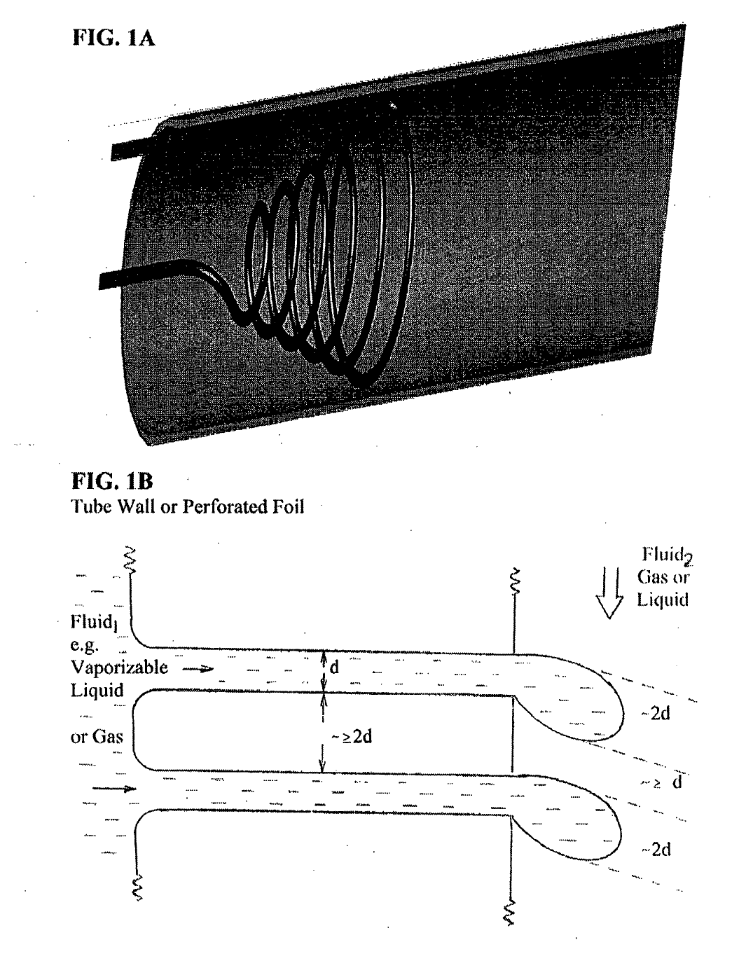

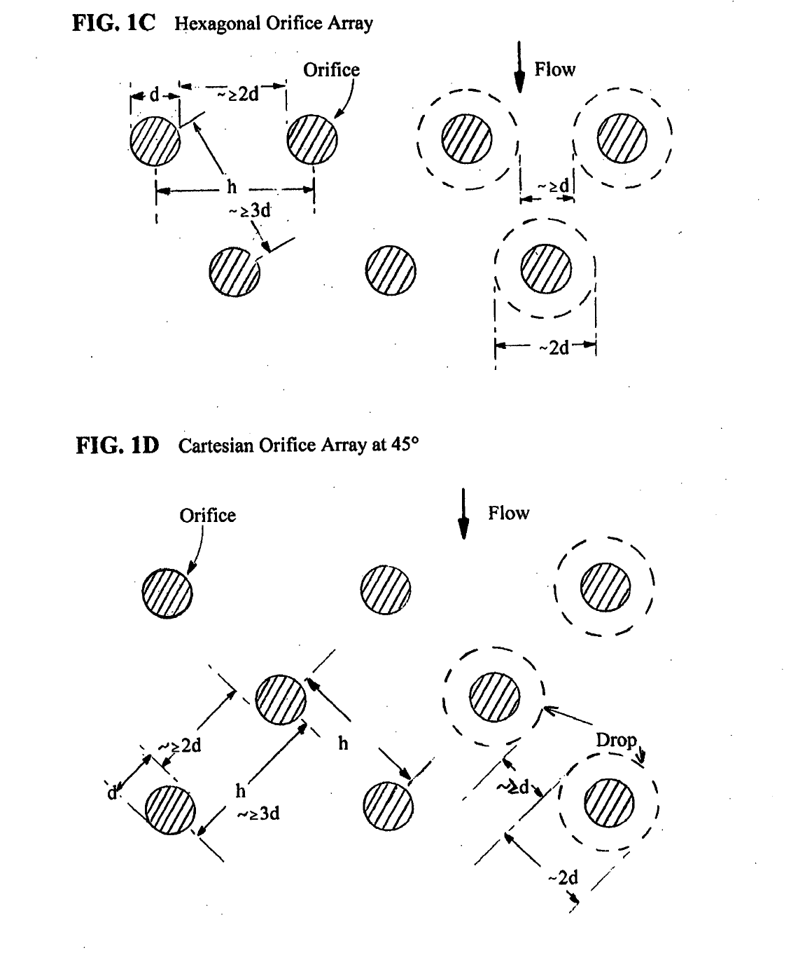

Hexagonal orifice array: In general, where users need to provide a maximum orifice spatial concentration, in some embodiments users preferably create orifices in a hexagonal array with orifice spacing h from each neighboring orifice. (See, for example, FIG. 1C.) That is, users align orifices in parallel lines as well as lining them up in lines at 60 degrees and 120 degrees to those lines. Pendant drops typically have about double the diameter of the orifices from which they are formed. Users preferably create drops with gaps between them to prevent coalescence. In some embodiments, the orifices are preferably spaced at a distance h that is preferably at least about three times the orifice diameter d to provide a gap of at least about half the drop diameter between drops. (See, e.g., FIG. 1C.)

Cartesian orifice array: In some embodiments, as with the hexagonal orifice array, users create multiple Cartesian orifice arrays. (See, for example, FIG. 1D.) This method distributes orifices of diameter d with orifice spacing h in orthogonal lines. As before, drop spacing h is preferably of the order of at least three times the orifice diameter d.

Random or other arrays: In other embodiments, users create a random spatial array of orifices in a tube wall as needed or desired.

10.12.4 Columnar or Rectangular Arrays

In some embodiments, users may further create these orifice arrays as multiple discrete areas. For example users can provide columnar arrays wrapped about the tube. (See, for example FIG. 13E.) For example, users may provide rectangular arrays of orifices, with the arrays spaced along the tube.

Of course, in other embodiments, the orifices may be spaced in other suitable manners with efficacy, as needed or desired.

10.13 Spatial Orifice Density

In various embodiments, users need or desire to design the ratio of the flow of the second fluid flowing across the tubes to the flow of a first fluid flowing through the tubes. To do so, users preferably adjust the gross orifice area in the tube walls relative to the cross sectional area of the duct. This permits much lower differential pressures and results in more uniform mixing than conventional methods. This method is in stark contrast to using a few orifices with high pressure differences.

This design parameter is approximately equal to the effective orifice area per tube length relative to the tube to tube spacing. (Note that this may count multiple rows of orifices along the tube and orifices of differing size.) The effective orifice area is obtained by the cross sectional area of the orifices adjusted for net fluid flow area exiting the orifice due to the necking down of fluid flow within the orifice variously caused by roughness, geometry, turbulence, cavitation or entrained bubbles.

Detailed designs will involve other parameters as desired or needed such as orifice size, orientation and configuration, the pressure difference across the tube wall, the pressure drop of the second fluid flowing across the tubes, the relative fluid densities, viscosities, surface energies, pressures, temperatures, tube configurations and relative positions etc. These may further use full CFD modeling to best position and orient the orifices.

10.13.1 Uniform Ratio of Fluid Flows

To achieve axisymmetric flow distributions with circular or conical arrays, in some embodiments users preferably use a prescribed, predetermined or pre-selected orifice spatial density for each of the perforated tube arcs. E.g., the spatial orifice density is uniform at a given radius, or distance from the cone apex.

10.13.2 Radial Variation in Ratio of Fluid Flows

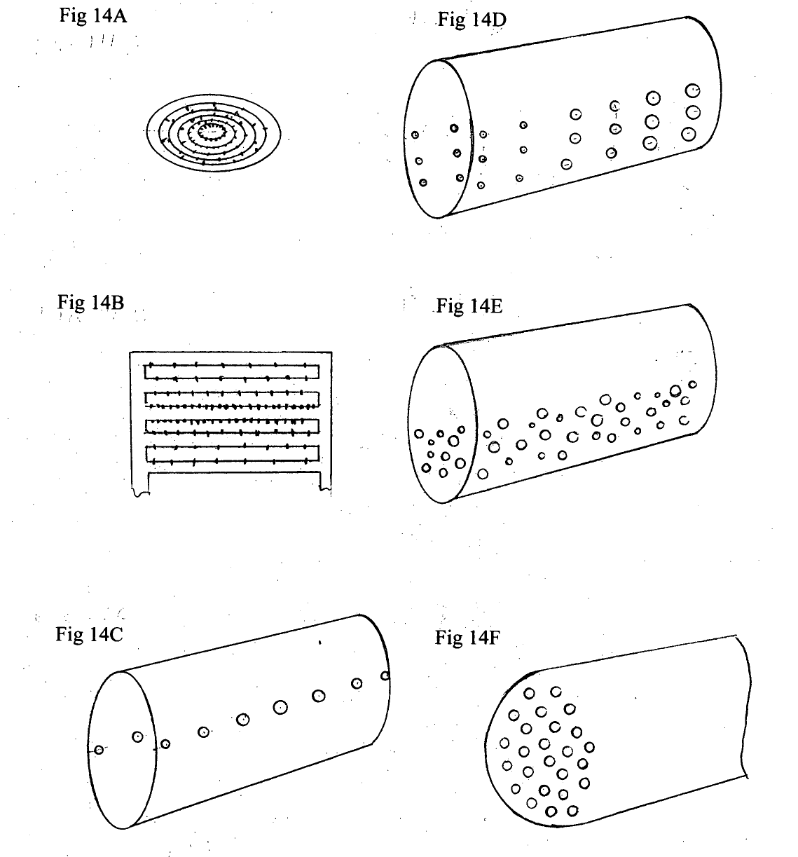

In other embodiments to obtain a prescribed, predetermined or pre-selected radial variation in the ratio of fluid flows, users preferably vary the orifice spatial density from one tube arc to the next radially outward tube arc. (See, for example, FIG. 14A.)

10.13.3 Transverse Variation in Ratio of Fluid Flows

Similarly, for a linear tube array or a linear array of tube arcs, users can vary the spatial density of orifices from one tube to the next tube to obtain one (or two) dimensional variations across a duct. (See, for example, FIG. 14B.)

10.13.4 Spatial Variation in Ratio of Fluid Flows

Similarly, to achieve a multidimensional spatial variation in fluid ratio, users preferably vary both the spatial density of orifices along each tube in one dimension (or parameter) as well as the spatial variation from tube to tube across the array in a second dimension (or parameter).

10.14 Orifice Size

10.14.1 Orifice Size Uniformity

Orifices of differing size typically create drops (or bubbles) of differing size, given sufficient pressure to emit such drops. To form drops of uniform size and at a uniform rate, users preferably create orifices with uniform dimensions within a prescribed, predetermined or pre-selected statistical distribution parameter. For example, with a relative standard deviation (RSD) <0.001. Of course, other suitable RSDs may be efficaciously utilized, as needed or desired.

10.14.2 Pressure Drop Adjusted Orifice Size

Liquid flow within small diameter tubes may cause a significant pressure drop along the tube. Conversely, any heating or cooling of the fluid along the tube will reduce or increase the surface tension. Accordingly where needed, users may increase or decrease the orifice size along the tube according to the distance away from the manifold and the change in temperature, to compensate for this increasing pressure drop or heating change in surface energy.

10.14.3 Graded Orifices

In some embodiments where users need or desire to control drop size and location of drops, users form graded orifice arrays. To form these arrays, users drill orifices with diameters changing in a prescribed, predetermined or pre-selected systematic fashion. (See, for example, FIG. 14C.) Users can change the orifice area in a linear fashion. Correspondingly, users change the diameter as the square root of the desired orifice area. Users then control the positive differential pressure across the tube to control the portion of the orifices through which fluids or liquids flow.

10.14.4 Stepped Orifice Sizes

In other embodiments users can make the orifice gradations in substantially discrete sizes. (See, for example, FIG. 14D.) With this, users control which orifices through which drops are expelled by controlling the positive differential pressure applied. Accordingly, users can cause drops to be formed from larger sized orifices and not from smaller orifices by controlling the differential pressure of the first fluid relative to the second.

10.14.5 Tailored Orifice Distribution

Flow through an orifice is generally proportional to the square root of the differential pressure across the orifice. A 100:1 turn down ratio of flow rate would conventionally typically require a pressure difference of 10,000:1. To compensate for this phenomena, users can change both the size distribution, number distribution and/or spatial distribution of orifices to obtain a desired flow rate versus differential pressure profile while achieving a prescribed, predetermined or pre-selected drop size distribution. For instance users can obtain a linear, quadratic or other variation of flow vs differential pressure instead of (or in combination with) the default square root relationship.

10.14.6 Varying Orifice Size

In other embodiments, users form orifices with prescribed, predetermined or pre-selected various sizes to correspondingly form drops of various sizes.

10.14.7 Random Orifices

In other embodiments users can form the orifices in a substantially random pattern. In situations where regular orifice arrays and periodic pulsing cause pressure oscillations, these may advantageously be reduced by shifting to or providing a random array. (See, for example, FIG. 14E.)

10.15 Location of Orifices

In some embodiments, users normally wish to eject drops or jets (or bubbles) of a first fluid through the orifices in the tube and uniformly distribute them into a second fluid (gas or liquid) flowing across the tube. In other embodiments, in some configurations, users inject drops of the first fluid into a static fluid or into a vacuum. In still other embodiments, users inject drops (or bubbles) of the first fluid against the second fluid flow. This is preferably where gravity, centrifugal acceleration or an electrostatic field exists or dominates to urge or propel the drops (or bubbles) against the flow.

10.15.1 Transverse Location of Orifices

The Bernoulli effect changes the relative pressure around the tube. The upstream static or stagnation pressure would hinder a liquid being expelled from an upstream orifice. Conversely, an orifice oriented substantially normal (that is at about 90° deg) to the fluid flow will result in a relatively lower differential pressure across the tube wall. This will assist a liquid (or bubble) to be expelled from an orifice located normal to the fluid flowing transverse to the tube. Gas flow transverse to an orifice will further assist in blowing off a drop (or bubble) as it increases in size from a sessile drop shape to a pendant drop shape.

Thus, in some embodiments, users preferably locate the orifices substantially normal to (at 90° deg to) the direction that the second fluid is flowing across the tube to assist in expelling and blowing off droplets (or bubbles) of the first fluid, when users need or desire that drops to be carried with the flow.

10.15.2 Drop Radial Position by Orifice Radial Location

In many conventional prior art sprays, drops differing in size and momentum penetrate different distances into a fluid. Furthermore, drops entrained within a spray travel farther than individual drops by the cooperative drag.

In contrast, in accordance with some embodiments, by forming uniform orifices, users form uniform drops (or bubbles) of the first fluid that will extend a uniform distance into the second fluid. Drops injected into a transverse flow will follow a nominally parabolic trajectory from the initial ejection direction to the transverse fluid flow direction. (This flow will then be perturbed by the turbulence downstream of the tube which forms alternating vortices parallel to the tube that spin off with the second fluid flow.)

In some embodiments, users position orifices at different locations around the tube at different radial positions to the second fluid orientation. This positions orifices at different distances across the transverse flow. The transverse fluid will also flow faster at the midpoint between tubes than in the expansion section nearer the tube in the downstream portion draft portion of the tube. By positioning orifices at different positions around the tube, users inject uniform drops that travel along differing trajectories and penetrate to different distances into the transverse fluid flow. Orifice positions and orientations are preferably adjusted according to the relative speed of the transverse flows and tube dimensions. These parameters will vary how laminar or turbulent the flow becomes and affect the flow velocity profiles. (See, for example, FIG. 8.)

10.15.3 Orifices at Tube Corners

For very low flow rates of the first fluid, drops may not be ejected as the fluid flows out from the tube, but might “dribble” or “weep” across the tube surface, wetting the tube. Certain flows of the second fluid flowing transversely across the tube could also influence such wetting. Drops could then aggregate resulting in larger drops breaking off the tube.

To prevent this, in some embodiments users preferably form a tube into a generally triangular cross sectional shape and then place orifices near the downstream corners. This may increase the ability of the drops to break away at low flows, compared to orifices located normal to the fluid flow in an oval tube. In modified embodiments, users form the tube into a diamond or rotated square shape or similar polygonal shape and locate orifices at the corners.

10.15.4 Orifice Axial Location

If orifices are located in a line (column) or arc around the tube, this can result in a spray where drops collectively travel farther than they would in a jet from an isolated orifice. This changes the distance the uniform drops travel into the transverse flow. To utilize or compensate for this effect, in some embodiments, users systematically align orifices or displace orifices in incremental locations axially along a tube as well as around the tube. Thus, in some embodiments, users preferably position the orifices in arcs that curve both around and along a tube to distribute drops across the flow.

10.15.5 Orifices in Tube Ends

In other embodiments, users form orifices in the end of tubes, whether closed off by hemispherical, flat or other surfaces. (See, for example, FIG. 14F.)

10.16 Orifice Configuration, Spacing and Orientation

In various embodiments, users preferably adjust the configuration, orifice or hole spacing, orientation and configuration to position and mix drops and/or micro-jets of the first fluid in a second fluid. These are detailed as follows.

10.16.1 Orifice Array Configuration

In some embodiments, users preferably configure the orifices or holes in an hexagonal array for greatest areal hole density. (See, for example, FIG. 1B.) In other embodiments, these orifice or hole arrays form a Cartesian pattern. (See, for example, FIG. 1C.) For a hole spacing of h, a hexagonal array will give 2/(h²3^{0.5})=1.1547/1h² holes per unit area or 15.5% greater areal density (holes/area) compared to a Cartesian array with areal density of 1/1h².

10.16.2 Orifice Size

In various embodiments, users preferably form the orifices with a diameter from about 1% to about 30% of the thickness of the tube wall according to the hole size required or desired and the hole forming technology used.

As examples, in other embodiments, users may form about 2 micrometer diameter holes to about 60 μm holes in 200 μm thick walls of a thin-walled tube. Similarly, users form about 0.3 to 10 micrometer diameter holes in an ultra-thin walled sheet or foil etc. of about 30 micrometer thick.

10.16.3 Orifice Spacing

When forming drops by gravity or pressure extrusion, sessile drops are formed which are typically of the order of twice the diameter of the orifice or hole. Thus, holes of about 2 micrometer (μm) diameter nominally create droplets of about 4 μm in diameter. To prevent drop coalescence during formation, the hole interval is preferably at least greater than the drop size formed. It is preferably to provide significant gaps between drops, to prevent droplet coalescence. Accordingly, in some embodiments, users preferably form the holes in a hexagonal array with hole spaced at intervals “h” preferably at least about 300% to 400% of the hole diameter d. For example, with about 2 μm diameter holes forming about 4 μm diameter drops, users typically space the holes at intervals of at least about 6 μm (i.e. drops of 3×2 μm in size preferably spaced at least about 3×3 μm apart).

10.16.4 Orifice Array Width

In some embodiments, users preferably form the orifices or holes into arrays with collective width equal to about 50% to about 100% of the diameter of the tube. In some embodiments, these orifices are positioned into two arrays preferably positioned on either side of a central blank section. The central blank section is preferably about 20% to about 40% the diameter of the tube.

For example, two arrays of about 626 holes across are made, each forming perforated strips about 3.75 mm wide on either side of a central solid strip about 1.5 mm wide. This creates a perforated strip circumference of about 7.5 mm with about 1252 holes. In this embodiment, the array width of about 7.5 mm is about equal to the lateral tube spacing of about 7 mm.

In embodiments having compound tubes, note that this gives a total downstream tube section circumference of about 9 mm. In such compound tubes, users preferably allow at least another 0.5 mm to 1.0 mm on each edge to attach to the stiffening tube. This results in a total strip width of at least about 10 mm to about 11 mm to form these downstream tube sections. Alternatively the downstream section can be configured wider to also wrap around the upstream structural tube section.

Note that these dimensions are illustrative taking a convenient thin walled tube. Similar effects are obtained in selecting larger or smaller dimensions. Users may select the tube size, shape and spacing according to the orifice diameter and maximum microjet distance desired or needed relative to the tube spacing.

10.17 Orifice Angular Orientation to Flow

In some embodiments, in addition to, or instead of, positioning orifices transversely around the tube, users preferably orient the orifices at various predetermined or pre-selected angles relative to the flow to adjust the terminal position of the fine drops injected into the transverse flow. By these measures, users preferably form drops of substantially uniform size and position them substantially uniformly across the transverse fluid flow.

This technique or methodology is preferably further refined to compensate for the variation in velocity of the transverse flow across the gap between the tubes and for the changes in differential pressure across tube wall due to the Bernoulli effect. Accordingly, in some embodiments, users preferably position drops between and along tubes to achieve substantially uniform number of drops of the first fluid per unit mass of the second fluid in the transverse flow. (See, for example, FIG. 8.)

10.18 Orifice Angular Orientation to Tube Axis

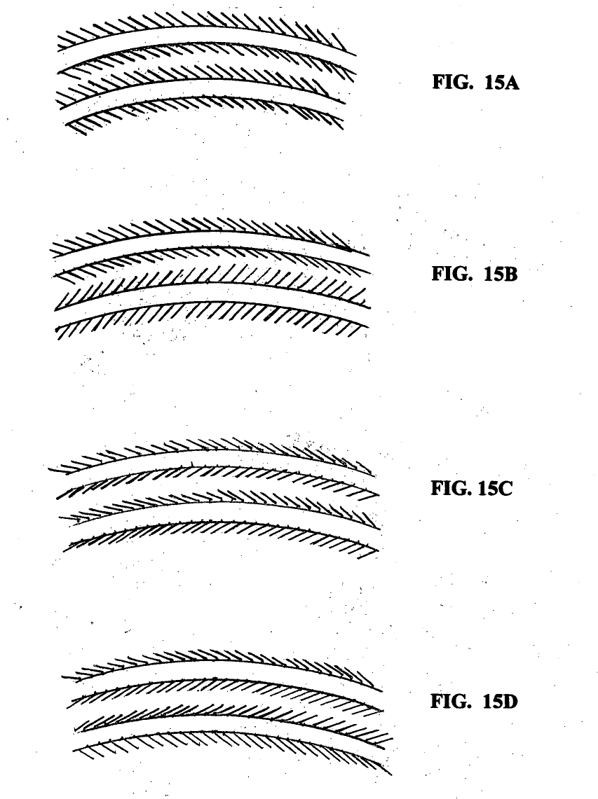

A jet of the first fluid exiting the tube imparts momentum and turbulence to the second fluid it penetrates. To increase the micro-turbulence uniformly throughout the flow, in some embodiments users preferably orient the orifices at an angle to the tube axis other than 90 degrees to the tube axis (off of normal). This adds momentum transversely to the second flow's primary velocity vector. The orifices may be oriented in the same direction diagonally across the tube. These tubes may be laid up in parallel resulting in orifices and microjets opposing each other. (See, for example, FIG. 15A.) In other embodiments, these tubes are laid up in opposite directions, resulting in the orifices and microjets pointing the same direction. (See, for example, FIG. 15B.)

In other embodiments users form orifices in a chevron pattern. This results in the orifices and microjets pointing in the same direction at a given angle to the tube axis on either side of the tube. This can be visualized as the tube being the “backbone” of herringbone with the orifices pointing in the direction of the angled bones of the herringbone. Users then lay up adjacent tubes with the same or alternating orientation of orifices.

With some configurations, these chevron perforated tubes are laid up parallel to each other. (See, for example, FIG. 15C.) This results in the microjets on either side of a gap pointing in the same direction into the gap. In other configurations, the chevron perforated tubes are laid up in opposite directions. This results in orifices and microjets opposing each other across a gap. (See, for example, FIG. 15D.)

10.18.1 Angled Orifice Arrays Creating Inter-Tube Turbulence

In some embodiments, users create numerous tiny micro-vortices parallel to the second fluid flow by injecting the first fluid into the gap between tubes from both tubes at opposing angles to the tube axis. In some embodiments, users preferably form this arrangement by laying up or arranging tubes with diagonally oriented orifice tubes in the same direction (e.g., in parallel arrays or in a conical wrap etc.) (See, for example, FIG. 15A.)

In other embodiments users use chevron orifice tubes laid up or arranged with the orifices alternatingly facing one direction then the other direction. These configurations form turbulence about axes parallel to the second flow, in addition to the vortices and turbulence created parallel to and downstream of the tubes and normal to the flow. (See, for example, FIG. 15D.)

10.18.2 Angled Orifice Arrays Creating Inter-Gap Turbulence (Downstream of Tubes)

In modified embodiments, users create counter flows in adjacent gaps. Users first orient the orifices in the same direction in the tubes on either side of a gap. This creates a clockwise or counterclockwise flow component in that gap about the flow velocity axis. Users then create a flow in the opposite sense in the adjacent gap. (See, for example, FIG. 15B.) This creates numerous micro-vortices between the two counter flowing fluid velocity components. In this configuration, these micro-vortices are downstream of the tube centers (rather than in and downstream of the gaps between the tubes.)

10.18.3 Swirl by Chevron Jointly Angled Orifices

In modified embodiments by orienting orifices in a chevron pattern, at the same angle to the tube axis on both sides of a tube transverse to the flow. In this configuration, users orient the transverse flow vector component clockwise or counterclockwise to the main flow. Adjacent chevron tubes may have the orifices oriented in the same direction. (See, for example, FIG. 15C.) This imparts the same tangential swirl flow in the same sense across the duct.

Users thus provide a swirl component substantially uniformly across the whole flow. Uniform swirl increases mixing that is commonly desirable in chemical reactions and combustion. Such swirl is most commonly applied in circular ducts. However, it can also be efficaciously applied in elliptical ducts and other configurations as needed or desired.

In other configurations, users lay up the chevron tubes in opposing clockwise/counter-clockwise directions; (See for example FIG. 15D.)

10.19 Conical Orifice Orientation

Laser drilling typically forms conical holes with the orifice nearest the laser being larger than the orifice farthest away from the laser. If the smallest possible holes or orifices are needed, then users preferably configure the strips to align the smaller diameter orifices with the outer surface of the strip and the larger orifice diameter with the inward surface.

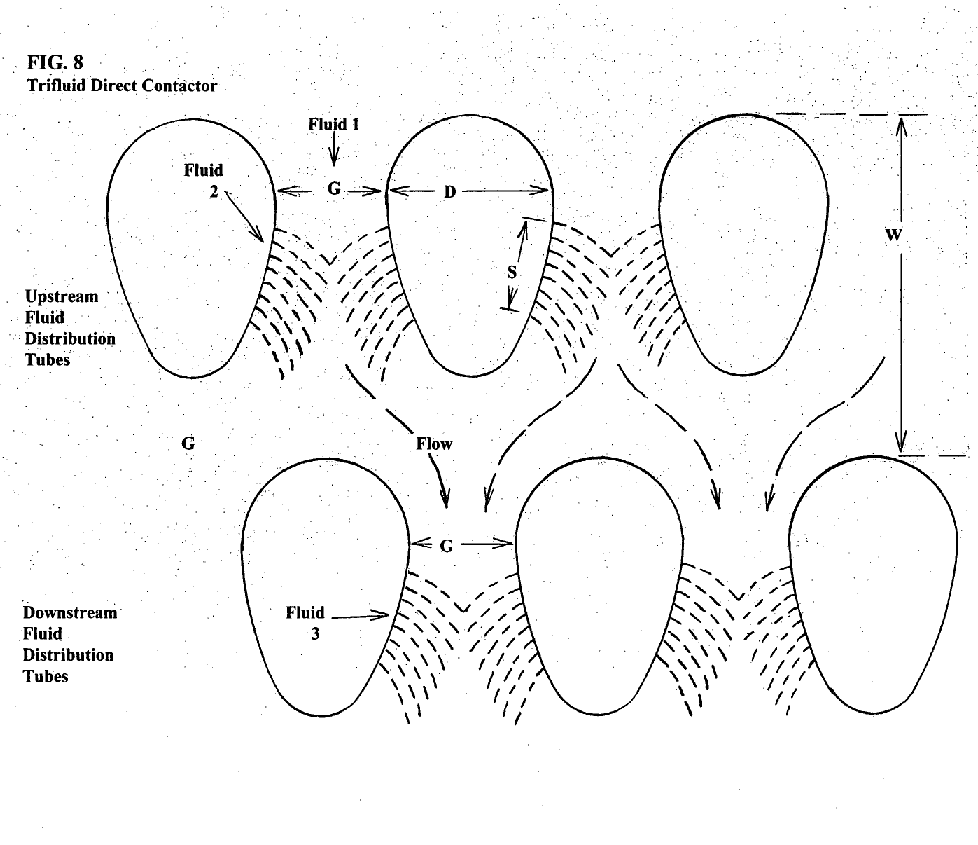

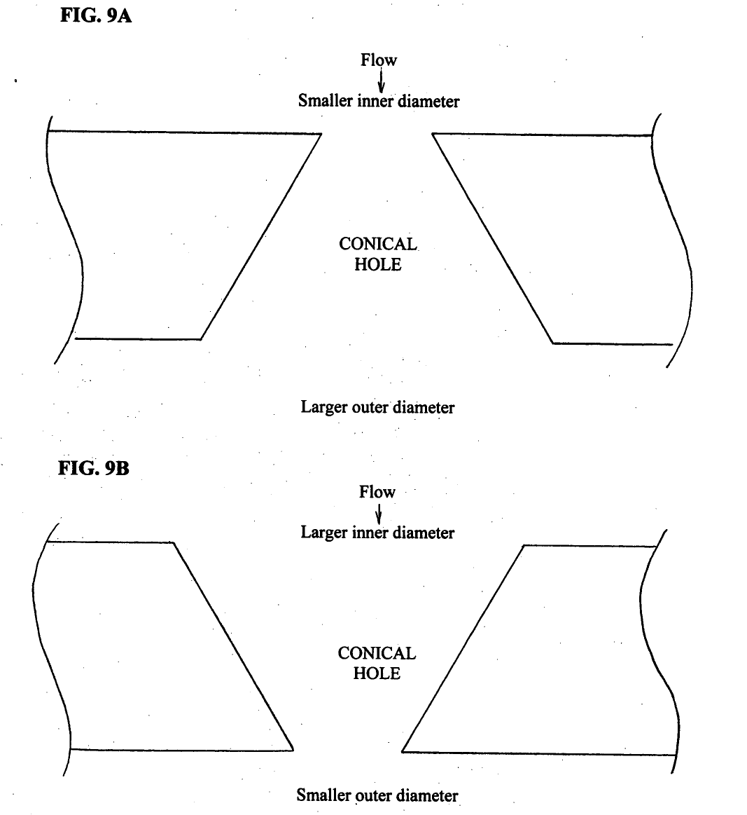

In other embodiments, to minimize hole blockage and facilitate cleaning, the smaller diameter orifices are oriented inward so that the hole size increases outward to the outer surface. (See, for example, FIG. 9A.)

10.20 Fluid-Droplet Vortex Mixing

Advantageously, by providing a distributed tubular array, users generate vortices in the second fluid flow downstream of each of the tubes and manifolds. This distributed turbulence creates substantially uniform mixing of the first fluid flowing through the tube orifices with the second fluid flowing over the tubes. The first fluid droplets and second fluid are mixed in the stream of vortices created immediately downstream of each tube.

10.21 Modifying Tube Shape

In some embodiments, users preferably adjust tube shape to affect the pressure drop across a tube or tube array or bank. Changing tube shape preferably affects the vortex intensity and turbulence downstream of the tubes. Tube shape also affects the direction of flow and momentum of fluid flowing across tubes. Flow induced differential pressure across a tube causes bending forces and moments on the tubes.

In some embodiments, users selectively adjust tube shape to streamline (or anti-streamline) and orient perforated tube arrays to adjust these parameters, as needed or desired. By streamlining tube cross section, users preferably increase the tube's moment of inertia about the bending axis and increase its ability to resist the bending moments. By such methods, users change parameters to improve (and preferably optimize) present value of total system costs including capital, assembly and operating costs.

10.21.1 Circular Tubes

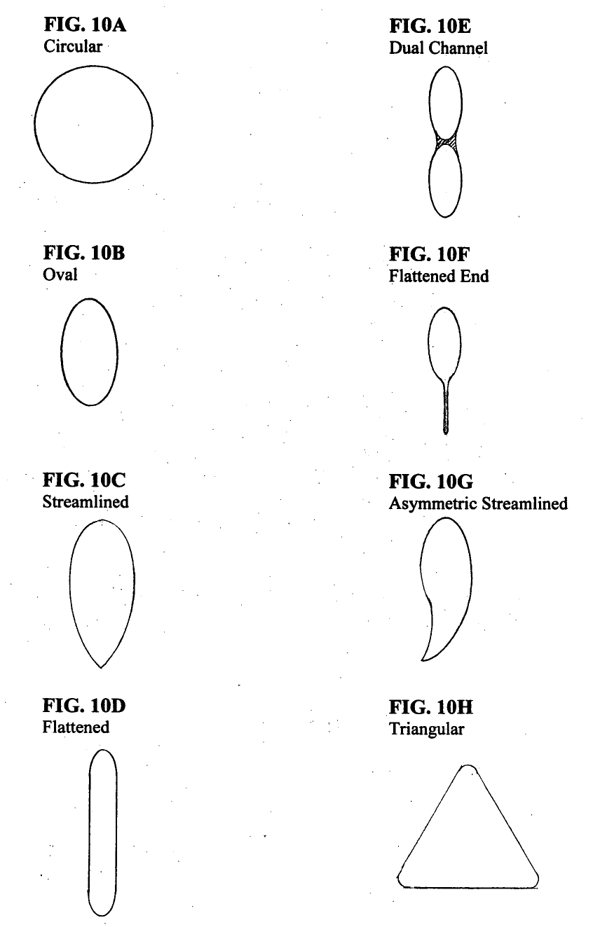

In some embodiments, users use standard generally circular tubes for fuel and coolant distribution tubes. A circular tube shape enhances turbulent vortex mixing over streamlined shapes. (See, e.g., FIG. 10A.)

10.21.2 Streamlined Non-circular Tubes

In some embodiments, users reduce the pressure drop across the tube bank while increasing the surface heat transfer coefficient by configuring the fluid tubes to a non-circular shape with the narrower cross section facing into the fluid flow. This reduces the parasitic pressure drop, making the fluid contactor more efficient, but reduces vortex mixing.

Elliptical or Oval Tubes: In some embodiments, a generally elliptical or oval tube is used. Utilizing a generally simple process, a generally circular tube is pressed to flatten it from side to side to easily form the tube into a generally elliptical or oval shape. (See, e.g., FIG. 10B.)

Symmetric Streamlined Aerodynamic Shape: In further embodiments, users further form the tube into a more streamlined cross section using multiple forming rollers where the downstream tube portion is pressed narrower than the upstream portion. Such streamlined shapes generate some of the least vortex mixing. (See, e.g., FIG. 10C.)

Flattened Tubes: Gases have substantially higher volume than liquids. The necessary liquid flow cross sectional area through a tube is often much smaller than that of the gas flowing across the tube. Consequently, in still further embodiments, users further flatten the tubes to minimize the drag from the fluid flowing across the tube while retaining the stiffness to bending due to the cross-flow drag. (See, e.g., FIG. 10D.)

Dual Channel Internally Bonded Flattened Tubes: A flattened tube will expand given sufficient internal pressure. In some embodiments, users internally bond the tube walls while leaving room for liquid flow. Pressing an elliptical tube in the middle will form a dumbbell or figure “8” shape. Forming and bonding a flattened tube into this shape now generates two internal fluid ducts. In some embodiments, users continually bond a dumbbell shaped tube to form two fluid channels. In modified embodiments, users further flatten the ducts. (See, e.g., FIG. 1E.)

Single Channel Flattened Tube: In some embodiments, by further flattening one lobe, users obtain a straightened figure “9” or “6” shaped tube. Users can internally bond the tube walls by this forming pressure. In modified embodiments users electro-weld the walls, or users internally coat the tube with a solder or braze and then heat bond the tube walls. (See, e.g., FIG. 10F.)

Asymmetric Aerodynamic Shape: In some embodiments, users use aerodynamic wing shaped tubes to preferentially redirect the fluid flow across the tube in an efficient manner. (See, e.g., FIG. 10G.)

10.21.3 Anti-Streamlined Bluff Tubes

Conversely, in some embodiments, users form the tubes into less streamlined shapes to increase the inherent turbulent mixing downstream of the tubes as needed or desired.

Transverse Elliptical Tubes: In some embodiments, by orienting the long axis of an elliptical tube normal (at 90°) to the flow axis of the second fluid, users increase the flow turbulence as well as the pressure drop across the perforated tubes. (i.e., or by aligning the short axis of the ellipse with the second flow direction.) By using sufficiently bluff tube shapes, users can form two vortex streams from either side of the anti-streamlined tube, thereby increasing mixing. E.g., as in a paddle or oar being pushed through a fluid with the bluff face in the direction of movement. (See, e.g., FIG. 10B.)

Hemispherical or Triangular Shapes: Users use shapes that are streamlined upstream but bluff downstream in some embodiments to reduce pressure drop while creating flow separation with multiple vortices. E.g., a tube formed towards a semicircular cross-section. To increase drop shedding as the first fluid exits the distribution tube, users preferably position orifices at the widest transverse axis provides the greatest differential pressure boost by the Bernoulli effect. (See, e.g., FIG. 10H.)

10.22 Streamlined Wire Tubes

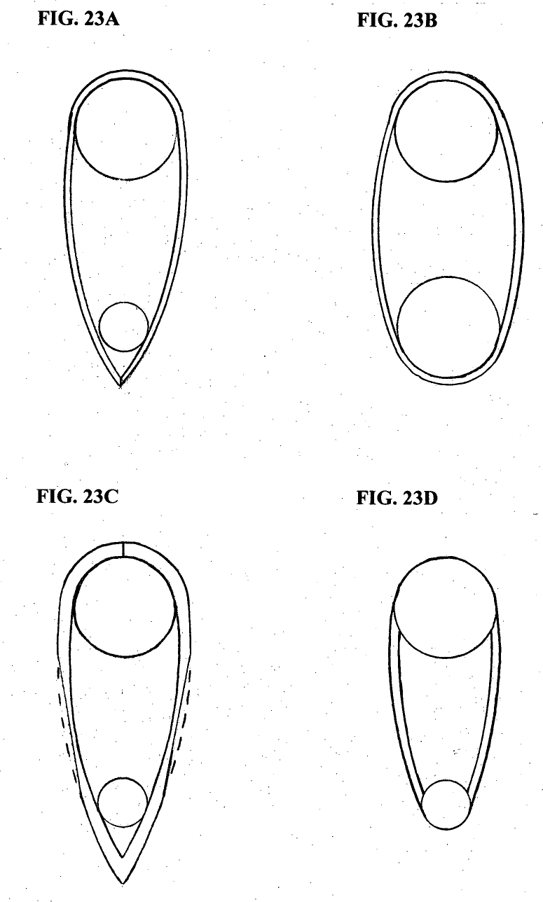

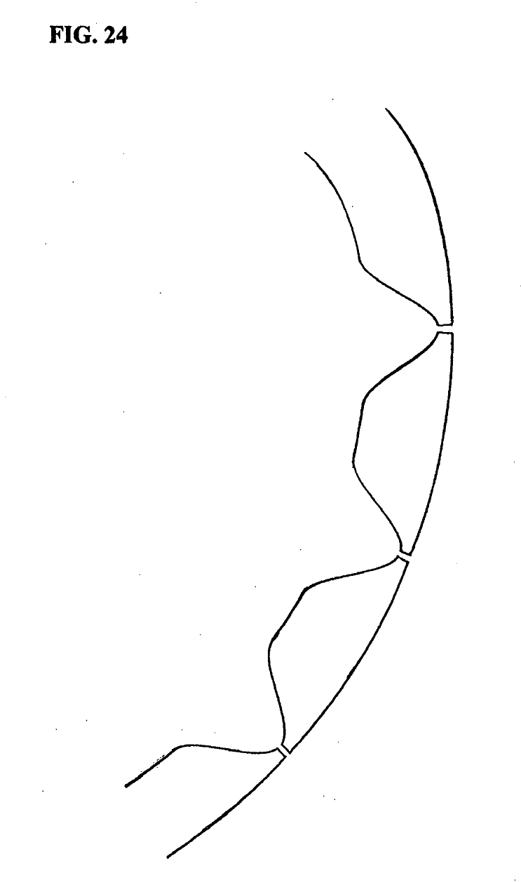

In another embodiment, users preferably form streamlined tubes by wrapping a thin strip around two wires and bonding the strip to those wires. (See, for example, FIG. 23A.) The curved shape of the wires preferably provides the streamlining form upstream and down stream. The wires further provide strength and rigidity to support the perforated tubes against drag and turbulence within the second fluid.

10.22.1 Relative Wire Size

In some embodiments, users preferably select a larger diameter wire upstream and smaller diameter downstream. (See, e.g., FIG. 23A and FIG. 23C.) The thin strip preferably extends beyond the downstream wire to form a narrow edge. (See, e.g. FIG. 23A and FIG. 23C. Similar, e.g., to FIG. 1C.)

In a modified embodiment, both wires may be the same to form an oval or elliptical shape (See, e.g., FIG. 23B, or similar, e.g., to FIG. 10B.) Such configurations may be used to increase turbulence by orienting the bluff side towards the flow (i.e. the longer axis perpendicular to the flow.)

10.22.2 Thin Strip Assembly

In a modified embodiment, a thin strip may be wrapped around one wire and abutted to the second wire. The strip is preferably bonded to at least one of the wires.

In another embodiment, two thin strips are laid up on either side of two wires and preferably bonded to both wires. In a preferred modification, the thin strips wrap around the larger wire upstream and preferably butt together. In a preferred modification, these strips extend beyond a smaller wire downstream, and join, to improve streamlining. (See, e.g., FIG. 23C.) In other embodiments, the thin strips may abut to or overlap one or both of the wires. (See, e.g., FIG. 23D.) Optionally, the strip could be press fit around at least one of the wires.

In these embodiments, the strips are preferably perforated before assembly to facilitate movement of the strip(s) past a laser. Alternatively, in some circumstances, it is preferable to perforate the strip(s) after assembly.

In some embodiments, the thin strip(s) are formed into a curve prior to assembling and bonding to the wires. Alternatively, in some assembly methods, the strip(s) are assembled flat and the tubes are pressurized to a proof pressure to curve the strips.

In some embodiments, the wires are preferably moderately flattened to improve aerodynamics and provide a greater surface to bond to the thin strip, though circular wires may be used. In other embodiments, trapezoidal shaped wires may be used to improve bonding while still providing some streamlining. In modified embodiments, the upstream or downstream end of the wire may similarly be formed to improve streamlining. Similarly, in some embodiments the edges of the thin strips may be cut at an angle, thinned, beveled, pressed, ground or otherwise smoothed to improve aerodynamics.

10.23 Polygonal Wired Tubes

In embodiments utilizing triangular or other polygonal tubes, this method may be used to provide a wire support at each vertex.

10.24 Hybrid Compound Tubes

Users may combine the various embodiments and assembly methods described herein.

10.24.1 Compound Tubes from Ground Strips

In some embodiments, users may take thin strip and grid a thin section along a portion of the strip. The thin strip is preferably perforated and then assembled to form compound perforated tubes by the methods described herein. This method provides benefits of achieving more uniform thinned strip thickness. Correspondingly this results in more uniform orifices being formed by the laser drilling or other orifice forming technology. Alternatively, the thin sheet ground walls may be perforated after assembling the tube.

10.24.2 Wire Tubes from Ground Strips

In modified embodiments, users form one or more thinned ground strips around wire stiffeners to form a streamlined stiffened thin wall tube. (See, e.g., FIG. 23D.) This method provides very thin walls and small orifices while giving substantially greater structural strength, stiffness and streamlining.

10.25 Combination Thinning & Drilling

In some embodiments, users thin tube walls, sheets or foils using alternate methods (other than grinding) such as lasers, electrochemical etching or photochemical etching. Fine orifices are then formed through the thinned sections using technologies such as high resolution laser drilling. (See, e.g., FIG. 24.) With this method, users need only make moderate diameter pits to thin the walls, rather than thinning continuous or extensive wall sections. This advantageously removes less material and retains more of the wall strength than conventional grinding methods. This method can utilize conventional lasers with moderate thickness/depth ratios rather than very high (T/D) ratios. E.g., T/D ratios typically of about 10 instead of about 100.

10.26 General Application

Of course, as the skilled artisan will appreciate, other suitable nominal thicknesses and shapes may be efficaciously provided for the upstream and downstream structural components or “wires” used to form the compound perforated tubes. Similarly, as the skilled artisan will recognize, a variety of curved, curvilinear, angular or flat strips may be utilized to form the sides of the compound perforated tubes. Various combinations of the thinning and/or forming holes may similarly be used, as desired or needed. Furthermore, orifices may be positioned in a variety of locations and orientations about a thin-walled or compound perforated tube depending on the pressure drop and degree of mixing desired or needed.

Forming Arrays of Perforated Tubes

In many embodiments, users preferably form the perforated distribution tubes described above into various two or three dimensional arrays. This provides the benefit of more uniformly distributing and mixing the first fluid flowing thru the tubes with a second fluid flow through a duct across those tubes. E.g. users may spray water or fuel into air to uniformly mix them together.

11.1 Tube Orientation to Duct Flow

11.1.1 Tubes Perpendicular to the Duct or Flow Axis

In some embodiments, users preferably orient the perforated tubes across and substantially perpendicular (i.e., normal or at 90°) to the duct and flow axis of the second fluid. This generally provides a preferably or an improved distribution of droplets and greatest or enhanced vortex mixing downstream of the tubes for a given tube length.

11.1.2 Tubes at an Angle to the Duct or Flow Axis

In other embodiments, users can efficaciously orient the tubes at some angle to the duct and flow axis as needed or desired. This typically varies according to the desired two or three dimensional array configuration. Users still preferably orient the tubes at an angle near 90 deg to the duct or 2^{nd} fluid flow axis to maximize or enhance vortex mixing. (See, e.g., FIG. 11A.)

11.1.3 Tubes Parallel to the Duct or Flow Axis

In some embodiments, an opposite alternative tube orientation is utilized to orient the tubes substantially parallel to or at a small angle to the flow axis. This can reduce the pressure drop but at the expense of minimizing or reducing turbulent mixing and less efficient mixing of droplets into the fluid. (See, e.g., FIG. 11B.)

11.2 Two Dimensional Tube Array Configurations

11.2.1 Circular/Spiral Arc Contactor Arrays

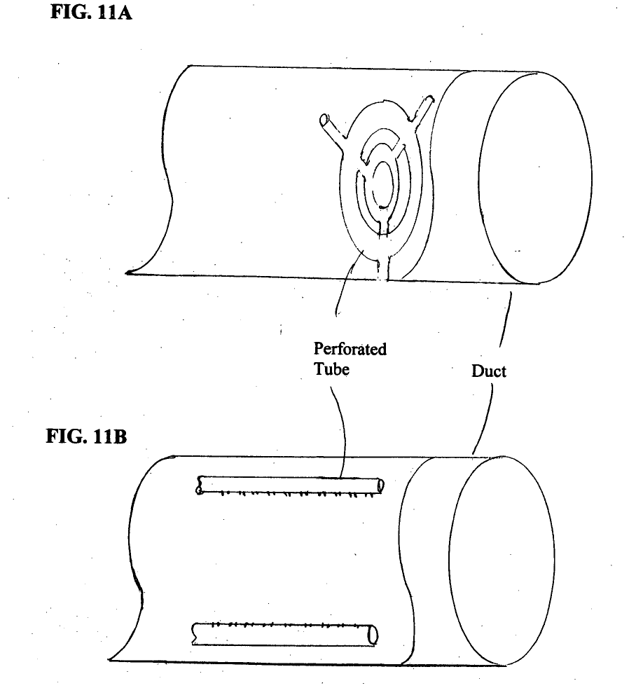

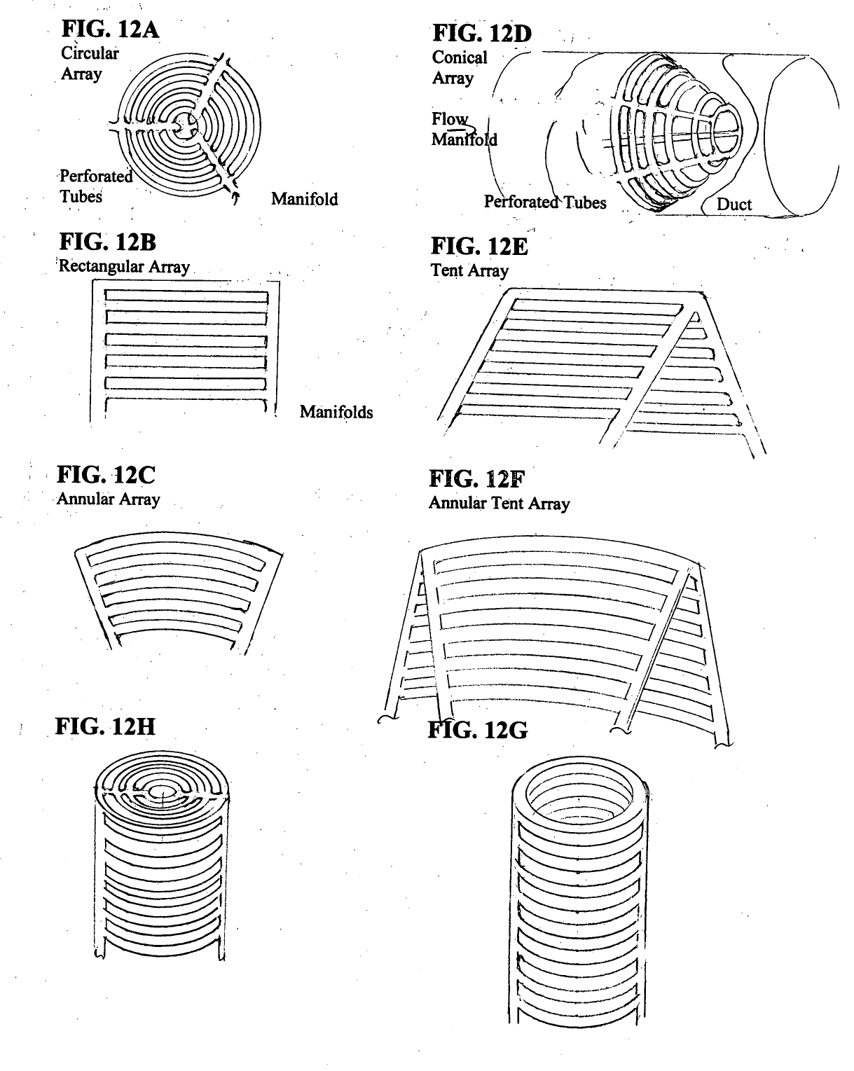

For circular ducts, in some embodiments, users preferably form perforated tubes into circular or spiral arcs. Users then form an array of such circular or spiral arcs between two or more radial manifolds to create arc shaped flow passages. (See, e.g., FIG. 12A.) In other embodiments, users connect the tubes to one radial manifold. In modified embodiments, users further form a perforated tube into a single spiral and form a pseudo circular array. A spiral perforated tube is typically simple to form but could have significant pressure drop from outside to inside resulting in non-uniform drop formation.

11.2.2 Rectangular Contactor Arrays

In other embodiments, users form parallel arrays of perforated tubes for rectangular ducts. To minimize or reduce pressure drops, users preferably run the perforated tubes across the shorter dimension of the rectangle and preferably join the perforated tubes to manifolds oriented along the long sides of the rectangular duct. (See, e.g., FIG. 12B.) In other embodiments to reduce assembly costs, users run the perforated tubes across the longer dimension of the rectangle. In other embodiments, users prepare four triangular arrays extending out from the center of the rectangle between radial manifolds to form a four sided pyramid.

11.2.3 Annular Contactor Arrays

For annular ducts or to match annular openings, in some embodiments, users preferably form perforated tubes into an array of arcs. Users bond these perforated tubular arcs between radial manifolds. Similarly users form an annular section array of perforated tubular arcs. (See, e.g., FIG. 12C.)

11.3 Three Dimensional Spatial Arrays of Perforated Tubes

In some embodiments, users preferably take the two dimensional arrays described above and extend them into three dimensional arrays such as conical or tent shaped forms as follows.

Conical Array of Helical Wound Tubes: In some embodiments, users preferably wind the perforated tubes at a fairly small helical angle about a conical form. Using a substantially constant tube to tube spacing, this efficiently fills the cross sectional space of a duct. At the same time, users provide more room between adjacent tubes for axial flow of the second fluid and reduce the pressure drop across this tube array. Users provide at least one and preferably two or more manifold tubes oriented axially tangent to the conical surface. Using multiple manifold tubes provides greater rigidity while reducing pressure drops along the perforated tubes. (See, e.g., FIG. 12D.)

Tent Shaped Tube Array: For rectangular ducts, in some embodiments, users preferably take the rectangular array of perforated tubes and extend it to a three dimensional tent shaped array of perforated tubes. Users preferably bond the perforated tubes transverse to the flow between V shaped manifolds. (See, e.g., FIG. 12E.) In modified other embodiments, the perforated tubes could be oriented in the other direction. Here manifolds would be oriented along the tent ridge and parallel base edges. Users then bond the perforated tubes between the base and ridge manifolds. This provides shorter tube lengths at the expense of tubes not being oriented normal to the flow resulting in lower turbulent mixing.

Polygonal Pyramid: In some embodiments users form a pyramid array for rectangular ducts. Users take the rectangular array of four triangular arrays of perforated tubes described above. Users then extend that array to a three dimensional quadrilateral pyramid. As before, the tubes are preferably bonded between radial manifolds oriented down the four extended edges of the pyramid. (Not shown. (Compare, e.g., FIG. 12E.)) In a similar fashion users can form triangular pyramids from triangular arrays of perforated tubes. Users could also form hexagonal pyramids from triangular arrays of perforated tubes.

Annular Tent Tube Array: Annular ducts are often encountered in industry. E.g., in the entrance to a compressor or gas turbine. These annular ducts are often divided into multiple annular duct sections. Accordingly, in some embodiments, users preferably combine the conical perforated tube array concept with the tent shaped perforated tube array. Users thus form a curvilinear tent shaped array of perforated tubes that conforms to a section of an annulus. This “3-D” annular tent array form reduces the pressure drop across the annular array. This configuration further simplifies and shortens the transition pieces commonly used to transition from circular ducts to annular section ducts. This further reduces the flow redirection and inefficiencies typically encountered for such transitions. (See, e.g., FIG. 12F.)

Cylindrical Tube Array: In yet other embodiments, users provide a cylindrical array of perforated tubes connected to one or two generally circular manifolds. This configuration would provide a convenient means of mixing a first fluid uniformly with a second fluid flowing radially into a circular duct. (See, e.g., FIG. 12G.)

Can Tube Array: In modified embodiments, users extend the conical tube arrays, to form can shaped tube arrays by adding a circular array to the end of a cylindrical array. Users wrap perforated tubes into a cylindrical or helical shape to form the sides and/or the can top. These can be connected to manifolds as described in connection with the conical array. (See, e.g., FIG. 12H.)

11.3.1 Arrays of Three Dimensional Tube Arrays

For large fluid flows, in some embodiments, users then preferably form larger extended arrays of perforated tubes by taking two or more of the above three dimensional (“3-D”) tubular array structures and arranging them into extended arrays of such 3-D array structures. Users readily take tubular arrays with circular, hexagonal or Cartesian footprints and replicate them in linear or spatial arrays as desired or needed to fit into corresponding the ducts or areas.

Similarly in various embodiments, users replicate the annular tube arrays to form part or all of a circle. For circular or polygonal tube arrays are used that do not fill the space, users preferably provide blocking structures to fill the inter-array gaps and prevent the second fluid from flowing between the tube arrays.

11.3.2 Array Opening Orientation

“Horn” Orientation: In some embodiments, users orient a conically wound tube in the “horn” orientation with the apex or point upstream and “mouth” downstream when users need or desire the second fluid to flow across the tubes from outside/upstream of the tubular cone to inside downstream of the tubular cone. With this orientation, the second fluid flow entrains droplets from the tube orifices into the inside of the cone on the downstream side. (See, e.g., FIG. 19, i.e., the opposite of the “funnel” configuration as shown, e.g., in FIG. 12D.)

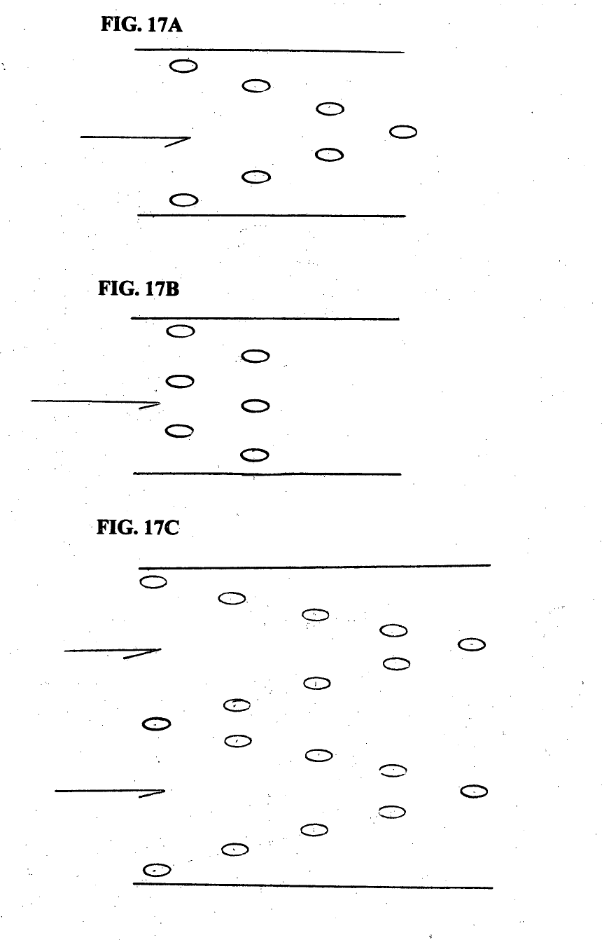

“Funnel” Array Orientation: Conversely, in other embodiments, users orient the conical array in the “funnel” configuration with the apex or point downstream and the “mouth” upstream. This generally causes the second fluid to flow from upstream inside the conical tubular array to the outside downstream of the conical array when users need or desire the droplets of the first fluid to be entrained by the second fluid to outside the downstream cone as they exit the tube orifices. (See, for example, FIG. 12D and FIG. 17A.)

11.4 Optimize Cross Sectional Area and Shape

The smaller the tube size, the smaller the differential pressure of fluid flow across the tube, but the higher the differential pressure for fluid within the tube. Tubes extended longitudinally in the direction of the flow will be stronger in bending than round tubes. In accordance with some embodiments, users improve and preferably optimize the shape of the perforated tubes and orifice configuration by optimizing the net present value of cost of the forming the tubes and orifices, the energy costs of pumping fluid across the tube and the fluid pumping within the fluid.

11.4.1 Tube Spacing

In various embodiments, users space the tubes across the flow at intervals as needed or desired. They preferably form an array of tubes of diameter D, spaced at intervals W. This results in a gap G between the orifices where G=W−D.

This tube spacing W is preferably equal to about the total width of the perforated area on the elliptical foils. This tube spacing is nominally about 175% of the tube diameter D, preferably in the range of about 110% to 500% of the tube diameter D. Similarly, users may set the gap G between the tubes at about 10% to 400% of the tube diameter D.

E.g., users may set the tube spacing W to about 7 mm. This in a gap between tubes G of about 3 mm in the above example for tubes with diameter D of about 4 mm.

11.4.2 Drilling Orifices

In some embodiments, users preferably use laser drilling technology with a high Thickness to Diameter drilling ratio to create small uniform orifices in thin or ultra-thin tube walls. E.g., using technology with about 100:1 thickness/diameter drilling capability with 200 μm thick walls permits forming about 2 μm diameter orifices. This combines structural wall with fine orifices.

In other embodiments users use the compound perforated tube design to form an array of fluid orifices with orifice diameter from about 10% to 1% of the structural tube wall thickness (0.5% to 0.05% of the tube diameter) using common laser drilling technologies with typically 10:1 Thickness/Diameter capability. With this combination users can also drill orifices ten times smaller than in conventional designs. Higher drilling Thickness/diameter laser drilling capabilities of 100:1 nominally increase this range of orifice sizes by an order of magnitude.

11.4.3 Drop Array Formation

In one embodiment for example, with an array of about 2 μm orifices, users form about 4 μm droplets about every 6 μm across the flow. By using directed orifices, users typically inject fine jets to distribute such droplets across a transverse flow. With a hexagonal injection pattern, users nominally form about 3.2 million drops/cm² total flow cross sectional area (including the tubes area). Users nominally create 5.3 billion drops/cm³ in a transverse gas flow assuming droplets spaced about 6 μm along the flow. Ignoring droplet coalescence, this nominally creates an initial direct contact surface area about 45,000 cm² per cm³ of flow.

11.5 Manifolds

In various embodiments, users preferably connect multiple distribution tubes to one or more manifolds. This reduces the internal pressure drop and pumping losses of the first fluid flowing within the distribution tubes. It also provides some structural support for the distribution tubes against the bending forces of the second fluid flowing across the tubes and manifolds and for the pressure oscillations caused by vortices downstream of the tubes and from resonant pressure oscillations.

11.5.1 Manifold Configuration

In some embodiments, with rectangular, Cartesian or tent like tube orientations, users preferably align the manifolds along parallel edges of the tube array. With pyramidal or polygonal configurations, users may align manifolds along one or more diagonals. With other embodiments, with circular or conical arrays, users preferably orient the manifolds along one or more radii.

11.5.2 Thin Manifolds

By flattening the manifold(s), in some embodiments, users reduce the drag or pressure drop for fluid flowing across it, as with flattening the distribution tubes. Users also desirably increase the bending strength of the manifold crosswise to the flow.

11.5.3 Varying Internal Manifold Cross-Sectional Area

In some embodiments, manifolds vary in size with distance to compensate for the fluid delivered to the perforated tubes. The internal cross sectional area preferably varies proportional to the remaining first fluid flow rate as the distance along the manifold. E.g. as distance along a radius, an edge, or similar parameter.

To accommodate differential pressures while varying in internal cross section, manifolds contain multiple passages with internal structural constraints between external walls to substantially constrain them from bulging, in some embodiments. Alternatively, other embodiments may form manifolds from or include multiple ducts or pipes.

11.6 Tube Supports

Flow of the second fluid over the perforated distribution tubes causes turbulence, pressure drops and a flow drag force in the direction of the second flow. Tubes oriented transverse to the flow are also subject to bending forces by the flow drag. Accordingly, in some embodiments, users preferably support these distribution tubes by attaching supporting stiffeners to the tubes.

11.6.1 Streamlined Stiffeners

In some embodiments, users preferably make these tube stiffeners from thin streamlined shapes aligned with the flow. This reduces the pressure drop and pumping power attributed to these stiffeners. (See, for example, FIG. 19.)

11.6.2 Structural Supports

In some embodiments, users attach the tube stiffeners to at least one upstream structural support attached to the fluid duct so as to support the drag forces on the tube array which are transferred to the tube stiffeners. Users preferably use a multiplicity of structural supports to provide transverse supports and counter turbulence induced force moments and array vibration or oscillation. (See, for example, FIG. 19.)

11.7 Tube Surface

11.7.1 Tube Surface Energy

The difference in surface energy between the first fluid being expelled from the tube and the tube surface relative affects whether the fluid will “wet” the surface or be repelled from it. When a second fluid is present flowing across that surface, then this difference in surface energy should also be compared with the difference in surface energy between that fluid and the tube surface. To assist droplet formation and to prevent the first fluid from wetting the exterior of the tube, in some embodiments, users preferably treat the tube surface to change its surface energy to repel the first fluid at least about and downstream of the orifices.

11.7.2 Tube Surface Roughness

Very fine surface roughness or texture also helps repel drops and prevent a fluid from wetting the surface. In some embodiments, users preferably create very small scale roughness on the exterior of the tube about and downstream of the orifices to help prevent liquid wetting and assist drop formation.

Fluid Delivery Systems

12.1 Fluid Filters

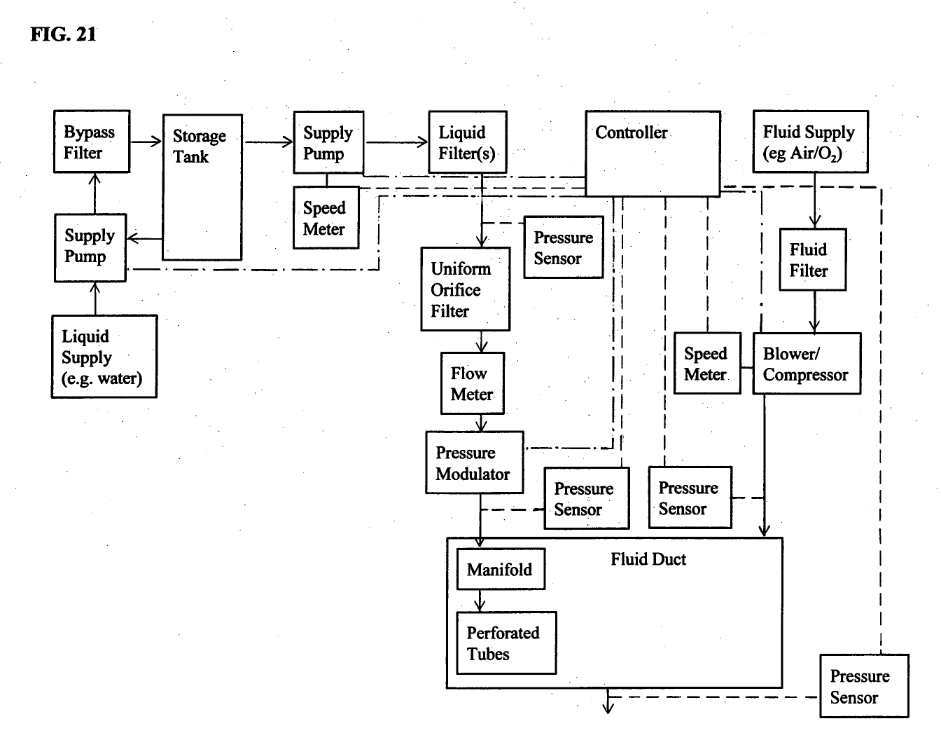

To effectively such fine orifices, in some embodiments, users preferably filter the first fluid from coarse and fine particulates to prevent the distributed orifices in the tubes from being blocked. (See, for example, FIG. 21.)

12.1.1 Coarse Fluid Filter

In some embodiments, users preferably begin with inexpensive coarse filters to remove the bulk of particulate material in the first fluid in the beginning or initial filtering stages.

12.1.2 Fine Fluid Filter

Then in some embodiments, users preferably follow the coarse filter with an inexpensive fine filter of smaller size than the orifice holes. This provides an inexpensive means to protect the precision uniform orifice fluid filters.

12.1.3 Uniform Orifice Fluid Filters

Then, in some embodiments, users preferably provide uniform orifice fine filters using fine orifices of uniform size prior to the fluid entering the perforated tubes. (See, for example, FIG. 21.) The maximum particle size passed by the fine filter is preferably ⅔rds (or about 67%) of the orifice size or less. Users preferably form this uniform orifice fine filter using a filter membrane or sheet with a large number of accurately controlled uniformly sized orifices. This can be formed by laser orifice drilling similarly to making the tube orifices except users can make it in a large thin flat sheet with low pressure drop across the sheet. In some embodiments, users then preferably support the sheet with a porous backing that permits the liquid to flow through while supporting the filter membrane.

12.1.4 Recirculating “Bypass” Filter

To extend the life of the main coarse and fine filters and the uniform orifice fine filter, in some embodiments, users preferably also process liquid storage tanks (See, for example, FIG. 21) with bypass recirculation filters to pick up most particulates in secondary inexpensive fine filters which need not have the absolute maximum orifice size of the uniform orifice fine fluid filters.

12.1.5 First Fluid Delivery System: e.g., Liquid Pump

To deliver the first fluid, in various embodiments, users preferably provide equipment to pressurize and deliver the first fluid into the second fluid. (See, for example, FIG. 21.) Users preferably select equipment sufficient to at least overcome the pressure drop of the fluid through the tubes, the pressure drop of delivering the first fluid through the orifices and the pressure drop needed to exceed the pressure of the second fluid at the orifices and to eject the first fluid into the second fluid. As the first fluid is most commonly a liquid such as water, users preferably provide a pump capable of generating at least the maximum pressure, flow rate and turndown rate desired. In some embodiments, users preferably use a continuous positive displacement pump that creates very low pressure fluctuations. E.g., Kraütler GmbH & Co. of Lustenau, Austria makes precision continuous positive displacement equipment (“KRAL”) that can be used as a pump or as a flow meter.

12.1.6 Pump Pressure Fluctuation Dampers

In various embodiments, oscillations of differential pressure across the distribution tube orifices between the first fluid and second fluid will cause variations in flow of the first fluid through those orifices. (Not shown) E.g., the typical positive displacement high pressure Diesel pump creates very substantial pressure pulsations. These will cause pulsating variations in the ratio of the flow of first fluid delivered to the flow of the second fluid. In some embodiments, users will provide fluctuation dampers between the source of the pulsations within the fluid delivery system and the distribution tubes. (See, for example, FIG. 21.) These will significantly reduce these oscillations and the corresponding variations in ratio of first to second fluids.

12.1.7 Fluid Flow Transducer

In various embodiments, users preferably provide a high accuracy high resolution fluid flow transducer inline between the first fluid pump and the manifold to the distribution perforated tube array. (See, for example, FIG. 21.) E.g., in some embodiments, users preferably use a continuous positive displacement liquid flow transducer with a an accuracy about 0.1% and a resolution about 0.01%. E.g., the continuous positive displacement high precision flow meters from KRAL-USA of Redland, Calif.. These are used as secondary liquid flow transfer standards as well as being used with a wide range of liquids and liquid viscosities in commercial applications.

12.2 Second Fluid Deliverer

In many embodiments, the second fluid delivered is commonly a gas. (In other embodiments this method may apply to delivering a first fluid into a second liquid.) Accordingly, users preferably provide a device to create a pressure difference in the second fluid between the delivery location and the exit location. (See, for example, FIG. 21.) Users create sufficient pressure difference to move the gas through at the desired flow rate for the flow impedance provided.

12.2.1 Blower(s)

In some embodiments with lower pressure applications, users preferably provide one or more blowers prior to the fluid contactor to generate the prescribed, predetermined or pre-selected pressure differential between the gas delivery point and the contactor exit. In other embodiments users place the blower after the fluid contactor to generate a prescribed, predetermined or pre-selected draft.

12.2.2 Compressor(s)

For higher pressure applications, in other embodiments, users preferably provide one or more compressors in series prior to the fluid contactor to generate the prescribed, predetermined or pre-selected pressure differential between the gas delivery point and the contactor exit. (See, for example, FIG. 21.) In other embodiments users place the compressor after the fluid contactor to evacuate and compress the gas back up to atmospheric or ambient conditions sufficient to generate the desired flow.

In many embodiments, turbomachinery is commonly used for gaseous compressors, commonly centrifugal or axial compressors. These are preferably for applications operating over narrow speed and flow ranges.

12.2.3 Moving Cavity Compressors

A number of companies provide precision screw compressors or other moving cavity compressors to compress gases. E.g., Kobelco Compressors (America), Inc. of Elkhart, Ind., provides compressors with high efficiency and linearity over a wide turndown ratio. (E.g., about +/−1%; Over a turn down range of 100% down to about 10% or less). These typically have three lobes, giving three pulses in the gas pressure per rotor revolution.

12.2.4 Natural Draft Device

In other embodiments users may provide the motive power to deliver and move this second fluid through the fluid contactor by use of device or system that generates a natural draft such as a chimney or a natural draft “cooling” tower in a power plant.

12.3 Fluid Delivery System Control

Preferably, the system of embodiments of the invention includes a pump, compressor, blower and controller. (See, for example, FIG. 21.) The controller can control and monitor the overall operation of the system such as pump pressure drop, pump speed, compressor and/or blower speed, and the like. Suitable sensors may be utilized, such as rotational speeds, pressure, temperature, flow meters and the like, as needed or desired. The controller may efficaciously incorporate a feedback system.

In various embodiments, pumps, blowers and/or compressors are variously driven by work engines, synchronous or asynchronous motors with fairly constant or varying speed. Variations in drive speed, atmospheric pressure and/or humidity cause small but significant differences in composition and/or the pressure and/or temperature to which the second fluid is compressed. In various embodiments, users preferably improve control over the compressor speed to improve control of the pressure, flow rate and/or temperature of the second fluid supplied to the fluid contactor.

12.3.1 Variable Speed Drive

In some embodiments, users preferably drive the fluid supply system by a electrical or mechanical variable speed drive. Users preferably provide a synchronous motor to reduce the variation in drive speed with variations in pressure differential between atmospheric pressure and the pressure supplied. In other embodiments users provide an asynchronous motor or work engine such as a gas turbine or an internal combustion engine.

12.3.2 Drive Speed Transducer

Users preferably monitor the speed of the pump delivering the first fluid (e.g. water). (See, for example, FIG. 21.) To achieve of the order of 0.1% flow uncertainty, in some embodiments users preferably control fluid supply drive speed with a precision an order of magnitude greater than about 0.01%. In turn, users preferably provide a rotary transducer with substantially greater resolution. In some embodiments users preferably provide a high resolution rotary transducer close coupled to the drive shaft of the order of 0.001%.

Optical rotary encoders are commonly available with 10,000 optical pulses per revolution. Electronic conditioners are available to multiply the pulse rate 2× to 20×. In some embodiments, users preferably use such equipment to provide about 200,000 pulses per revolution and dithering electronics to reduce errors due to vibration (e.g., with a 10,000 pulse per revolution encoder and a 20× pulse multiplier). E.g., see BEI Electronics.

12.3.3 Drive Controller

Correspondingly, in some embodiments, users preferably control drive speed using feedback from such speed transducers with controls of comparable resolution and precision, among other parameters. (See, for example, FIG. 21.)

12.4 High Temperature Tubes for Thermal Cleaning

Where these are not filtered out, fibers and other materials in the second fluid can build up on the tubes and block tube to tube gaps. Similarly unfiltered materials within the first fluid can block tube orifices. In some embodiments, users preferably make the perforated tubes of high temperature materials capable of sustaining temperatures preferably significantly greater than the pyrolysis temperatures of liquid fuels and blocking biomass materials. E.g., substantially higher than about 900 K (about 623° C.). In some embodiments with lower stress and temperature applications, users preferably use high temperature stainless steel. In other embodiments, with higher stress and temperature applications, users preferably select Incolonel or Hastalloy or similar high temperature materials.

12.5 Vibrate Tubes-Orifices

To facilitate drop formation and release, and to improve drop size uniformity, in some embodiments, users preferably mechanically and/or electrically excite the perforated tubes to generate vibrations in the tubes. This causes a sessile and then pendant drop or liquid jet to oscillate at or near the excitation frequency. This encourages drops to form with much greater precision and uniformity than by natural turbulence driven oscillation.

12.6 Differential Pressure Modulation System

In some embodiments, users provide a pressure modulation system to vary the pressure of one or more fluids flowing through the perforated tubes or tube arrays. (See, for example, FIG. 21.) In modified embodiments, they may also or alternatively vary the pressure of the second fluid flowing across those tubes or through those tube arrays. In some embodiments, users vary the speed of the fluid delivery pumps, blowers or compressors to vary one ore more of these pressures.

In other embodiments, users may move diaphragms, enclosure walls, or pistons connected to fluid manifolds and/or fluid ducts to modulate or fluctuate the pressure. In further embodiments, users may combine such methods of pressure variation.

By so doing, users provide systems to control the differential pressures across the perforated tubes and thus to control the fluid delivery rates through those perforated tubes.

12.7 Electrostatic Jet Reduction

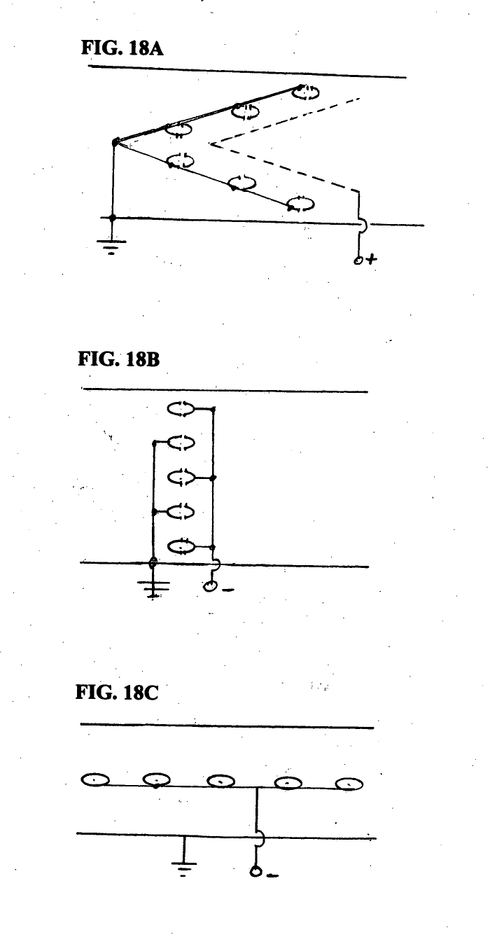

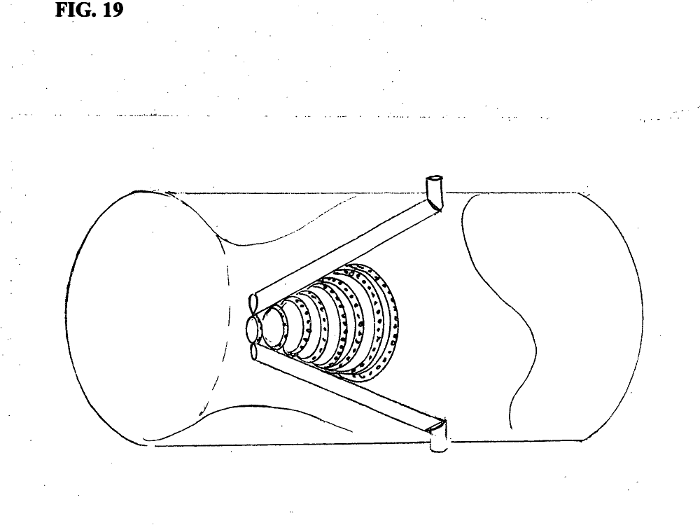

Some embodiments of the invention incorporate electrostatic jet reduction. Users preferably apply an electric field generally in line with the orifice axis. (See, for example, FIG. 18A, FIG. 18B, and FIG. 18C.) This typically causes a substantial reduction in the diameter liquid jet exiting the orifice. Consequently, the jet breaks up into substantially smaller droplets than are typically formed from jets exiting the orifice under just differential pressure.

12.7.1 Electrical Field Excitation

In some embodiments, users preferably supply one or more voltages to one or more electric grids and corresponding voltages to one or more perforated tubes or tube arrays at some suitable distance away from the grids. In general, the tubes are preferably grounded with the high voltage applied to the electric grid.

For example, users may position a conical electric grid positioned downstream of a conical distribution tube array. A differential high voltage applied between the grid and the tube array will draw micro-jets from the tube orifices towards the grid. The jets will neck down and form smaller droplets. With sufficient voltages, the droplets will be small enough to flow around the downstream grid.

In other embodiments, users similarly position the grid upstream of the tubular array. The electric field draws the micro-jets outward and generally upstream. Then the jets and droplets break up and are swept downstream by the transversely flowing second fluid.

Conversely, in other embodiments, users may excite the tubes and first fluid delivery systems and ground the electrodes. For instance, users may excite a cylindrical or conical array positioned within a cylindrical conductive duct. The duct acts as a grid and is conveniently grounded.

This method requires relatively high voltages, but relatively low power. In some embodiments, the electric power supplies providing these voltages may be controlled to vary one or more of the electric voltages and/or currents.

12.8 Electric Heating

In embodiments using electrical heating, users provide electrical supplies with suitable voltage and current to heat tubes in a controlled manner. In such embodiments, users preferably connect the distributed fluid contactor using corrosion and temperature resistant electrical contacts. These contacts are preferably configured so that there are generally similar heating rates per surface area along the distribution tubes. In embodiments using one or more helical distribution tubes, users preferably connect electrical connections to each end of the distribution tubes.

Similarly, in embodiments using multiple distribution tubes between manifolds, electrical contacts can be made symmetrically or asymmetrically across the manifolds so that the current flows generally uniformly through the tubes. E.g., to manifolds on opposite corners of rectangular distribution arrays or annular arrays. In other embodiments non-uniform heating is also used.

With these various embodiments, control mechanisms and temperature sensors are preferably provided to control the temperatures to which the distribution tubes are heated and the heating duration.

12.9 Materials

The perforated tubes and manifolds can be made from a wide variety of materials according to the applications, temperatures, and desired or needed design life. Embodiments commonly use corrosion resistant materials such as stainless steel. High temperature applications will use suitable high temperature materials such as Inconel or Hastalloy. Others embodiments can use quartz, glass, sapphire or ceramic tubes. Other embodiments utilize a variety of structural plastics.

Operation—Preferred Embodiment

13.1 Fluid Pressure Drop Ratios

In many embodiments, users desire or need to control the ratio of the flow of the second fluid across the tubes to the flow of the first fluid through the tubes. This relates to the velocity ratio times the density ratio times the net area of the fluids. In many embodiments, the velocities in turn relate to the pressure drops the fluids experience, for given fluids, pressures and temperatures etc.

For many embodiments, the corresponding primary control parameter is the pressure drop across the tube array relative to the differential pressure drop across the tube wall. The second fluid flow rate and pressure drop across the tube array is often held constant or varies relatively slowly. Thus users will primarily control the differential pressure drop across the tube wall to control the pressure drop ratio.

13.2 Excitation Drop Control

In various embodiments, users further control the size, uniformity and rate of drop ejection and formation by

1) mechanically vibrating the orifices (tubes), by

2) pulsing the differential pressure across the orifices (tube wall), and/or by

3) controlling the electric field outside tube orifices.

13.3 Vibrate Tubes-Orifices

To facilitate drop formation and release, and to improve drop size uniformity, in some embodiments, users preferably mechanically and/or electrically excite the perforated tubes. This causes a sessile and then pendant drop or liquid jet to oscillate at or near the excitation frequency. This encourages drops to form with much greater precision and uniformity than by natural turbulence driven oscillation.

13.3.1 Orifice Vibration Frequency & Direction

In some embodiments, users preferably oscillate the perforated tube arrays at or close to the natural frequency of the liquid microjet oscillation. In some embodiments, users preferably oscillate one or more the tubes along the axis of the flow direction. In this mode, all orifices are vibrated substantially uniformly to desirably obtain more uniform drop size. In some embodiments, orifices expelling liquid drops or microjets are preferably vibrated transverse to their axis (i.e., the flow axis of the first fluid), especially when the orifice orientation is preferably perpendicular to the second fluid flow. This maximizes the formation of the capillary waves in the microjets and consequent formation of drops of uniform size.

In various embodiments, users preferably use a frequency Omega of wavelength lambda with a characteristic capillary speed V_{c} where Omega=V_{c}/lambda=V_{c}*0.56/(2*Pᵢ*rₒ).

In other embodiments, users preferably oscillate the tubes transverse to the fluid flow direction of the second fluid to create symmetric liquid oscillations. For example, when the orifices are oriented parallel to the second fluid flow axis. In other embodiments, users vibrate the orifice array in the azimuthal direction about the flow axis of the second fluid. This is typically the least effective option since the vibration magnitude is proportional to radial distance from the axis.

13.4 Ultrasonic Intra-Tube Fluid Pulsation

13.4.1 Minimum Orifice Differential Fluid Pressure to Overcome Surface Energy (“Tension”)

With small orifices, surface tension becomes a major factor in determining drop (or bubble) formation. A differential pressure or acceleration is typically needed to form liquid drops (in a gas or liquid) or conversely gas bubbles in a liquid, due to increasing the interfacial surface energy (“surface tension”). The higher the interfacial curvature (the smaller the orifice diameter), the greater the differential pressure needed to form the interfacial surface energy. When orifices vary in diameter, the minimum pressure needed to expel liquid from the largest holes will typically not be sufficient to expel them from smaller holes.

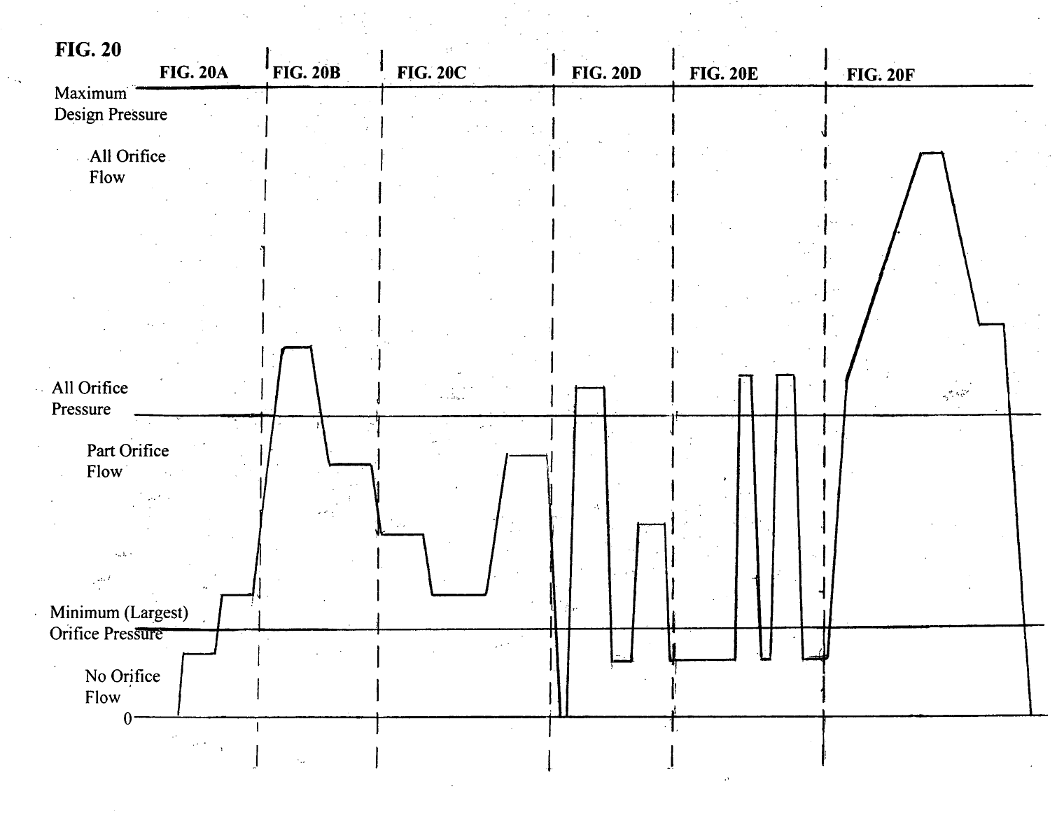

Accordingly, in some embodiments, users apply a pressure at least sufficient to expel liquid from the smallest holes. Users correspondingly provide fluid pressure in the manifolds and distribution tubes at least sufficient to exceed this minimum differential pressure at the tube orifices when users need or desire to create drops. (See, for example, FIG. 20A.) This flow continues as long as fluid is provided with at least a differential pressure greater than this Minimum Orifice Differential Pressure.

13.4.2 All Orifice Differential Fluid Pressure

When orifices differ in size about the distribution tubes, then to create drops (or bubbles) users should apply different differential pressures or accelerations across the orifice (tube wall) between the fluid within the tubes and the surrounding fluid to create drops (or bubbles) from differing sized orifices. In some embodiments, users preferably apply a pressure generally greater than the All Orifice Differential Fluid Pressure or acceleration sufficient to form drops through all the orifices.

In other embodiments, users apply a pressure generally less than All Orifice Differential Fluid Pressure but somewhat greater than the Minimum (Largest) Differential Fluid Pressure, as needed or desired. Such control will typically create drops from the larger orifices but not from the smaller ones. (See, for example, FIG. 20B.)

13.4.3 Control by Graded Differential Pressure

In other embodiments, users form orifices with a small but generally uniform gradient in size e.g., large at the center to smaller at the periphery. Users then apply a prescribed, predetermined or pre-selected differential pressure sufficient to form drops though a portion of the orifices but not through all of them, in order of larger orifices to smaller ones. In some embodiments, users selectively control the differential pressure to spatially select where drops are formed. To do so, they preferably vary the differential pressure at least above a minimum pressure and generally below the maximum pressure required to form drops from all the orifices. (See, for example, FIG. 14A, FIG. 14B, FIG. 14D, FIG. 20B.)

13.4.4 Control by Pressure with Discrete Orifice Sizes

In some embodiments, users form orifices of varying size for tubes bent to different radii, arcs or helices. A prescribed, predetermined or pre-selected differential pressure is then applied to selectively issue or eject drops (or bubbles) from orifices in some tubes and not from others. This provides users with substantially discrete spatial control of where drops are formed. (See, for example, FIG. 20C.)

13.4.5 Control by Digital Fluid Pulsation

With substantially uniform orifices, in some embodiments, users use a differential pressure pulse as a pressure “switch” to form one or more drops out of each of a prescribed, predetermined or pre-selected range of orifices. They then turn the flow off by reducing the differential pressure to somewhat below the minimum orifice differential pressure. (See, for example, FIG. 20D.)

13.4.6 Control by Frequency Modulation

By varying the frequency of pulses of a given magnitude, in some embodiments users apply a frequency modulation of drops (or bubbles) injected into the surrounding fluid flow. The rate at which drops are formed is generally controlled by the frequency with which a pressure pulse is given that exceeds the minimum orifice differential pressure. To refine this control, users preferably provide smaller changes in the pulse width to compensate for inertia and the necessary fluid acceleration needed to form a drop or bubble. (See, for example, FIG. 20E.)

13.4.7 Control by Amplitude Modulation

By varying the pressure amplitude, in some embodiments users create a form of amplitude modulation. With intermediate pressure, the higher the pressure the more orifices emit liquid. With pressures above the All Orifice Differential Pressure, the greater the velocity of fluid ejected through the orifices. (See, for example, FIG. 20F.)

Varying the width of pressure pulses may also provide some degree of amplitude modulation because of fluid inertia and the time it takes to accelerate and expel liquid through the orifice.

13.4.8 Higher Pressure Jet Control

By increasing the differential pressure across the tube wall above that required to form drops, in some embodiments users increase the flow rate of injected first fluid till it forms a jet with a given velocity entering the second fluid flow. This affects the drop size, injected fluid flow rate and penetration distance. Users further control the fluid injection rate by adjusting this high differential pressure within the stress limits of the tube and orifice construction. (See, for example, FIG. 20F.)

13.4.9 Maximum Operating Design Pressure

The strength of the thin wall strip or foil, orifice fraction and wall curvature, will have effect on the limit of the usable differential pressure across the perforated wall. Accordingly, in some embodiments, users generally limit the upper differential pressure within suitable safety factors, accounting for long term cyclic fatigue. (See, for example, FIG. 20A.)

13.5 Tube Stress and Pressure Differences

In various embodiments, users preferably control the maximum pressure difference across the tube wall to prevent the tube from bursting. The hoop stress generated in the tube walls is preferably kept below the design working stress of the tube material adjusted for the stress concentrations of the orifices and bonding methods. From the curvature, stress concentrations and strength of the wall material, there is a maximum tolerable design differential fluid pressure and pressure fluctuation rate.

13.5.1 Maximum Differential Pressure in Perforated Tubes

In general users preferably constrain the internal fluid force within the tube to less than the tensile force in the tube walls. The internal fluid force is about equal to the fluid pressure times the longitudinal cross sectional area of a tube section in a plane through the tube axis. The tensile force is about equal to the hoop stress in the tube wall multiplied by the cross sectional area of both tube wall sections in that longitudinal plane.

In doing so, users preferably account for the stress, creep and fatigue components. These include stress concentrations due to orifices, non-circular shapes, bending forces of gases traversing the flow, vibration due to turbulence and vortex generation, pressurization to control flow, and cyclic pressurization to vary flow rates or digitally control the liquid flow.

Under some circumstances and embodiments, users preferably provide differential pressures that exceed the nominal design limits but remain below the tube burst pressure, when higher than nominal design rates are desired or needed. They then replace the distribution tubes more frequently to accommodate the greater damage rates.

13.5.2 Maximum Thin Wall Tube Diameter for Orifice Size

A given laser drilling technology typically has an optimum Wall Thickness/Orifice Diameter. E.g., about 10:1. In various embodiments, users preferably select a desired orifice size. This in turn limits the maximum wall thickness through which users can create the needed or desired orifices using that orifice forming technology. E.g., about 100 μm wall thickness to form about 10 μm orifices.

13.5.3 Minimum Pressure for Liquid and Orifice

Conversely, the orifice size and the fluids used determine a minimum pressure needed to force the liquid out through the orifice. This is proportional to the differential surface energy between the first liquid being expelled from the tube and the second fluid flowing across the tube.

In accordance with some preferred embodiments, users establish a minimum and a maximum pressure within which embodiments of the distributed direct contactors can be safely and/or optimally operated.

13.5.4 Maximum Over Pressure

In some circumstances, the pressure around the perforated tube may fluctuate. It could be possible for the pressure around the tube to become greater than the pressure within the tube. In other embodiments the pressure within the perforated tube might be decreased below the pressure around the tube. In such circumstances there is potential for a negative differential pressure on the perforated tube. With thin walled tubes, and especially with thin perforated foil walls, it might be possible to bend the thin wall or foil inward. This could fatigue or tear the thin wall or foil or separate it from the structural wall. Sufficient over pressure could even cause a sufficient negative differential pressure that could collapse the compound perforated tube.

Consequently, in some embodiments, users preferably control the maximum negative differential pressure to prevent such collapse damage to a perforated and/or compound perforated tube. This is particularly applicable for tubes within the pressurized chamber of an internal combustion engine.

13.5.5 Combined Pressure Control

Preferably, in some embodiments, by varying pulse width, pulse amplitude and/or pulse frequency users precisely adjust the rate of fluid issuing from the tubes relative to a varying rate of fluid flow across the tubes over common to very wide turn down ranges. These controls dynamically adjust the flow rates to provide digital frequency or amplitude modulation of the relative fluid mixing.

13.6 Electric Field Excitation Control

13.6.1 Base Electric Field Excitation

In some embodiments, users preferably apply one or more suitable electric fields generally normal to liquid orifices in perforated tubes. In some embodiments, one or more high differential voltages are applied between perforated arrays and complementary grid electrodes to form these electric fields. (See, for example, FIG. 18A.) In other embodiments, voltages are applied between two or more sets of distribution tubes. (See, for example, FIG. 18B.) In another configuration, the voltages may be applied between tubes and a portion of one or more ducts. (See, for example, FIG. 18C.)

Such electric fields create fine liquid columns smaller in diameter than the orifices they are delivered through. This liquid column then breaks up into micro droplets that are smaller than the orifice diameter. (This contrasts with sessile or “pendant” drops which are about twice the size of the orifice. It also differs from high velocity jets which initially break up into drops of similar size to the orifice. The differential fluid velocity then breaks these drops into smaller droplets.) In such configurations, one or more conductive manifolds may be used as methods to electrically connect distribution tubes to respective voltage sources.

In some embodiments, users preferably apply a prescribed, pre-selected or pre-determined excitation voltage according to the electric field gradient desired or required, liquid surface tension and viscosity gas pressure and flow rates. These in turn depend on the tube to tube spacing, liquid composition and temperature. Such electric field excitation provides the benefits of using larger orifices that are less susceptible to clogging while creating smaller drops. It can also be used to create drops from more viscous fuels such as bunker fuel or crude oil.

13.6.2 Control by Oscillating or Pulsing Electric Fields

In some embodiments, users pulse or oscillate the high voltage between two or more tubes or tube sets, or between tubes and electrodes. This provides an oscillating excitation to the first liquid being delivered or expelled from the perforated tube orifices. This in turn will generate oscillations in the liquid column and initiate column breakup and droplet formation. The liquid oscillations will be generally synchronous with the field excitation. The oscillating electric field excitation will generally create more uniform droplets according to the precision of pulsing the electric field in magnitude and frequency.

In some embodiments, users preferably tune the electric field pulsation or oscillation frequency to the natural liquid jet oscillation frequency in the presence of the average electrical field established.

13.6.3 Control by Field—Drop Frequency Modulation

As with pressure modulation, in some embodiments, users modulate the electrical field to vary drop size and delivery rate with a prescribed, predetermined or pre-selected frequency modulation.

13.6.4 Control by Field—Drop Amplitude Modulation

In some embodiments, users preferably modulate the amplitude of the electric field. This expands or reduces the liquid jet and thus creates drops of different size resulting in a general drop amplitude modulation. Such amplitude modulation provides benefits of varying drop size in systems where drop size is generally controlled by orifice size and liquid surface energy.

13.6.5 Control by Combined Frequency and Amplitude Field Modulation

In some embodiments, users combine frequency and amplitude modulation of the applied electric field. This enables users to substantially vary both drop size and drop delivery frequency and thus liquid delivery rate.

13.7 High Temperature Cleaning

In some embodiments, fibers and other material in the second fluid that are not filtered out can build up on the tubes and block tube to tube gaps. In some preferred embodiments, by using high temperature materials to make the tubes, users preferably heat the tubes and vaporize or “gasify” any liquid fuel or biomass materials built up on tubes or blocking them. This operation is similar to an electric “oven cleaner.” Users preferably control the temperature carefully and precisely, sufficient to at least exceed the pyrolysis temperature of liquid fuels for the necessary duration. Users further preferably maintain the temperature below prescribed, pre-determined or pre-selected levels, to stay below creep and deformation design parameters of the material used.

In some embodiments, users preferably provide a hot water or steam flow through one or more perforated tubes in addition to or instead of electrically heating the tubes, to assist cleaning the orifices by the water gas shift reaction.

Forming Streamlined Arrays of Perforated Tubes

Here are disclosed preferred methods of forming perforated distribution tubes. In some configurations, users further assemble these streamlined perforated tubes into arrays and connect them to manifolds to duct the fluid to the tubes.

14.1 Cutting Tubes and Forming Holes

Following are preferred ways of forming tubes and manifolds.

14.1.1 Cut Tubes

Users cut long tube lengths into suitable shorter lengths. Technology is now available to rapidly and precisely shear or separate tubes into shorter tubular lengths sections without sawing them and with minimal burr formation. E.g., Production Tube Cutting Inc. of Dayton, Ohio.

14.1.2 Form Holes in Manifolds

To attach tubes to manifolds, users form suitably sized holes in the manifolds. Then users abut or insert the perforated tubes into the manifold hole. Finally users join the tubes to manifolds by welded, brazing, soldering or a similar joining method.

14.1.3 Manifold Hole & Tube End Shape

In many embodiments, users form circular holes in manifolds. Accordingly, users preferably form the ends of distribution tubes into circular shape to fit the manifold hole.

In other embodiments, users may extend the manifold hole to variously form round ended slots, or elliptically shaped holes etc. as needed or desired. Users correspondingly form the tube ends into shapes the conveniently fit into such elongated holes.

14.1.4 Friction Drilling

Users preferably use friction drilling to heat and soften or melt metal and press a hole through it. Users preferably create a hole and then pull the residual metal out to form a collar after the manner of T-Drill company of Norcross, Ga. This is preferable in providing an outward extension that assists in welding a connecting tube and adds strength to the joint. In other embodiments users may use the method of the FlowDrill company of St. Louis Mo. using hot drilling to create a hole, which leaves 80% of the residual metal pointing inward, 20% outward.

14.2 Bond Tubes into Manifolds

In some embodiments, tubes are then bonded to one or more manifolds using one of a variety of methods including inductive, electric or friction welding. Modem technology is now available to inductively weld tubes with thin walls to manifolds. For instance, VerMoTec of St. Ingbert, Germany can inductively weld tubes with 0.15 mm thick walls.

In other embodiments, users braze, solder, glue, thermo-form or use other suitable techniques to join the tubes to one or more manifolds.

14.3 Structural Supports

14.3.1 Manifold Tube Supports

Attaching the perforated distribution tubes to manifolds provides some structural support. Further support is provided by positioning tube sections between two manifold tubes. E.g., in planar arrays, or in circular sections.

14.3.2 Additional Supports

As needed or desired, users add further supports at the end of tubes, or attach supports in between tube ends, transverse to the tubes. In some embodiments, these are preferably positioned upstream of the tubes so that liquid does not impact and build up on downstream supports. In other embodiments users attach supports both above and below tubes to form a three dimensional structurally supported array or space frame.

14.4 Flow Direction Tube Offset

A planar tube array blocks part of the flow cross section, restricting the flow to the space between the tubes. This causes a significant pressure drop. In some embodiments, users preferably offset tubes along the flow velocity axis to increase the gap between tubes. This typically reduces the flow constriction and the pressure drop across the tubes. This generally generates substantial savings in parasitic pumping energy, resulting in savings of both capital and operating costs.

14.4.1 Offsetting Adjacent Tubes

For instance, offsetting adjacent circular tubes by about 122% of the tube spacing W will increase the gap G between the tubes to about equal to the tube spacing W. E.g., using tubes with about for 4 mm diameter on 7 mm intervals, offsetting the tubes by about 8.5 mm will increase the gap G between tubes from about 3 mm to about 7 mm or about equal to the tube spacing. In this example, this offset increases the area between the tubes to about equal to the unobstructed cross section of the flow.

In other embodiments, users similarly offset streamlined tubes to increase the gaps between tubes. While there is still significant drag across the tubes, offsetting adjacent tubes significantly reduces the flow constriction and consequent pressure drop. (See, e.g., FIG. 12D.)

14.4.2 Conical Arrays

For circular flow ducts, some embodiments preferably use a conical or helical tube array rather than a planar circular array. With such an conical or helical array, the flow area between tubes can be increased to greater than the cross sectional area of the total flow by sufficiently reducing the cone angle in the “horn” configuration. (See, for example, FIG. 12D.) Similarly, the flow area can be increased by increasing the cone angle to much greater than 180 degrees in the “funnel” configuration. Here the upstream area of the array is larger than the downstream area. (See, for example, FIG. 17A. I.e., the opposite orientation to FIG. 12D.)

14.4.3 Pleated Array

At the other extreme, in some embodiments, users increase gap area between tubes by offsetting alternating tubes upstream and downstream in a zig zag pattern. (See, for example, FIG. 17B.) This significantly reduces the axial dimension of the duct while increasing inter-tube gaps.

In other embodiments users increase the inter tube gap by forming tubes into intermediate pleated arrays with larger zigzags. Here they offset several tubes in one direction then offset the next several tubes in the other direction. (See, for example, FIG. 17C.)

14.4.4 Compound Arrays

In further embodiments, users further combine these array formations. For example, users can use a conical compound tube array in the center portion of the flow and surround this by a pleated circular array extending outward to the flow boundaries. These examples of offsetting tubes generally apply substantially equally to Cartesian arrays, annular arrays, or otherwise ordered arrays.

14.5 Three Dimensional Structural Supports

As the tubes are offset, so the manifolds and structural supports are also generally offset. Offsetting the tubes and supports advantageously forms a three dimensional structural support or space frame that is stronger than planar arrays.

14.5.1 Conical Rays

Users form manifolds and add further structural supports in some embodiments as radial rays substantially tangential to the surface of a conical section. (See, for example, FIG. 12D.) By these methods, users provide three dimensional structural strength and stability to the tubular array. Users use at least two and preferably three or more radial structural manifolds and supports along the edge of the conical tube structure.

14.5.2 Space Structure

In some embodiments, users further provide transverse supports between tubes, and manifolds. Similarly, they may provide structural supports between offset arrays. Such methods further create space array type structural supports, thus giving the system greater strength and rigidity.

14.6 Design Optimization

As users narrow and streamline the distributed tubes, users reduce the drag of the second fluid flowing across the tube arrays. Conversely this increases the capital cost's of the tubes. Similarly as users increasing the tube-tube spacing, users reduce the drag across the tubes. At the same time, users increase the length and pumping work to deliver the second fluid through micro-jets. These parameters will vary with the viscosity and thus the orifice size and temperature of both the injected second fluid and the transverse first fluid.

In some embodiments, users adjust the tube diameter, shape, spacing, fluid velocity, orifice size and differential pressure to optimize drop formation and fluid mixing while minimizing the parasitic fluid pressure drop and fluid pumping losses, fluid filtration and costs. Users preferably optimize the capital cost of forming streamlined perforated tube arrays plus the net present worth of unrecoverable pressure-volume work of pressurizing and injecting the first fluid, and of compressing the second fluid sufficient to overcome the drag induced pressure drop across the distributed tube array, over the life of the system.

Alternative Methods of Forming Orifice Arrays

15.1 Alternative Assembly of Compound Perforated Tube

After forming the structural strip and the stiffened perforated foil as described above, the following modified or other techniques or steps are used in some embodiments. (See, for example, FIG. 4, FIG. 5.)

15.1.1 Attach Perforated Foil to Structural Strip

Overlap and align one edge of the perforated foil over the indented edge of the structural strip. Users preferably minimize hole blockage and facilitate cleaning by using the “horn” configuration. I.e. by orienting the smaller hole diameter inward with the hole size increasing outward (as discussed above and illustrated in FIG. 9A). If the smallest holes are needed or desired, then users use the “funnel” configuration. I.e. users configure the smaller diameter of the holes aligned outward with the outer surface of the strip and larger diameter inward (as discussed above and illustrated in FIG. 9B).

In this assembly method, the perforated strip or foil is first bonded to the structural strip along one edge.

15.1.2 Form Stiffened Perforated Foil into Downstream Streamlined Shape

Both sides of the compound strip are bent up about the tube-foil joint and formed into the desired streamlined shape. This will be similar to an elliptical shape but with a wider shorter upstream width and longer narrower downstream section similar to aircraft strut faring.

15.1.3 Align Perforated Foil to Structural Strip

The free edge of the formed perforated strip is aligned to the indent in the formed structural strip.

15.1.4 Attach Outer Foil Edge to Strip Edge

The perforated foil edge is attached or bonded to the structural strip edge to complete the streamlined compound perforated tube.

15.2 Alternative Elliptical Tube Construction

Following is a modified or other method of forming a compound perforated tube starting with an approximately elliptical tube.

15.2.1 Form Elliptical Tube

A stainless steel tubing of diameter D is pressed into an approximately elliptical shape. E.g., a tube with about a 4 mm outer diameter is selected with wall thickness about in the range 0.20 mm to 1.0 mm. This will have a circumference of πD of about 12.6 mm with a half circumference of about 6.3 mm.

15.2.2 Cut into Half Elliptical Tube

This elliptical tube is then cut in half along the short axis (normal to and half way along the long axis). E.g., using an abrasive water jet or a power laser. In other embodiments the tube is machined about in half to remove one half along this line.

15.2.3 Form Elliptical Foil

The thin perforated stainless steel foil is then formed approximately into the shape of half an ellipse with the ends forming the short axis of the ellipse. (In modified embodiments the tube is formed into a similar parabolic shape.) This downstream tube section is formed slightly wider than the net width of the supporting upstream half tube.

15.2.4 Prepare Attachment Indent

A thin indent is then ground a little greater than the thickness of the perforated foil on each outer side of the half tube e.g., about 25 to 35 micrometers. This is extended a little greater than the desired attachment width of the foil. E.g., about 0.6 mm to about 1.1 mm up both outer edges of the tube.

15.2.5 Fit Foil to Tube

The perforated foil half ellipse is fitted up over the half ellipse supporting tube to form an approximate ellipse.

15.2.6 Bond Foil to Tube

The thin foil half tube is then bonded to the supporting half tube. E.g., by induction welding, friction welding, brazing, soldering or gluing among other methods, according to the temperature and strength required.

Heat Exchangers & Contactors

16.1 Residence Time

16.1.1 Residence Time vs Drop Size Distribution

The speed of many physical phenomena and chemical reactions depends on the surface area of fluid or the interfacial area between two fluids. The time for the process to finish in turn depends on change in a process through the drop. Drop formation in most prior art systems results in a broad distribution of drop sizes. Disadvantageously, this results in a broad distribution of corresponding drop reaction residence times. In the prior art, systems are sized for the largest drops and longest acceptable residence times.

In contrast, users advantageously form drops of substantially uniform size using with distributed perforated tube arrays of embodiments of the invention. In turn, users achieve a substantially uniform and/or controlled residence time for substantially all drops. Consequently, users can significantly improve throughput, improve quality and reduce costs etc. Some applications of these methods and benefits are detailed as follows.

16.1.2 Evaporation Residence Time

The time to evaporate drops strongly depends on the largest drops in a spray. This correspondingly increases the evaporation equipment size. Instead of non-uniform drops, users preferably form substantially uniform drops of a second fluid by substantially uniform distributed orifices in perforated tube arrays in various embodiments of the invention. Users consequently obtain a substantially uniform time for those drops to evaporate in substantially uniform unsaturated flows of a second fluid.

William Sirignano (1999) reviews droplet evaporation rates including transient effects due to changing temperature in combustion, and the effects of neighboring drops in sprays or drop arrays. Davis & Schweiger (2002) further review the evaporation of drops. The vapor pressure of the second fluid and the diffusion coefficient in turn depend on the effective temperatures of both the liquid and gas. The evaporation rate of a drop is generally proportional to its surface area, the difference between local and remote vapor pressures and a diffusion coefficient.

To ensure substantially complete evaporation, users choose the drop size and residence time sufficient to generally limit the maximum evaporation time with a suitable statistical probability.

Accordingly, users create orifices with substantially the desired diameter and general uniformity, adjust tube oscillation frequency, control the pressure pulsation pattern of the second fluid and/or the external electric field outside the orifice, and the temperature of the two fluids and vapor pressure of the liquid in the second fluid as appropriate, needed or desired. Then users select the duct area and length, and the velocity (or pressure drop) of the second fluid in a prescribed, predetermined or pre-selected manner to control the residence time.

16.1.3 Heat Exchanger Residence Time

Drops (or bubbles) of a first fluid traveling in a second fluid change in temperature with evaporation, condensation and/or heat transfer and time. To achieve a given proportional change in temperature compared to the total temperature difference, users create and distribute substantially uniform drops and provide a prescribed, predetermined or pre-selected residence time for them in the second fluid.

16.1.4 Condensation Residence Time

Cooler drops of a first fluid in a second fluid saturated with some vapor will cool the fluid and condense some of that vapor. In some embodiments, users use distributed contactors to fairly uniformly distribute a cooler fluid in a second fluid. The first fluid temperature is preferably kept below a generally prescribed temperature. The contactor forms substantially uniform drops. It distributes the drops fairly uniformly.

Users preferably provide a mean residence time generally sufficient to achieve a certain fraction of the total temperature change. This achieves a certain amount of cooling of the second fluid. This in turn will generally condense a certain fraction of the vapor in the second fluid. By controlling the uniformity of the various parameters, users generally achieve a given condensation fraction.

16.2 Counter-Flow Direct Contact Heat Exchanger

Exhausting hot products of combustion results in significant energy losses. Surface heat exchangers are typically used to recover such exhausted energy. Using sprays with a wide distribution of drops results in small droplets being entrained in the exhaust plume with consequent loss of water.

To prevent or mitigate this, users preferably counter-flow drops of cold first fluid against a hot second fluid. They use distributed fluid contactor embodiments to distribute substantially uniform drops of fairly uniformly across the second fluid. They preferably use a generally vertical duct with fairly uniform cross section. They preferably select mean drop size and design the flue gas velocity so that the drops fall through the counter flow. I.e. most drops are formed larger and heavier than those that are entrained by the exhaust fluid flow. The force of gravity on the drops is greater than the sum of the drag on the drops and the buoyancy of drops in the counter flowing fluid. Conventional sprays generate “drafting” or coordinated drop motion. This increases drop entrainment. With distributed drop contactors, users preferably adjust drop velocity to compensate for the small drafting component.

As the drops fall through the counter flow of hot flue gas, they cool the flue gas. The hot gas in turn heats the drops. As a result, users have hot liquid drops at the bottom of the flue, and cold flue gas exiting the top of the flue. In some embodiments, users provide a gas-liquid separator to separate the hot water at the bottom of the flue from the hot flue gas. By this counter-flow direct contact heat exchanger, users desirably achieve a very efficient and inexpensive recovery of the heat in flue gas exhaust stream.

Users configure similar processes to recover heat in an hot exhaust fluid stream. E.g., in the case of an exothermic reaction or where the fluids are otherwise heated.

16.2.1 Direct Contact Fluid Condensor

When there is a condensable vapor in a hot flue gas (e.g., steam or hot water vapor), the cold drops will condense that vapor and become hotter. In some embodiments, users preferably use the same liquid as the vapor being condensed e.g., cold water to condense steam. Small drops provide a very high surface area giving rapid heat transfer. This process advantageously provides an efficient means of recovering a liquid from a hot exhaust fluid stream.

In other embodiments, users could use a third inert liquid as the liquid coolant or diluent. (See, for example, FIG. 8.) For example users can use a low vapor oil such as is used in vacuum pumps, or a synthetic fluid or refrigerant. In modified embodiments users efficaciously use a liquid metal such as gallium which has a low vapor pressure and a very wide liquid range, as needed or desired.

16.3 Cross-Flow Contactor

16.3.1 Cross-Flow

Users preferably increase the effective surface contact area of drops by reducing the orifice size and thus the drop size while increasing the number of orifices. However, the drop terminal velocity decreases with drop size. With counterflow configurations, the maximum gas velocity should be lower than the liquid drops' terminal velocity to prevent drops from being entrained by the gas and lost. Consequently the cross sectional area of the duct should increase as the drop size decreases i.e. so the gas velocity decreases. Conventional systems disadvantageously result in a wide range of drop size. This undesirably requires the gas flow and duct area to be sized for the smallest size for the tolerable droplet loss rate in the exit gas stream.

In contrast, users preferably generate substantially uniformly sized drops with embodiments of distributed contactors. Users thus preferably increase the gas flow and reduce the duct size while still retaining a very high droplet recovery. Even when users obtain smaller droplets, users will typically have a bimodal distribution with narrow peaks. The users preferably size for a prescribed, predetermined or pre-selected fraction of droplets recovered. Similarly users preferably use a range of orifices to increase turn down range. This gives us a narrower range of drop sizes than conventional spray systems. Again users preferably determine the desired gas flow velocity and size the ducts accordingly to achieve the desired droplet recovery.

16.3.2 Multiple Horizontal Plates

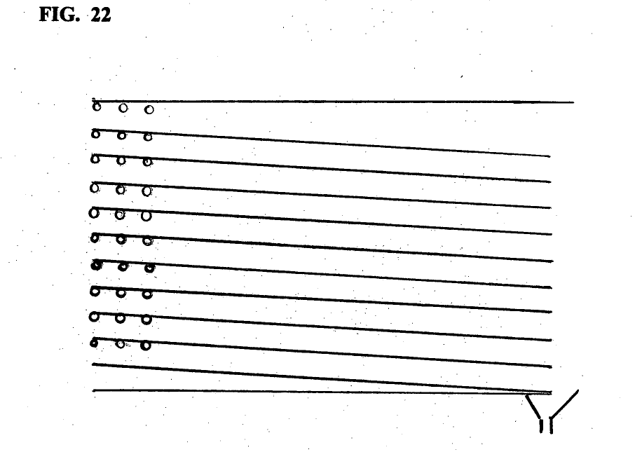

To overcome these limitations, users preferably direct the gas flow through multiple thin ducts. (See, for example, FIG. 22.) In some embodiments, users preferably orient these ducts generally horizontally. Users then direct the liquid orifices downward at the beginning and upper portion of each horizontal thin duct. Users preferably use substantially uniformly sized orifices drops to give substantially uniform drop velocities and residence times. Users size the duct height relative to the gas flow velocity so that the flow is preferably laminar.

Users preferably size the vertical depth of the thin ducts together with their length and width relative to the design gas flow velocity and drop size so that the liquid drops traverse the thin duct and contact the lower surface of the thin duct in generally less time than the residence time of the gas within the duct. Users then preferably control the gas flow rate relative to the drop flow rate to ensure that the gas flow rate results in a gas residence time greater than the time for the drops to fall from the top to the bottom of the thin horizontal ducts.

Spray flushing: Users further preferably provide for a high intensity and volume spray for each thin duct to periodically flush and wash out the accumulated particulates. Users preferably provide numerous orifices along a tube with a high pressure pump to provide a flushing spray across the full width of the duct. In other embodiments, users could provide a moveable spray system that periodically moves across the ducts and sprays each duct in turn. In modified embodiments, users could use a narrow spray to sequentially traverse across each duct.

Duct Angle: With a perfectly horizontal duct, the water would tend to stand in the duct. Accordingly, users preferably tilt the cross-flow ducts to a predetermined or pre-selected angle. This enhances the liquid flow down the duct in the direction of the air flow, preferably carrying recovered particulates with it. When users spray clean each duct, this preferable tilt similarly assists in flushing the duct and removing the particulates. In other embodiments, users could tilt the duct the other direction so that the liquid flows counterflow to the gas flow. This is more likely to create waves and duct blockage but is a possible modification.

Sizing: Users preferably size and configure the number of ducts and their width and length to minimize net present value of the life cycle costs of the ducts. These include pumping power needed to exhaust the gas, pump and recirculate the liquid, and the cost of spray cleaning the system.

16.3.3 Direct Contact Co-Flow Heat Exchanger

In some embodiments, users configure the direct contactor array to distribute droplets of the first fluid that are entrained into the co-flowing second fluid or are injected in the direction of fluid flow. This configuration will form in a direct contact co-flow heat exchanger. It is useful or particularly significant where the second fluid is saturated with the first fluid, or where the first fluid has a low volatility.

In embodiments where users desire or need to recover the first fluid, various liquid retrieval methods may be used, such as impingement separators, electrostatic precipitators, cyclones etc. The substantially uniform size drops used will result in much greater recovery of the injected liquid.

16.4 Fluid Scrubber

16.4.1 Intake Water Scrubber

Intake air or compressed oxidant containing fluid is commonly filtered through a porous intake filter to remove particulates. This reduces the compressor and turbine fouling thus preventing efficiency losses at the expense of a pressure drop with consequent pumping losses.

16.4.2 Exhaust Water Scrubber

Users similarly scrub the exhaust gases from combustion or power generation.

16.4.3 Sub-Atmospheric Direct Contact Condensor with Recompression

In the VAST cycle (Value Added Steam Technologies) users preferably use a minimum of excess oxygen and maximize gas cooling with the vaporizable thermal diluent. (See, for example, the Appendices A-C for further details on the VAST cycle.) Correspondingly users preferably cool the working fluid exhausted from the expander to further condense that thermal diluent. This can result in sub-atmospheric pressures. Users therefore preferably size the drop size and the distributed contactor direct contact heat exchanger dimensions to account for the greater velocity for a given drop size due to the lower pressure and density.

Scrubbing Soluble Emissions—NO₂, SOₓ: Some of the nitrogen oxides formed during combustion are highly soluble in water. E.g., Nitrogen dioxide (NO₂) is 10,000 more soluble than nitric oxide (NO). Similarly oxides of sulfur are also soluble in water. Both form dilute acids.

By thoroughly scrubbing the flue gas with large numbers of very fine water drops users provide a very large direct contact surface area. Users thus advantageously provide an effective means of scrubbing soluble pollutants like the soluble oxides of nitrogen and sulfur.

Mercury: Coal contains significant quantities of mercury. The concentrations of mercury in coal are typically a little less than 1 ppm. Burning coal is a major source of mercury emissions into the atmosphere. Combustion with 3% excess oxygen would result in gas concentrations of 80 ppb. Control of mercury concentrations on utility emissions of ˜1 ppbv are being considered, requiring about a 90% reduction in mercury emissions. At high temperatures, mercury remains as a vapor. In coal gasification, hot removal of particulates does not remove significant portions of the mercury vapor. Cooling the synthesis gas before combustion to remove mercury would cause substantial thermodynamic efficiency losses.

Mercury has a melting point of 234.28 K (−38.87° C., −37.966° F.) and a boiling point of 629.73 K (356.58° C., 673.844° F.). The National Institute of Science and Technology (NIST) Standard Reference Database 87 provides vapor pressure data for numerous elements and compounds including mercury. The vapor is fit to the Antoine or Extended Antoine equation. Vapor pressure increases approximately exponentially with temperature above the boiling point.

Users preferably cool the exhaust gas with cold fine water droplets and recover the exhaust heat into the water. This also substantially reduces the mercury emissions by condensing the mercury vapor and the dissolving and scrubbing action of the water's very large surface area on mercury particulates including oxides, sulfides, chlorides etc.

16.4.4 Solution Scrubber

Users similarly extend this water dissolving and scrubbing method to using solutions instead of clean water. Caustic solutions are commonly used to scrub flue gases of acidic emissions. By reducing drop size and increasing the direct contact drop surface, users significantly improve the scrubbing rate of such acidic and other emissions from a gas stream.

16.5 Direct Contact Thermal Control of Fluids

In another embodiment, users utilize the perforated tube arrays to heat or cool fluids by direct fluid contact by forming a direct contact fluid heat exchange. Users can use the sensible heat of changing the temperature of the injected fluid, and/or the latent heat from evaporation of an injected liquid.

16.5.1 Cooling by Cold or Refrigerated Liquid

To cool a fluid, users preferably use cool or refrigerated liquid through the distributed contactor to provide a very high surface area direct contact heat exchanger. This provides faster and more efficient heat transfer than conventional systems. For maximum effect, users preferably cool or refrigerate the water to about 2° C. Users then take this cold water and contact the air using the distributed contactor. This enables us to substantially cool the intake air without large amounts of evaporation as in conventional “fogging” systems.

Users preferably cool the intake air as needed or desired. E.g. when users wish to increase the gas density and the pumping capacity of a compressor. Advantageously, this enables us to increase the fuel flow rate and system power.

16.6 Distributed Direct Contact Fluid Heater

In situations where users wish to heat fluids, users preferably dispose a perforated tube array across the duct containing a second cool fluid duct to form a direct contact heat exchanger. Users then deliver a hot first fluid through the perforated tube array. With substantially uniform orifices, users form substantially uniform fluid jets or drops resulting an a very high direct contact surface area.

16.6.1 Low Vapor Pressure Liquid

When users wish to heat a cool fluid without vaporizing a significant portion of the hot first fluid, users preferably use a liquid with a very low vapor pressure. High molecular weight hydrocarbons such as vacuum pump oil may be used for moderate temperatures up to a few hundred degrees C. For higher temperatures, users preferably use the liquid metal gallium which has a very low vapor pressure and a very wide liquid temperature range.

16.6.2 High Vapor Pressure Liquid

In cold climates, it is preferable to both heat and humidify the air when heating it. With a liquid such as water that has a significant vapor pressure, a substantial portion will evaporate as it falls, humidifying the air. Users preferably distribute hot water though an perforated tube array configured across the air duct. By providing substantially uniform orifice and drop sizes, users achieve a more compact direct contact heat exchanger with higher heat transfer rates.

Where heating is associated with a demand for power, users preferably use a direct contact heat exchanger to cool the exhaust and condense the steam and water vapor while recovering high purity hot water. Users then pass that high purity hot water through a liquid—liquid heat exchanger to preheat common water. Users recycle the high purity cool water. Users take the heated common water and use it to heat and humidify the air.

16.6.3 Hot Contact Liquid Recovery

When delivering a hot liquid, users preferably provide a counterflow configuration such that the substantially uniform hot liquid drops of the first fluid fall through the cool second fluid. The hot first fluid drops cool while they heat the second fluid. As before, users preferably adjust the drop size and fluid velocity so that the substantially uniform hot liquid drops fall through the cool second fluid. Alternatively users can utilize the cross-flow or co-flow contactor's described above. With high vapor pressure liquids, users preferably account for the evaporation and change in drop size when sizing the heat exchanger and setting the gas velocities for a desired residence time, and selecting the orifice size.

Distributed Liquid Evaporator

17.1 Uniform Size & Residence Time

Substantially uniform drops will evaporate within a substantially uniform residence time within a substantially uniform flow of substantially uniform temperature. Thus, to evaporate a first liquid in a substantially uniform flow of a second fluid within prescribed, predetermined or pre-selected fluid duct dimensions, users preferably position a distributed contactor with substantially uniform orifices across the duct containing the second fluid duct. Users thus generate substantially uniform drops substantially uniformly distributed across the fluid flow within the duct.

These drops will evaporate within a fairly narrow distance from the contactor array, with the narrow residence time broadened somewhat by turbulence within the flow. Users thus obtain a narrow cumulative distribution of evaporation distances. There is a corresponding cumulative distribution versus drop size for a given evaporation distance. Users preferably adjust the drop size to obtain the desired cumulative probability of evaporation and/or cumulative probability of drop size at a desired distance from the contactor array.

17.2 Hybrid Counter-Co flow Evaporator

To evaporate a liquid in a vertical updraft flow, users preferably form substantially uniform drops which will initially fall against the counter-flowing fluid. Users size the drops such that when the drops have partially evaporated, the drag of the counter-flowing fluid will then reverse the droplet velocity and entrain the drops vertically along with the flow. Users preferably size the drops relative to the flow so that a prescribed, predetermined or pre-selected fraction of the drop mass will evaporate within the period when they are falling and returning back to the distributed contactor. (E.g., 99.97%.) This results in drops evaporating while they twice traverse the same region within the duct. Consequently users have about twice as many drops within the passage for a given number and size of orifices as compared with a co-flow configuration. This substantially increases the evaporation rate within a given duct, while permitting larger orifice sizes and thus lesser filtration requirements.

17.3 Co-Flow Evaporator

To evaporate a liquid in another fluid, users preferably use a co-flow system. Users preferably generate drops of sufficiently small size that the drops are entrained in the flow and carried away from the contactor array.

17.3.1 Upward Co-Flow Evaporator

When users have a temperature differential, users preferably orient the evaporator in the vertical direction to benefit from natural updrafts. To achieve a purely co-flow configuration, users preferably size the orifices to form drops that are sufficiently small to be entrained by the second fluid against gravity. I.e. the drag on those drops is less than the force of gravity on them. Gravity causes the velocity of the entrained drops to be less than the velocity of the second fluid velocity. Such a vertical updraft configuration provides a longer residence time than a downdraft configuration.

17.3.2 Downward Co-Flow Evaporator

In an alternative embodiment, users may configure a co-flow evaporator with a downward flow of the second fluid and corresponding downward flow of the first liquid drops. Here gravity accelerates the liquid as well as flow resulting in higher velocity and lower residence time than the hybrid counter-co flow and the upward co-flow configurations.

17.4 Radial Co-Flow Evaporator

Where a second fluid flows radially into or out of a duct, users preferably position a distributed contactor across the opening of that duct. The first fluid is then substantially uniformly mixed with the second fluid as it flows radially into or out of that duct. Users preferably size the orifices such that when liquid drops are formed, they are entrained by the second fluid. In other embodiments, where some of the first liquid drops may settle out, users preferably provide a means of collecting that liquid and recycling it.

17.5 Cross-Flow Evaporator

In other embodiments configured with horizontal ducts, users preferably use a cross-flow configuration. Users preferably position an array of distributed contactors across the horizontal duct. Users preferably position these contactors vertically across the duct. A collection basin, pump and return pipe is provided to recover droplets that fall through the duct before fully evaporating. Alternatively the distributed contactors may be placed horizontally across the upper portion of the duct near the inlet. In this case, orifices are preferably sized to form drops that evaporate just before reaching the bottom of the duct by the time they reach the exit.

17.5.1 Layered Cross-Flow Saturator

In another embodiment, users preferably further enhance the evaporation uniformity by forming multiple cross-flow evaporators. (See, for example, FIG. 22.) They provide multiple generally horizontal sheets to divide the large horizontal duct into multiple thin ducts, thereby achieving generally laminar flow. They provide a distributed contactor across each thin horizontal duct. Users preferably position an array of distributed contactors horizontally across the upper portion of each thin duct near the inlet. In this case, users size the orifices, thin duct length and height to form drops that do not completely evaporate by the time they reaching the bottom of the duct near the exit. Users so size number and size of orifices and dimensions to provide at least a prescribed, predetermined or pre-selected mass flow rate, surface area formation rate and residence time of the first fluid falling through the duct per mass flow of the second fluid flowing through the duct for prescribed, predetermined or pre-selected temperatures and composition of those fluids. By so doing, users can achieve a prescribed, predetermined or pre-selected degree of saturation with a prescribed, predetermined or pre-selected probability more efficiently and compactly than with the prior art. Users can similarly apply this methodology to the simpler cases of the other evaporator configurations.

17.6 Counter Flow Evaporator

In an alternative embodiment, users may use a purely counter flow configuration. Here users size the orifices to form and eject larger drops than the other embodiments. Users size orifices to form drops of sufficient size and velocity so that they will fall or move against the second fluid flow. Users then provide a means of recovering the drops before they evaporate sufficiently to be entrained by the second fluid.

17.7 Distributed Hydrocarbon Liquid Evaporator

The various evaporator embodiments may be used to evaporate hydrocarbon liquids including various petroleum distillate fractions, vegetable oils and liquid chemicals. These configurations may be variously used to evaporate fuels in combustion systems, to evaporate chemicals in petroleum refining or chemical processing, to evaporate potable liquids in food processing, or to concentrate liquids in biochemical processing systems.

17.8 Distributed Water Evaporator

Users preferably use embodiments of distributed contactor arrays where users wish to evaporate a liquid such as water to cool and/or increase that vapor concentration in a gas. E.g., evaporate water to cool or humidify air. Water is being introduced into power generation systems to cool intake air to increase power, increase efficiency and reduce NOₓ emissions. The distributed contactor provides substantial benefits over prior art. Some embodiments are detailed as examples of these applications.

17.8.1 Quasi-Isothermal Compressor

Compressing a gas increases the gas' temperature. Cooling the gas during compression reduces the work required to compress the gas. Isothermal compression provides the lowest compression energy. Entraining a vaporizable diluent liquid into the gas compressor results in liquid evaporation and diluent mixing which reduces the gas temperature and corresponding net work of compressing the gas. Similarly, spraying water into the gas flow within the compressor evaporatively cools the gas.

Post Compressor Diluent Drop Delivery: During compression work, the compressor compresses a real gas. In so doing it incurs parasitic turbomachinery losses due to blade and vane inefficiencies from turbulence, change of gas momentum direction etc. For the same amount of cooling, water delivered and evaporated after the compressor and before the turbine will result in less gas pumping and turbomachinery parasitic losses than the same amount of water evaporated prior to or within compressors.

Therefore, users preferably provide embodiments of distributed contactors to introduce water after the compressor and before the turbine to minimize compressor work to recompress and move water vapor within the compressor. The gas after the compressor is hotter than within the compressor resulting in faster water evaporation and a lower residence time needed to evaporate the water for a given drop size.

By more uniformly delivering the water throughout the gas with smaller drop size and greater surface area, users reduce the energy and entropy loss required for mixing.

Users preferably deliver the diluent water with small drop sizes of less than 100 μm. Users preferably use streamlined water distribution contactors to minimize the pressure drop. This combination provides a substantially faster evaporation, smaller volume and pressure vessel cost, and lower pressure drop than the Humidified Air Turbine (HAT®) or the Evaporated Gas Turbine (EvGT) power systems.

Inter-Compressor Diluent Drop Delivery: Where multiple compressors are used to achieve a desired pressure, users preferably cool the compressed fluid between the compressors by contacting with a cooling fluid by embodiments of distributed contactor arrays. Depending on the temperatures of the compressed fluid, users preferably select the temperature of the coolant fluid, the orifice size and distribution, and the relative fluid flow rates to control the rate of liquid evaporation and its residence time.

Intra-Compressor Drop Delivery: Users preferably apply this distributed water delivery method to intra-compression drop delivery within a compressor. This provides the benefit of cooling the compressed flow and reducing its volume (compared to using excess air as diluent) and thus reducing the compression work required. The prior art uses conventional injected sprays.

Pre-compressor Drop Entrainment: Where power managers seek retrofit of “fogging” water into compressor intake air, users preferably provide a distributed fluid contactor across fluid duct at or near the entrance of a compressor. With this distributed fluid contactor users provide substantially more uniform water drop sizes and liquid/gas ratio distribution. By eliminating the larger drop fraction, this measure significantly reduces blade erosion within the compressor. This measure is the easiest to install in a retrofit. These factors give significant cost advantages.

Evaporation prior to compression results in an additional volume of water vapor that must be compressed with corresponding parasitic flow losses. Direct distributed contactors entraining ro delivering substantially uniform water drops within a compressor(s), between compressors or after the compressor(s) is significantly more efficient than “fogging” before the compressor.

Fuel flammability limits constrain limits the maximum fraction water that can be evaporated or delivered as very small drops prior to the onset of combustion.

17.8.2 Cooling Gas by “Fogging”

Evaporative air cooling is being added to the air intake systems for power plants to cool the air, increase system power, increase system efficiency and add thermal diluent to reduce nitrogen oxides formed by combustion. Conventional systems create wide drop size distributions. Large drops can cause blade erosion. Therefore wide drop size distributions require a long residence time to evaporate the largest drops or to let them fall out. This requires a large volume duct prior to the compressor.

In other embodiments, users provide distributed contactors to provide generally uniformly sized drops in place of conventional sprays with wide size distributions. With one or more of these measures, users achieve a very narrow residence times to evaporate the drops. With one or more of these methods, users can reduce system size and cost compared to the prior art.

17.9 Delivering Fluids into IC Engines

Both fuels and water are being injected into work engines and evaporated in the oxygen containing fluid (e.g., ranging from air to oxygen enriched air to oxygen).

17.9.1 Entraining through Cylindrical Wall Opening

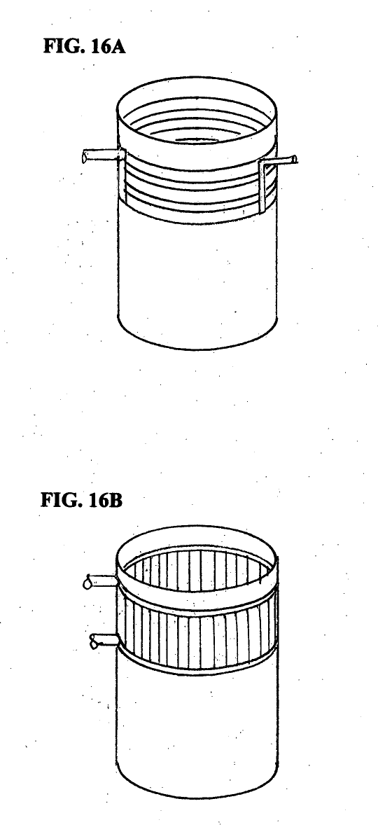

Powell (1991, 1996) and others teach engines which draw their air in through openings, slots or perforations in or around the engine cylinder wall. In some embodiments, users preferably place an array of streamlined perforated tubes around the cylinder wall covering these openings. Users preferably wind thin streamlined perforated tubes around the cylinder over these openings in a direction tangential to the cylinder wall. Users preferably connect both tube ends to a fluid supply manifold. (See, for example, FIG. 16A.)

In other embodiments, users position the perforated tubes around the cylinder wall parallel to the cylinder axis. Users preferably connect one or both ends of the perforated tubes to a fluid supply manifold. (See, for example, FIG. 16B.)

17.9.2 Delivering a Fluid through an Intake Duct or Port

In other embodiments, users position one or more arrays of perforated distribution tubes across one or more intake ducts or ports to deliver one or more fluids into the fluid flowing through those ducts or ports. Such embodiments may use a planar, conical or other array as previously described.

17.9.3 Delivering a Fluid into a Prechamber

Some engines similarly use prechambers connected to the main cylinder(s). In some embodiments, users position one or more perforated distribution tubes across or around one or more ducts or ports connecting to such prechambers to deliver fluids into those prechambers. In another embodiment, the perforated distribution tubes are positioned about or along ducts leading to or from such prechambers.

17.9.4 Delivering a Fluid into a Chamber

Conventional systems inject one or a few fuel jets into a combustion chamber. This is often done after the air is significantly compressed. This requires high velocities.

Instead, users preferably use a perforated distribution tube around the periphery of the chamber. They preferably inject numerous fine microjets of fuel into the chamber at low pressure. The perforated tube is preferably wound around the cylinder head space above the limit of piston travel. The orifices preferably point towards the center of the chamber, away from the walls. Preferably providing some tangential orientation of the orifices imparts some swirl component to the fluid and increases mixing.

This method permits the fuel to significantly penetrate and evaporate by the time the oxygen containing fluid is compressed within the combustion chamber. This provides much smaller more uniform drops with more uniform residence time. The results in significantly improved charge uniformity.

17.10 Distributed Direct Contact Drier

Spraying a fluid with slurried or dissolved materials into a hot gas is a common method of evaporating the carrier liquid, drying and recovering the solid materials such as milk powder. Users preferably deliver such compound fluids through embodiments of distributed perforated tube arrays to create drops with a very narrow drop size distribution (or substantially uniform drops). These will evaporate within a very narrow residence time range enabling much more uniform processing times. This narrow distribution further prevents very small drops and particles, thus increasing product recovery. The narrow drop and particle distribution further reduces or prevents the formation of large drops. This reduces residence time and liquid carrier liquid carryover into the product.

As before, users preferably filter the compound fluid using a filter with a substantially uniform orifice size smaller than the product delivery orifices. With solids that tend to agglomerate, users preferably provide a wiper to remove solids built up on the filter. Users further provide a back flushing system to clear the filter.

Uniform Powder Former

Users can form very uniformly sized powders by delivering liquid or molten drops through these distributed orifices in the perforated tubes. Users can use these distributed orifices to form drops from molten liquid, from reactive liquid or by evaporation of a suspension or solution. In such applications, users preferably place the holes at the bottom of the perforated tubes to form substantially uniform drops. Users preferably control the temperature of the liquid within a narrow prescribed, predetermined or pre-selected range. This helps control the variation in surface energy, viscosity and density which affect drop size. Users preferably also control the temperature of the structure around the distributed orifices.

18.1 Melt Drop Powder Former

Particularly with melts, users preferably hold the temperature melt within a narrow prescribed, predetermined or pre-selected range near the freezing point. Users preferably maintain the vessel walls at a temperature lower than the molten drops. Users further control the height of the drop vessel as a function of drop size to ensure sufficient residence time for the drops to cool and solidify. The thermal response time for drops to reach a prescribed, predetermined or pre-selected fraction of temperature difference between melt and walls is proportional to the drop surface area or the square of the drop diameter. Users preferably use orifices smaller than about 50 μm to obtain rapid cooling and small drop size. E.g., Reducing drop size from about 500 μm to about 50 μm achieves about 100 times faster equilibrium for the same mass. This method provides a substantially shorter drop height, faster production and lower cost than the prior art.

18.1.1 Extended Cool Walls

If a large cross section of drops fall through a vessel, the interior portions will be hidden by other drops from the cool exterior walls and not cool as fast as drops near the cool exterior walls. To improve cooling rates, users preferably provide further cool walls to radiatively cool the droplets. Users further intersperse one or more perforated distribution tubes with cool walls which can be cooled with coolant channels carrying a cooled fluid. Users can use alternating drop passageways and cooled walls with perforated tubes above the passageways. Users preferably configure these as rectangular arrays.

In some embodiments, users form the tubes, drop passageways and cooling walls in spiral or concentric forms. In other embodiments, users form cooling walls by using cooling vertical tubes carrying coolant interspersed across the drop space, preferably in a hexagonal pattern.

18.1.2 Drop through a Vacuum

Molten metals often react with oxygen to form oxides. Many organic compounds similarly react with oxygen. To prevent or mitigate such reactions, users preferably evacuate the vessel through which the drops fall. The vacuum also eliminates convective cooling. The residence time for drops falling within the vessel is based on gravity caused acceleration. The dispersed cooling wall methods described above become even more advantageous with this configuration.

Users preferably use pipes for cooling surfaces as they can easily handle the pressure differences. In other embodiments, users can use coolant containing cooling walls where the walls are periodically bonded together to accommodate the pressure difference.

18.1.3 Drop through an Inert Gas

As a modification to falling liquid drops through a vacuum, users preferably deliver liquid drops to fall through an inert gas such as argon or possibly nitrogen. In calculating the drop velocity falling within the gas users preferably account for velocity dependent differential drag on the drop and buoyancy from differential density. In calculating the thermal residence time users preferably account for the influence of internal drop circulation on increasing heat transfer to the surface such as developed by Sirignano (1999) and others.

18.2 Uniform Powder Former by Reactive Liquids

18.2.1 Ultra Violet Solidification

Many chemicals are formed by exposing a reactive compound to Ultra Violet (UV) radiation. Users preferably form fine drops of the reactive compound with embodiments of distributed perforated tubes. Users then preferably send the drops through or exposed to an ultra violet radiation field. Users preferably form this UV radiation field with banks of UV lamps, preferably located at the foci of parabolic or similar reflectors to direct all the radiation across the falling drops. Users can also use vertical UV lamps with drops falling between them.

Often the UV radiation lamps are more intense and narrow. Consequently much of the UV radiation is poorly or non-uniformly intercepted by drops. Users preferably distribute the UV radiation more uniformly along the drop cavity. Users preferably provide reflective surfaces, linear Fresnel mirrors, or Fresnel lenses in a normal V or inverted V configuration in parallel with the UV lamps. In other embodiments, the UV lamps are interspersed among the perforated tubes, preferably above the drop space, but may also be below that drop space.

18.2.2 Drop through Reactive Gas

For liquids that react with a gas to form solids, users preferably form the drops with distributed perforated tubes. The reactive gas is flowed across the perforated tubes. The gas flow is preferably vertical to improve product uniformity. The drop residence time is preferably controlled to ensure a prescribed, predetermined or pre-selected portion of the reactive liquid in the drops reacts with the surrounding gas.

Recovering Droplets & Particulates

19.1 Gravity Settling

In some embodiments, users provide a generally horizontal duct with a sufficient residence time for the substantially uniform droplets formed to settle down to lower side of the duct. To recover the first fluid, users provide suitable channels to direct the first fluid flow to drains where they collect the fluid.

In some embodiments, users preferably select duct dimensions to provide a smooth laminar flow. Steps, baffles and other flow changes that cause eddies are preferably avoided.

The substantially uniform size of the first fluid drops formed results in a generally uniform vertical velocity across the second fluid flow. The drops have a fairly predictable residence time depending on where they are released and the relative uniformity of the flow. Users then select a duct length long enough and/or the duct area large enough or reduce the velocity slow enough to provide the desired residence time so that they recover at least a prescribed, predetermined or pre-selected portion of the drops. Suitable methods are further described above in the discussion of the cross-flow contactor, heat exchanger and/or evaporator.

19.2 Settling Planes

As in the discussion on using multiple planes in layered cross-flow contactors and heat exchangers, users preferably provide multiple settling planes to recover the fluid in some embodiments. (See, for example, FIG. 22.) These settling planes significantly reduce the distance droplets typically travel before they contact a recovery plane.

19.3 Cyclones

Cyclones are commonly used to recover drops and solid particles. However conventional drop or particulate formation results in a wide distribution of drop or particulate sizes. Cyclones efficiency drops off dramatically for smaller drop or particulate size. Kim and Lee (1990) measured the efficiency of a small cyclone 3.11 cm diameter by 9.5 cm high (barrel and cone). They found the efficiency drop off from 80% at about 7 microns to less than 10% at about 4.5 microns. Griffiths and Boysan (1996) obtained very close correlation with those experimental results by modeling the cyclone with Computational Fluid Dynamics using a Randomized Normal Grouping (RNG) based k-E turbulence model to account for the swirling flow.

With a broad distribution, a cyclone will typically only recover a portion of the drops or powders. Often cyclones are sized much smaller than needed for mean drops to recover smaller drops or particles. This undesirably requires many more cyclones. It also requires much higher pressure drops with higher pumping costs.

In contrast, by using embodiments of distributed direct contactors, users preferably generate substantially uniform sized drops or a narrow prescribed, predetermined or pre-selected distribution of drop sizes. By using the analysis methods of Griffiths and Boysan (1996) users preferably obtain a cumulative distribution of drops recovered vs size. In modified embodiments, other suitable analysis methods may be efficaciously used, as needed or desired.

Using such methods, users preferably size the cyclone dimensions and flow parameters to achieve a prescribed, predetermined or pre-selected cumulative distribution of drops recovered. By such methods, users can achieve greater than about 99% drop recovery at substantially lower gas flow rates per cyclone. This improves recovery and revenues and lowers pumping costs compared to conventional systems. In other embodiments, for the same gas flow rate, users can use larger or fewer cyclones and thus reduce operating and/or capital costs.

In modified embodiments, users use the experimental methods of Kim and Lee (1990) to obtain recovery efficiency versus drop size. Users then extrapolate the recovery efficiency versus size to identify the drop size at nominally 100% recovery. Users then select the drop size to be greater than the size needed to achieve greater than this nominal 100% recovery with the cyclone under consideration.

19.4 Electrostatic Precipitators

Electrostatic precipitation technology is used to remove droplets or particulates from a gas stream. Prior art with sprays results in a wide distribution of droplet or particulate sizes. Consequently, and disadvantageously, the electrostatic precipitation equipment are sized to remove the smallest particulates or droplets tolerable. Particulates smaller than that are undesirably lost with the exhaust gas flow.

19.4.1 Recovering Liquid Drops

In contrast, embodiments of distributed direct contactors are used to form drops of substantially uniform size. This enables users to size the electrostatic precipitators and the voltage used to remove these generally uniform drops. This provides a substantial reduction in size of the electrostatic precipitator and/or power required to recover a prescribed, predetermined or pre-selected fraction of particles.

19.4.2 Recovering Solidified Powders

Users preferably utilize distributed direct contactors to form substantially uniform drops. Users then solidify these to form substantially uniform powders. Users then provide an electrostatic precipitator and adjust the dimensions gas flow and power to efficiently recover these substantially uniform particles. Users obtain greater recovery efficiency with lower cost than the prior art.

19.4.3 Recovering Evaporated Powders

Users similarly apply this method with driers to recover the powders formed by drying fluids containing slurries or dissolved solids. By creating substantially uniform drops, users form much more uniformly sized powders. Users then recover these powders with this electrostatic precipitator method with greater efficiency and lower cost and energy than the prior art.

19.5 Impingement Separators

Another common method of separating entrained droplets from a fluid is to direct the flow through a tortuous passage which changes the gas flow direction. A fluted array is commonly used to force the gas to change direction by traversing the flutes. Particles with a drop size and mass to drag ratio greater than certain values will impinge on the passage wall. Particles with smaller drop size and smaller mass to drag ratios will be carried on through by the gas.

By generating substantially uniform drops, users substantially improve recovery of impingement separators. Users preferably size the impingement passages, orifice size drop size and gas velocity such that substantially all the particles will impinge on the separator with very few carried past the separator. Correspondingly users adjust the gas velocity and passage size to minimize the pressure drop and pumping cost of forcing the fluid through the impingement separator.

Solar Collector

As with steam generation, heat recovery in concentrated solar collectors in prior art is typically limited by the material thermal stress limits. The solar flux is focused on tubes containing a fluid that is heated such as water or helium, or liquid sodium.

In some embodiments, users preferably use distributed perforated tube arrays to provide a dense “rain” of very small drops across the space containing high intensity concentrated solar flux. Users preferably use a suitable low vapor pressure metal or salt to create the drop arrays. E.g. gallium. Users preferably form the drops with a dense distributed array of perforated tubes so that the drops form an optically thick “fluid” to absorb the solar flux. This is preferably formed as a partially open cylindrical array to obtain the near “black body” (i.e. “gray body”) high absorption benefits of a cavity.

Users preferably focus the solar flux through a sapphire window positioned across the opening in the cavity cylinder. Such sapphire windows can easily withstand the high temperatures involved. In other embodiments, users use a clear quartz window. Users select the window thickness according to the vapor pressure of the fluid being heated. With a low pressure metal such as gallium, there is not a substantial pressure difference across the window so users can use a relatively thin window.

In other embodiments, users form the wall of the cavity with an array of sapphire tubes. Users then pass the heat transfer fluid through the tubes to absorb the heat from the solar flux.

From the foregoing description, it will be appreciated that a novel approach for distributed fluid contacting has been disclosed. Where dimensions are given they are generally for illustrative purpose and are not prescriptive. While the components, techniques and aspects of the invention have been described with a certain degree of particularity, it is manifest that many changes may be made in the specific designs, constructions and methodology herein above described without departing from the spirit and scope of this disclosure.

Various modifications and applications of the invention may occur to those who are skilled in the art, without departing from the true spirit or scope of the invention. It should be understood that the invention is not limited to the embodiments set forth herein for purposes of exemplification, but includes the full range of equivalency to which each element is entitled.

1. An energy conversion system operative to form an energetic fluid comprising thermal diluent fluid, combustion gases, oxygen containing fluid, and pollutants, comprising:
a combustor configured to combust oxygen and fuel to form a combusting fluid, the combustor including one or more fluid inlets configured to receive oxygen containing fluid, fuel, and a thermal diluent fluid, and a fluid outlet configured to emit the energetic fluid;
a fluid delivery system configured to deliver the oxygen containing fluid, the fuel, and the thermal diluent fluid to one or more inlets of the combustor, the oxygen containing fluid being at an elevated pressure; and
a controller configured to control the delivery of fluid within the energy conversion system so that at least one pollutant content within the energetic fluid is below a desired concentration near the combustor outlet port, and to control a temperature of the fluid.

2. A process of generating power using an apparatus comprising a combustion chamber and a work engine coupled to the combustion chamber, comprising the steps of:
delivering fuel to the combustion chamber;
delivering compressed air at an elevated temperature and a pressure to the combustion chamber;
varying the quantity of air and fuel supplied to the combustion chamber, while maintaining a constant fuel to air ratio;
mixing the fuel and air in the combustion chamber;
igniting the mixture of fuel and air to produce a combustion vapor stream;
delivering water under pressure to the combustion chamber, the water being converted substantially instantaneously upon entering the combustion chamber to steam, the delivery and formation of steam creating turbulence and mixing in the combustion chamber resulting in a working fluid comprised of steam, combustion products and non-flammable materials in the air and fuel;
controlling the quantity of water delivered to the combustion chamber such that the latent heat of vaporization of the water maintains the temperature of the working fluid at a desired level;
delivering the working fluid to the work engine; and
transferring heat from the working fluid exiting the work engine to the water, the heat transferred to the water being sufficient to elevate the temperature of the water from a feed temperature to the desired temperature for delivery to the combustion chamber.

3. An apparatus for mixing a first fluid with a second fluid, the apparatus comprising: a fluid distribution portion comprising at least one tubular portion having an outer surface and an inner surface, the inner surface defining a first flow path for the first fluid, a duct that defines a second flow path for the second fluid, the duct having an axial direction and a first and second transverse directions mutually distinct from the axial direction, the first and second transverse directions defining a plane through an axial location and containing a cross-sectional area of the duct, a first fluid delivery system for supplying the first fluid to the fluid distribution portion a second fluid delivery system for supplying the second fluid to the duct; the tubular portion comprising a plurality of orifices each forming a third flow path along which the first fluid can be injected into the second fluid within the duct; and wherein the outer surface of the tubular portion comprising the orifices is positioned within the duct in the second flow path and the orifices when projected onto a plane containing the first and second transverse directions have an average spatial density of at least about 10,000 orifices per square meter of duct cross sectional area.

4. The apparatus of claim 3, wherein the orifices have an average lineal density of at least 1000 orifices per meter length of the tubular portion.

5. The apparatus of claim 3, wherein the orifices when projected onto a plane containing the first and second transverse directions have an average spatial density of at least about 1 00,000 orifices per square meter of duct transverse cross sectional area.

6. The apparatus of claim 3, wherein the orifices have an average diameter less than about 80 micrometers.

7. The apparatus of claim 3 wherein the orifices have an average diameter less than about 5 micrometers.

8. The apparatus of claim 3, further comprising a flexible manifold for connecting the first fluid supply system to each tubular portion.

9. The apparatus of claim 3, further comprising a support that is coupled to the distribution portion to support the distribution portion in the duct.

10. The apparatus of claim 3, wherein the tubular portion comprises a plurality of tubular curvilinear sections extending in at least one of the transverse directions, whose flow paths are connected to at least one manifold that is connected to the first fluid supply system.

11. The apparatus of claim 3, wherein the curvilinear sections are positioned sequentially downstream within the second flow path from each other.

12. The apparatus of claim 3, wherein the tubular portion comprises at least one tubular member that extends in the axial direction and at least one manifold which connects the tubular member to the first fluid supply system.

13. The apparatus of claim 3, wherein the tubular portion comprises at least one tubular member that extends in the first or second transverse direction, and are connected to at least one pair of manifolds at angles between 5 degrees and 175 degrees.

14. The apparatus of claim 13, wherein the manifolds are angled with respect to each other.

15. The apparatus of claim 13, wherein a differential pressure is applied to the first fluid between the two manifolds.

16. The apparatus of claim 1, wherein the tubular portion includes a first portion that extends in the first transverse direction and at least the size of the orifices or the distribution of the orifices in the first transverse direction are configured so as to deliver a non-uniform amount of the first fluid with respect to the first transverse direction to the second fluid to achieve a desired transverse distribution of the first fluid in the second fluid.

17. The apparatus of claim 16, wherein the tubular portion includes a second portion that extends in the second transverse direction and at least the size of the orifices or the distribution of the orifices in the second transverse direction are configured so as to deliver a non-uniform amount of the first fluid with respect to the second transverse direction to the second fluid to achieve a desired transverse distribution of the first fluid in the second fluid in the second transverse direction.

18. The apparatus of claim 16, wherein the first and second transverse directions are perpendicular to each other.

19. The apparatus of claim 16, wherein the first transverse direction is radial to the axial direction.
